(19) United States
(12) Patent Application Publication
(10) Pub. No.: US 2013/0070262 A1
(43) Pub. Date: Mar. 21, 2013

(54) PRINTING DEVICE AND METHOD OF CONTROLLING PRINTING DEVICE

(71) Applicants: Satoko KONNO, Kanagawa (JP); Shunsuke ARITA, Tokyo (JP); Mitsutaka NAKATA, Tokyo (JP); Ato ARAKI, Tokyo (JP)

(72) Inventors: Satoko KONNO, Kanagawa (JP); Shunsuke ARITA, Tokyo (JP); Mitsutaka NAKATA, Tokyo (JP); Ato ARAKI, Tokyo (JP)

(21) Appl. No.: 13/617,600

(22) Filed: Sep. 14, 2012

(30) Foreign Application Priority Data
Sep. 16, 2011 (JP) 2011-203700
Aug. 24, 2012 (JP) 2012-185884

(51) Int. Cl. G06F 15/00

(52) U.S. Cl. 358/1.6

(57) ABSTRACT

A printing device includes a plurality of holding units connected to an upper level device for generating image data, via a plurality of first transfer paths, respectively; a control unit configured to divide the image data into a plurality of blocks and transfer division pieces of image data corresponding respectively to the blocks to the respective holding units via the first transfer paths to cause the holding units to hold the division pieces of image data, the number of blocks being equal to the number of holding units; and a printing unit configured to print the division pieces of image data read out from the holding units on a same page.

### CROSS-REFERENCE TO RELATED APPLICATIONS

The present application claims priority to and incorporates by reference the entire contents of Japanese Patent Application No. 2011-203700 filed in Japan on Sep. 16, 2011 and Japanese Patent Application No. 2012-185884 filed in Japan on Aug. 24, 2012.

### BACKGROUND OF THE INVENTION

1. Field of the Invention

The present invention relates to a printing device and a method of controlling the printing device.

2. Description of the Related Art

In the related art, a printing system has been known which includes a printing device and an upper level device delivering print data to the printing device as well as instructing the printing device to perform printing. In this printing system, for example, the upper-level device generates a raster image type of print image data by using a raster image processer (RIP), on the basis of print data written in page description language (PDL) that is transmitted from a host device, and transmits the generated print image data to a printing control unit of the printing device (for example, refer to Japanese Patent Application Laid-open No. 2004-287519).

Different from the printing system described above, a printing device provided with a printer controller, a printer engine, and data lines to connect the printer controller to the printer engine is already known (for example, refer to Japanese Patent Application Laid-open No. 2002-254763). In the printing device that is disclosed in Japanese Patent Application Laid-open No. 2002-254763, a control line through which various control information is exchanged between the printer controller and the printer engine is separate from the data lines through which print image data is exchanged, so that a high-speed transmission of data can be realized. In the printing system, the print image data of each color is transmitted in parallel so that the high-speed transmission of data in color printing can be realized.

Furthermore, there is proposed a printing system provided with an upper level device for generating print image data, a printing device for performing a print based on the print image data, and a control line and a data line for connecting the aforementioned units, in which the control line and the data line are separate from each other. In this printing system, a printing controller controls also a data processing controller for controlling a transfer timing of the print image data, as well as a control including a sheet conveyance control for conveying a sheet to be printed.

Here, the case is considered in which single-color (for example, K) print image data are printed with a system in which a data line for transferring print image data is provided for each color of Y (yellow), C (cyan), M (magenta), and K (black). In a conventional system, the print image data are managed page by page for each color. Thus, even in the single-color printing, printing has been conducted in a manner that single-color print image data for one page are transferred to just a single-color data processing controller for a printing object among multiple data processing controllers corresponding to the respective colors.

Therefore, the amount of transferring print image data to one data processing controller is the same as that in the case of printing of the print image data with colors; as a result, there have been problems that the data transfer speed is not increased as compared with that in the case of multicolor printing and it is difficult to increase the printing speed.

Therefore, there is a need for a printing device and a method of controlling the printing device, capable of improving the single-color printing speed in the case of transferring print image data via a different data line for each color.

### SUMMARY OF THE INVENTION

It is an object of the present invention to at least partially solve the problems in the conventional technology.

According to an embodiment, there is provided a printing device that includes a plurality of holding units connected to an upper level device for generating image data, via a plurality of first transfer paths, respectively; a control unit configured to divide the image data into a plurality of blocks and transfer division pieces of image data corresponding respectively to the blocks to the respective holding units via the first transfer paths to cause the holding units to hold the division pieces of image data, the number of blocks being equal to the number of holding units; and a printing unit configured to print the division pieces of image data read out from the holding units on a same page.

According to another embodiment, there is provided a method of controlling a printing device. The method includes holding data in a plurality of holding units connected to an upper level device for generating image data, via a plurality of first transfer paths, respectively; dividing the image data into a plurality of blocks, the number of blocks being equal to the number of holding units; transferring division pieces of image data corresponding respectively to the blocks to the respective holding units via the first transfer paths to cause the holding units to hold the division pieces of image data; and printing the division pieces of image data read out from the holding units on a same page.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating an example of the configuration of a printing system applicable to each embodiment;

FIG. 2A is a block diagram illustrating an example of the configuration of an upper level device applicable to each embodiment;

FIG. 2B is a functional block diagram illustrating an example of a function of the upper level device applicable to each embodiment;

FIG. 3A is a block diagram illustrating an example of the configuration of a printing device applicable to each embodiment;

FIG. 3B is a block diagram illustrating an example of a printer controller applicable to each embodiment;

FIG. 4A is a block diagram schematically illustrating an example of the configuration of a data transfer control unit applicable to each embodiment;

FIG. 4B is a block diagram specifically illustrating an example of the detailed configuration of the data transfer control unit applicable to each embodiment;

FIG. 5 is a block diagram illustrating an example of the configuration of an image output unit applicable to each embodiment;

FIG. 6 is a schematic diagram illustrating an example of the configuration of a printing device including a paper conveyance system that can be applied to each embodiment;

FIG. 7 illustrates an example of control information that is transmitted and received between a printer controller of a printing device and the upper level device applicable to each embodiment;

FIG. 8 is a sequence diagram conceptually illustrating an example of a printing process that can be applied to each embodiment;

FIG. 9A is a flow chart illustrating an example of a process of the upper level device that can be applied to each embodiment;

FIG. 9B is a flow chart illustrating an example of a process of a printer controller that can be applied to each embodiment;

FIG. 9C is a flow chart illustrating an example of a process of a print instruction of the printer controller that can be applied to each embodiment;

FIG. 9D is a flow chart illustrating an example of a process of each data transfer control unit that can be applied to each embodiment;

FIGS. 10A to 10C are sequence diagrams specifically illustrating an example of the printing process that can be applied to each embodiment;

FIG. 11A is a flow chart illustrating another example of a process of the upper level device that can be applied to each embodiment;

FIG. 11B is a flow chart illustrating another example of a process of a data transfer control unit that can be applied to each embodiment;

FIG. 12 is a diagram for explaining virtual memory according to each embodiment;

FIGS. 13A and 13B illustrate a specific example of the virtual memory applicable to each embodiment;

FIG. 14 is a diagram for explaining control of an input pointer and an output pointer on the virtual memory applicable to each embodiment;

FIG. 15 is a diagram illustrating an example of a transfer management table that is applied to the first embodiment.

FIGS. 16A and 16B are diagrams for explaining information related to a printing object applicable to each embodiment;

FIG. 17 is a flow chart illustrating an example of a process when the printer controller receives data from the upper level device applicable to each embodiment;

FIG. 18 is a diagram for explaining a check of a vacant memory capacity in the virtual memory applicable to each embodiment;

FIG. 19 is a diagram for explaining in detail a check of a vacant memory capacity in the virtual memory applicable to each embodiment;

FIG. 20 is a flow chart illustrating an example of a process when transmission ends, applicable to each embodiment;

FIG. 21 is a flow chart illustrating an example of a process when printing ends, applicable to each embodiment;

FIG. 22 is a diagram for explaining an example of the case where bitmap data having a size different for each color are transmitted, applicable to each embodiment;

FIG. 23 is a diagram for explaining an example of the configuration of a transfer management table applicable to each embodiment;

FIG. 24 is a diagram for explaining an example of a method of arranging print image data on memory applicable to each embodiment;

FIGS. 25A and 25B are diagrams for explaining an example of a method of arranging print image data on memory applicable to each embodiment;

FIG. 26 is a diagram specifically illustrating data transfer according to a first embodiment;

FIG. 27 illustrates an example of the configuration of a transfer management table according to the first embodiment;

FIG. 28 illustrates an example of a method of writing divisional image data to each memory;

FIG. 29 illustrates a method of zero-clearing the memory according to the first embodiment;

FIG. 30 is a sequence diagram conceptually illustrating an example of a printing process that can be applied to the first embodiment;

FIG. 31A is a flow chart illustrating an example of the configuration of an upper level device applicable to the first embodiment;

FIG. 31B is a flow chart illustrating an example of a process of a printer controller that can be applied to the first embodiment;

FIGS. 32A to 32C are sequence diagrams illustrating a more specific example of a printing process applicable to the first embodiment;

FIG. 33 is a diagram illustrating an example of a transfer management table that can be applied to a second embodiment;

FIGS. 34A and 34B are diagrams for explaining a method of transferring data according to the second embodiment; and

FIG. 35 represents the calculation formula for calculating the data increment number according to the second embodiment.

### DETAILED DESCRIPTION OF THE PREFERRED EMBODIMENTS

Hereinafter, embodiments of a printing system according to the present invention will be described in detail with reference to the accompanying drawings. First, in order to help with understanding, production printing to which a printing system according to each embodiment is applied will be schematically described. In general, the production printing is used when a large capacity of printing is performed in a short time. For this reason, in the production printing, there is constructed a work flow system for controlling from a print data generation to a print distribution, in order to efficiently perform a job control or a print data control, as well as improving the print speed.

The print system according to each embodiment involves a part for implementing the print operation in the work flow for the production printing. In the system, a process using the RIP (hereinafter may be called “RIP process”) is performed by a device different from a device for printing the bitmap data obtained through the RIP process. Since the RIP process requires the most long processing time in the printing process, it is possible to improve the print speed by performing the RIP process and the printing process by different devices.

### <Outline of Printing System Applicable to Each Embodiment>

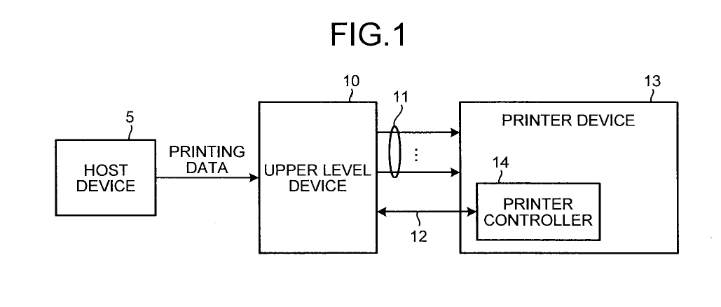

FIG. 1 illustrates an example of the configuration of a printing system that can be applied to each embodiment of the present invention. The printing system is provided with an upper level device 10, a printer device 13 as an image forming device, a plurality of data lines 11, and a control line 12. The upper level device 10 is connected with the printer device 13 via the plurality of data lines 11 and the control line 12. A host device 5 may be a computer for example to generate print job data including print image data and print set information.

The print job data may include data written in PDL (hereinafter referred to as “PDL data”) for example. The print set information relating to the print setting including print page information, layout information, print run information, as well as the print image data composed of the bitmap image for printing, is generated by interpreting the PDL data.

The upper level device 10 performs the RIP process in accordance with the print job data supplied from the host device 5 to generate the each color bitmap data as print image data. Along with that, the upper level device 10 generates control information for controlling the print operation, on the basis of the print job data and the information from the host device 5.

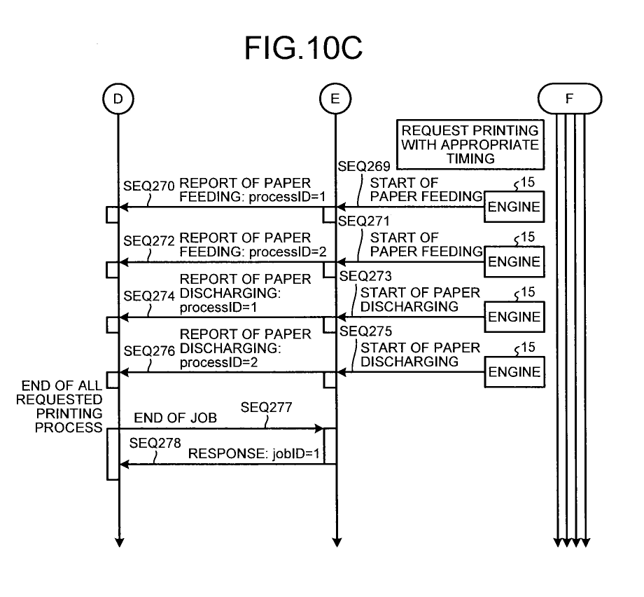

The print image data for each color generated by the upper level device 10 is supplied to a printer engine unit (not shown) of the printer device 13 through the plurality of data lines 11. Between the upper level device 10 and a printer controller 14, the control information for controlling the print operation is transmitted/received through the control line 12. The print controller 14 controls the printer engine unit on the basis of the transmitted/received control information to form an image on a print medium, thereby perform the print operation according to the print job. Incidentally, the specific example of the control information will be described later with reference to FIGS. 10A to 10C.

The printing method is not limited in particular. However, in each embodiment, printing paper is used as the printing medium and a printing image is formed on the printing paper using an inkjet system. However, the present invention is not limited thereto and each embodiment can be applied to the printing device that forms a printing image on the printing paper using toner. As the printing paper, continuous paper (continuous stationery) where perforations to be cut are provided at a predetermined interval is used. In the production printing, the continuous paper is mainly used as the printing paper. However, the present invention is not limited thereto and cut paper where a size is fixed to an A4 size or a B4 size may be used as the printing paper. In the continuous paper, a page means a region that is interposed by perforations provided at a predetermined interval.

The printing medium that is printed by a printing system according to each embodiment is not limited to printing paper such as paper. That is, other printing media that can be printed by a printing system applied to each embodiment and can be provided as a roll may be used. For example, a plastic film or cloth may be used as the printing medium.

### <Upper Level Device>

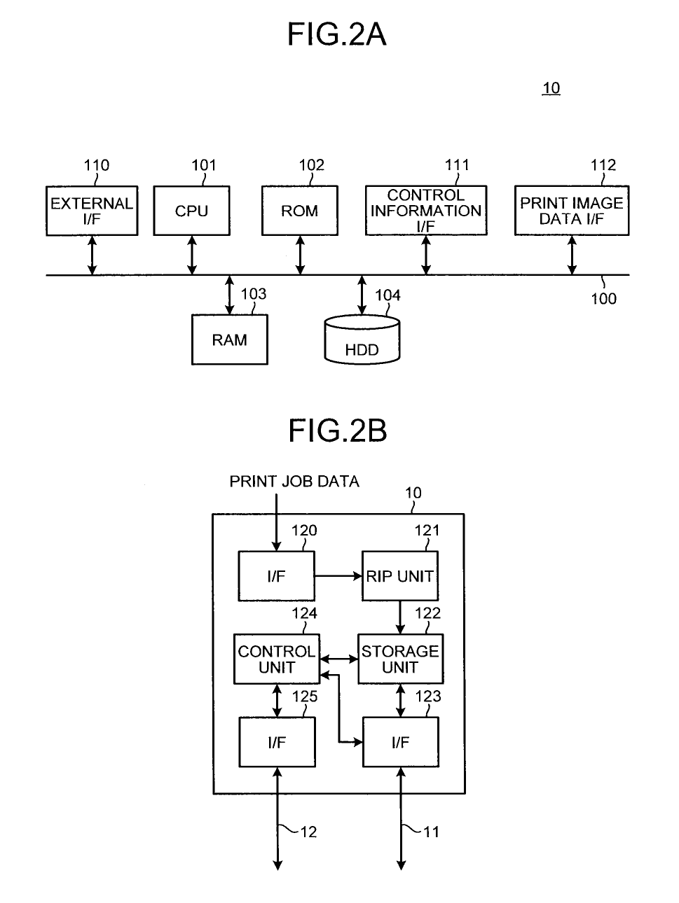

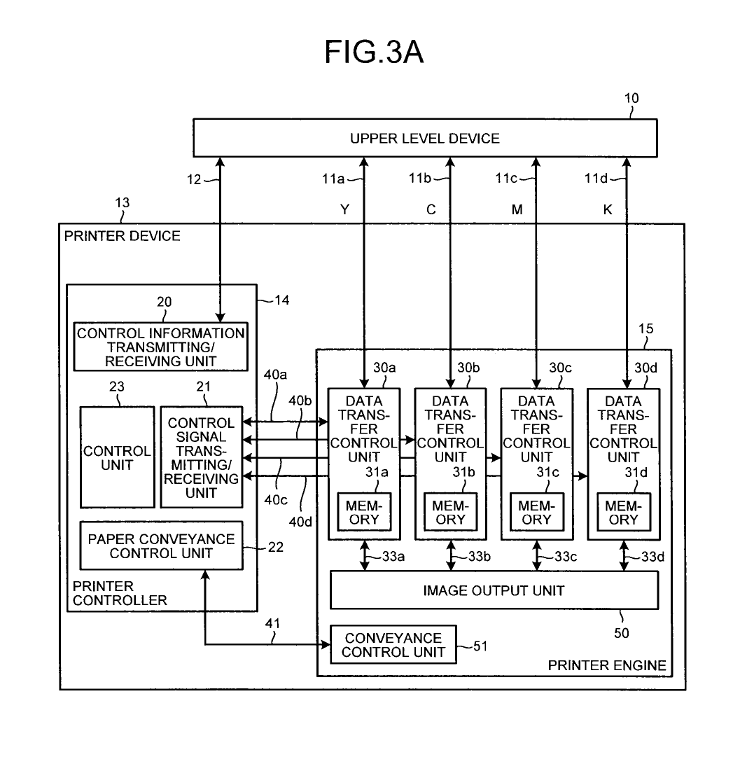

FIG. 2A illustrates an example of the configuration of the upper level device 10. A control processing unit (CPU) 101, a read only memory (ROM) 102, a random access memory (RAM) 103, and a hard disk drive (HDD) 104 are connected to a bus 100. An external I/F 110, a control information I/F 111, and a print image data I/F 112 are connected to the bus 100. The individual units that are connected to the bus 100 can communicate with each other through the bus 100.

In the ROM 102 and the HDD 104, a program to operate the CPU 101 is stored in advance. The RAM 103 is used as a work memory of the CPU 101. That is, the CPU 101 uses the RAM 103 as the work memory according to the program stored in the ROM 102 and the HDD 104 and controls all the operations of the upper level device 10.

The external I/F 110 corresponds to, for example, a transmission control protocol/Internet Protocol (TCP/IP) and controls communication with the host device 5. The control information I/F 111 controls communication of control information. Since the print image data I/F 112 controls communication of print image data, the print image data I/F 112 has plural channels. For example, print image data of each color such as yellow (Y), cyan (C), and magenta (M), and black (K) that is generated in the upper level device 10 is output from the plural channels. Since a high-speed transmission speed is required in the print image data I/F 112, the peripheral component interconnect bus express (PCI Express) may be employed. A type of the control information I/F 111 is not limited in particular. However, in this case, similar to the print image data I/F 112, the PCI Express is used.

In this configuration, print job data that is transmitted from the host device 5 is received in the external I/F 110 of the upper level device 10 and is stored in the HDD 104 through the CPU 101. The CPU 101 executes the RIP process on the basis of the print job data read from the HDD 104, generates bitmap data of each color, and writes the bitmap data in the RAM 103. For example, the CPU 101 renders page description language (PDL) data by the RIP process, generates bitmap data of each color, and writes the bitmap data in the RAM 103. The CPU 101 compresses and encodes the bitmap data of each color that is written in the RAM 103 and temporarily stores the bitmap data in the HDD 104.

For example, when a print operation starts in the printer device 13, the CPU 101 reads the compressed and encoded bitmap data of each color from the HDD 104, decodes the compressed code, and writes the extended bitmap data of each color in the RAM 103. The CPU 101 reads the bitmap data of each color from the RAM 103, outputs the bitmap data as the print image data of each color from each channel of the print image data I/F 112, and supplies the bitmap data to the printer device 13. The CPU 101 transmits/receives control information to control printing through the control information I/F 111 between the CPU 101 and the printer device 13, according to a progress situation of the print operation.

FIG. 2B is a functional block diagram illustrating an example of a function of the upper level device 10. The upper level device 10 includes interfaces (I/F) 120, 123, and 125, an RIP unit 121, a storage unit 122, and a control unit 124. The interfaces 120, 123, and 125 correspond to the external I/F 110, the print image data I/F 112, and the control information I/F 111, respectively. The RIP unit 121 and the control unit 124 are configured by a program operating on the CPU 101 in FIG. 2A. The storage unit 122 corresponds to at least one of the RAM 103 or the HDD 104 in FIG. 2A.

The print job data that includes the PDL data is generated by the host device 5 and is transmitted to the upper level device 10. The print job data is received in the interface 120 and is supplied to the RIP unit 121. The RIP unit 121 performs rendering on the basis of the PDL data included in the supplied print job data and generates print image data based on the bitmap data of each color of Y, C, M, and K. The RIP unit 121 sequentially stores the generated print image data of each color of Y, C, M, and K in the storage unit 122.

The control unit 124 communicates with the printer controller 14 of the printer device 13 through the interface 125. For example, the control unit 124 generates control information to control printing in the printer device 13, on the basis of the print job data supplied from the host device 5 through the interface 120. The control information is transmitted from the control unit 124 to the printer controller 14 through the interface 125.

The interface 123 is configured to have independent access to the print image data of each color of Y, C, M, and K stored in the storage unit 122. The interface 123 is connected to the printer device 13 through the plurality of data lines 11 corresponding to the individual colors of Y, C, M, and K, and exchanges control information related to print image data transfer of each color of Y, C, M, and K between the interface 123 and the printer device 13 or transmits print image data of each color of Y, C, M, and K.

### <Printer Device>

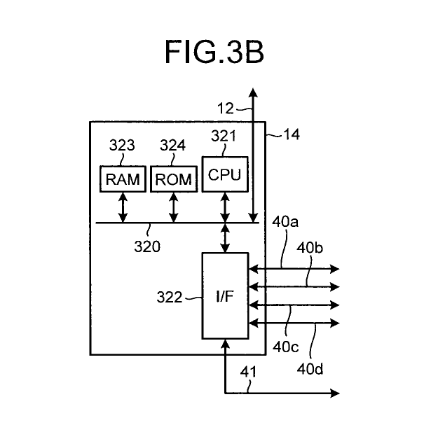

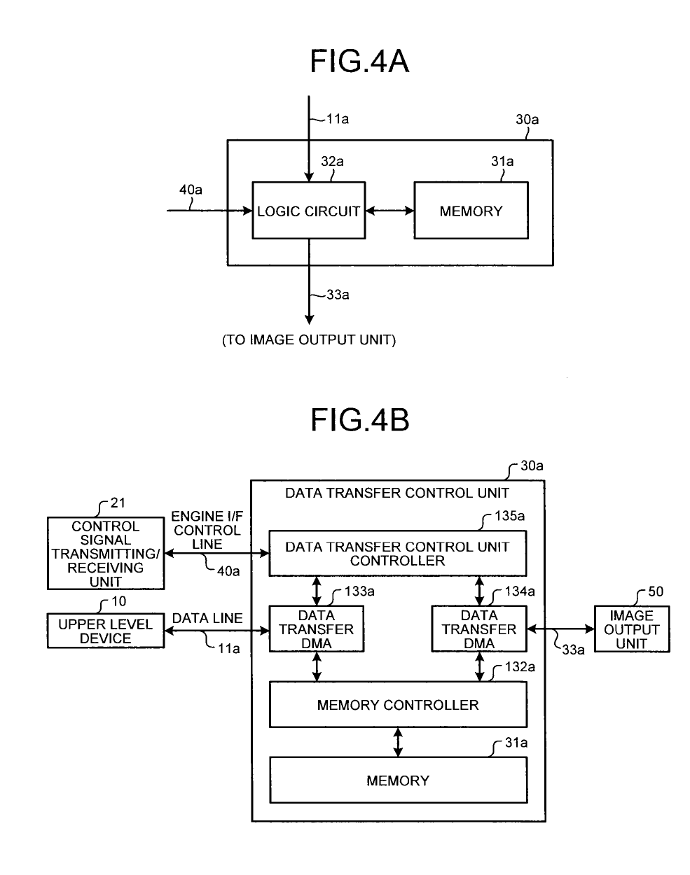

FIG. 3A illustrates an example of the configuration of the printer device 13. The printer device 13 includes a printer controller 14 and a printer engine 15. The printer controller 14 is connected to the control line 12, and exchanges control information with the upper level device 10 through the control line 12 to control a print operation. The printer engine 15 is connected to the plurality of data lines 11a, 11b, 11c, and 11d and executes a printing process of print image data of each color that is transmitted from the upper level device 10 through the data lines 11a, 11b, 11c, and 11d according to the control of the printer controller 14.

The printer controller 14 and the printer engine 15 will be described in more detail. The printer controller 14 includes a control information transmitting/receiving unit 20, a control signal transmitting/receiving unit 21, a paper conveyance control unit 22, and a control unit 23.

The control information transmitting/receiving unit 20 exchanges control information to control printing with the upper level device 10 through the control line 12. The control signal transmitting/receiving unit 21 is connected to data transfer control units 30a, 30b, 30c, and 30d to be described below through engine I/F control lines 40a, 40b, 40c, and 40d. The control signal transmitting/receiving unit 21 exchanges a control signal individually with the data transfer control units 30a, 30b, 30c, and 30d. The paper conveyance control unit 22 is connected to a conveyance control unit 51 to be described below through a conveyance control line 41 and exchanges a control signal with the conveyance control unit 51 to control paper conveyance.

The control unit 23 includes a CPU, a ROM, and a RAM, and uses the RAM as a work memory to control the individual units of the printer controller 14 according to a program previously stored in the ROM. The control unit 23 analyzes control information that is transmitted from the upper level device 10 and is received by the control information transmitting/receiving unit 20 and delivers the control information to the control signal transmitting/receiving unit 21 or the paper conveyance control unit 22.

The control information transmitting/receiving unit 20, the control signal transmitting/receiving unit 21, and the paper conveyance control unit 22 may be configured as hardware controlled by the control unit 23 and may be configured as a program module that operates on the control unit 23.

FIG. 3B illustrates an example of the hardware configuration of the printer controller 14. The printer controller 14 includes a CPU 321, an interface (I/F) 322, a RAM 323, and a ROM 324. The CPU 321, the interface (I/F) 322, the RAM 323, and the ROM 324 are connected to a bus 320 such that they can communicate with each other. To the bus 320, a control line 12 is also connected through a communication I/F not illustrated in the drawings. The CPU 321 operates using the RAM 323 as the work memory according to the program stored in the ROM 324 and controls all the operations of the printer device 13. The interface 322 includes a logic circuit that is configured in a hardware manner and controls communication with a printer controller 14, data transfer control units 30a, 30b, 30c, and 30d and a conveyance control unit 51.

In this configuration, for example, functions of the control signal transmitting/receiving unit 21 and the paper conveyance control unit 22 illustrated in FIG. 3A are realized by the I/F 322. The function of the control unit 23 is realized by the program operated on the CPU 321. The function of the control information transmitting/receiving unit 20 is realized by a communication I/F not illustrated in the drawings and the bus 320.

Returning to the description of FIG. 3A, the printer engine 15 includes the plurality of data transfer control units 30a, 30b, 30c, and 30d that have the same configuration, an image output unit 50 that outputs an image based on the print image data to paper and forms an image, and a conveyance control unit 51 that controls conveyance of printing paper.

The data lines 11a, 11b, 11c, and 11d are connected to the data transfer control units 30a, 30b, 30c, and 30d, respectively. The data transfer control units 30a, 30b, 30c, and 30d include memories 31a, 31b, 31c, and 31d, respectively, and store the print image data of the individual colors transmitted from the upper level device 10 through the data lines 11a, 11b, 11c, and 11d in the memories 31a, 31b, 31c, and 31d.

Each of the memories 31a, 31b, 31c, and 31d has the same memory capacity and the same address configuration. Each of the memories 31a, 31b, 31c, and 31d preferably has the memory capacity that can store print image data of at least three pages. For example, the three pages of the print image data correspond to print image data of a page during transmission from the upper level device 10, print image data of a page during an output, and print image data of the next page. However, the present invention is not limited thereto and each of the memories 31a, 31b, 31c, and 31d may store print image data of two pages or less.

The data transfer control units 30a, 30b, 30c, and 30d are connected to the control signal transmitting/receiving unit 21 by engine I/F control lines 40a, 40b, 40c, and 40d, respectively. The control signal transmitting/receiving unit 21 can transmit/receive a control signal between the data transfer control units 30a, 30b, 30c, and 30d through the engine I/F control lines 40a, 40b, 40c, and 40d.

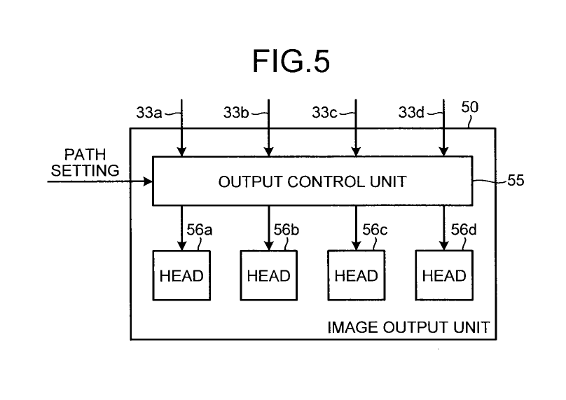

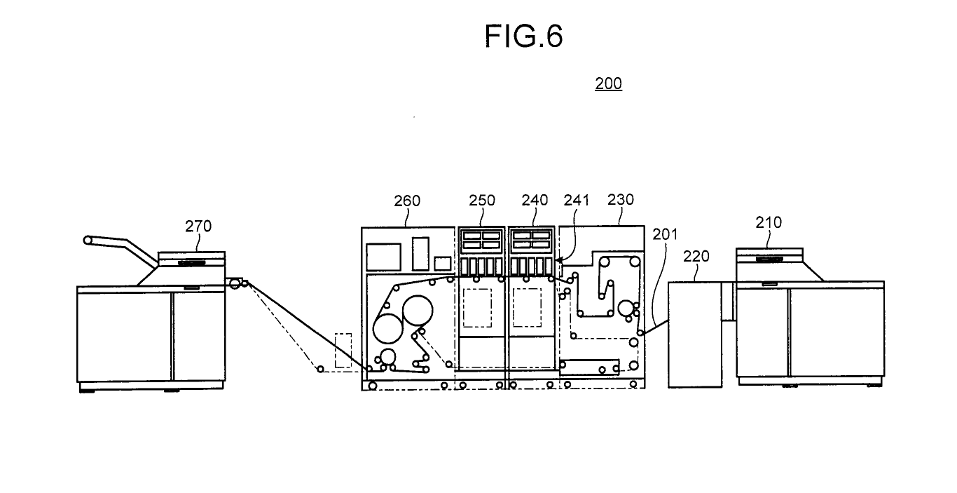

FIG. 4A schematically illustrates an example of the configuration of the data transfer control unit 30a. Since the common configuration is applied to the data transfer control units 30a, 30b, 30c, and 30d, the configuration of the data transfer control unit 30a among the data transfer control units 30a, 30b, 30c, and 30d is illustrated representatively in FIG. 4A.

The data transfer control unit 30a includes a memory 31a and a logic circuit 32a. The engine I/F control line 40a and the data line 11a are connected to the logic circuit 32a. The logic circuit 32a stores the print image data transmitted from the upper level device 10 through the data line 11a in the memory 31a, according to the control signal received from the control signal transmitting/receiving unit 21 through the engine I/F control line 40a. Likewise, the logic circuit 32a reads the print image data from the memory 31a according to a control signal received from the control signal transmitting/receiving unit 21 through the engine I/F control line 40a and supplies the print image data to an image output unit 50 to be described through an output line 33a.

The control by the logic circuit 32a that is configured in a hardware manner with a combination of logic circuits is advantageous in that a high-speed process can be executed, over the control by a CPU which uses interrupts to make a program diverge into processes. For example, the logic circuit 32a performs logic determination with respect to a control signal based on a bit string that is received through the engine I/F control line 40a and determines a process to be executed. However, the present invention is not limited thereto and the same function as that of the logic circuit 32a may be realized in a hardware manner using the CPU.

The print image data of the individual colors that are output from the data transfer control units 30a, 30b, 30c, and 30d is supplied to the image output unit 50. The image output unit 50 executes printing based on the print image data of each color. In each embodiment, printing of the print image data is performed by an inkjet system that ejects ink from nozzles in heads and performs printing. However, the printing system is not limited to the inkjet system and a laser printer system may be used.

FIG. 4B specifically illustrates an example of the configuration of the data transfer control unit 30a. In FIG. 4B, components that are common to those of FIG. 4A are denoted by the same reference numerals and the redundant description will not be repeated. The data transfer control unit 30a includes a memory 31a, a memory controller 132a, data transfer direct memory accesses (DMA) 133a and 134a, and a data transfer control unit controller 135a. Among these components, the memory controller 132a, the data transfer DMAs 133a and 134a, and the data transfer control unit controller 135a are included in the logic circuit 32a illustrated in FIG. 4A.

The memory controller 132a controls access with respect to the memory 31a. The data transfer DMA 133a receives print image data from the upper level device 10 and writes the print image data in the memory 31a through the memory controller 132a. The data transfer DMA 134a reads data from the memory 31a through the memory controller 132a and transmits the data to the image output unit 50 through the output line 33a. The data transfer control unit controller 135a receives control information that is transmitted from the control signal transmitting/receiving unit 21 in the printer controller 14 through the engine I/F control line 40a and controls the data transfer DMAs 133a and 134a according to the received control information.

For example, once a data transfer start request transmitted from the control signal transmitting/receiving unit 21 is received in the data transfer control unit controller 135a through the engine I/F control line 40a, the data transfer control unit controller 135a instructs the data transfer DMA 133a to start to transmit data, according to the data transfer start request. The data transfer DMA 133a transmits the data transfer request to the upper level device 10 through the data line 11a according to the instruction. For example, the data that is transmitted from the upper level device 10 according to the data transfer request is received in the data transfer DMA 133a and is written at a predetermined address of the memory 31a through the memory controller 132a.

Once the printing instruction that is transmitted from the control signal transmitting/receiving unit 21 is received in the data transfer control unit controller 135a through the engine I/F control line 40a, the data transfer control unit controller 135a instructs the data transfer DMA 134a to read data from the memory 31a. The data transfer DMA 134a reads data from the memory 31a through the memory controller 132a, according to the instruction. The data transfer DMA 134a transmits the read data to the image output unit 50 through the output line 33a.

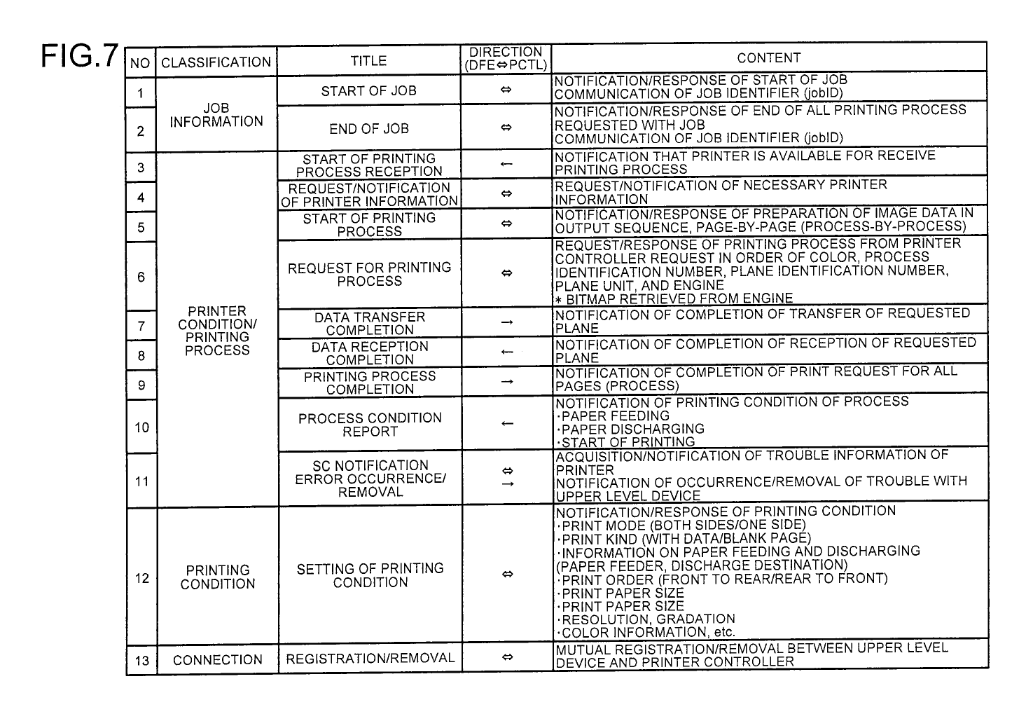

FIG. 5 illustrates an example of the configuration of the image output unit 50. The image output unit 50 includes an output control unit 55 and heads 56a, 56b, 56c, and 56d of the individual colors of Y, C, M, and K. A relation between the colors and the heads 56a, 56b, 56c, and 56d is not limited to the above example. The output control unit 55 controls connection of output lines 33a, 33b, 33c, and 33d to which print image data of the data transfer control units 30a, 30b, 30c, and 30d is output and the heads 56a, 56b, 56c, and 56d. That is, the output control unit 55 can set a path such that each of the heads 56a, 56b, 56c, and 56d is connected to any one output line selected from the output lines 33a, 33b, 33c, and 33d.

For example, the output control unit 55 may set the output lines 33a, 33b, 33c, and 33d and the heads 56a, 56b, 56c, and 56d to be connected in a one-to-one relation. Further, the output lines 33a, 33b, 33c, and 33d may be set to be connected to the heads 56a, 56b, 56c, and 56d in a one-to-multiple relation, such that the heads 56a, 56b, 56c, and 56d are connected to the output line 33a.

Paths to connect the output lines 33a, 33b, 33c, and 33d with the heads 56a, 56b, 56c, and 56d may be set by an operation from the user using a DIP switch. However, the present invention is not limited thereto and the paths may be set by a control signal from the control signal transmitting/receiving unit 21.

As described above, in the printer device 13 according to each embodiment, transmission of the print image data from the upper level device 10 and transmission/reception of a control signal to control printing of the print image data between the upper level device 10 and the printer device 13 are performed through different paths. The print image data of the individual colors is transmitted from the upper level device 10 through the different data lines 11a, 11b, 11c, and 11d and the print image data of the individual colors that is transmitted through the data lines 11a, 11b, 11c, and 11d is independently controlled and is supplied to the data transfer control units 30a, 30b, 30c, and 30d that have the same configuration. Further, in the image output unit 50, connection paths of outputs of the data transfer control units 30a, 30b, 30c, and 30d and the heads 56a, 56b, 56c, and 56d of the individual colors can be set by a user operation or the like.

Therefore, the printer device 13 according to each embodiment can easily change the configuration of the printer engine 15, according to the number of colors of the print image data (four colors of Y, C, M, and K or only color of K) or the number of heads used by the image output unit 50. At this time, the printer engine 15 may be provided with only the necessary units among the data transfer control units 30a, 30b, 30c, and 30d according to the required configuration.

For example, in a case of performing a full-color printing with four colors Y, C, M, and K, all of the data transfer control units 30a, 30b, 30c, and 30d may be provided in the printer engine 15. In the output control unit 55, the outputs of the data transfer control units 30a, 30b, 30c, and 30d may be connected to the heads 56a, 56b, 56c, and 56d, respectively. For example, in a case of performing a mono-color printing with only color K, it may be configured from a cost viewpoint that only the data transfer control unit 30a is provided with only the head 56a. And, in the output control unit 55, the output of the data transfer control unit 30a can be connected to the head 56a. Alternatively, in the case of performing the mono-color printing with the only color K, it may be configured form a speed viewpoint that only the data transfer control unit 30a is provided with four heads 56a, 56b, 56c and 56d. And, in the output control unit 55, the output of the data transfer control unit 30a can be connected to four heads 56a, 56b, 56c and 56d. In this case, the same color is printed overlappingly a plurality of times. Therefore, for example, a high speed printing may be realized by shortening the ejection time of ink from heads 56a, 56b, 56c and 56d respectively to ¼ of the usual ejection time and increasing the conveyance speed of sheet paper to quadruple of the usual conveyance speed.

### <Conveyance System of Printing Paper>

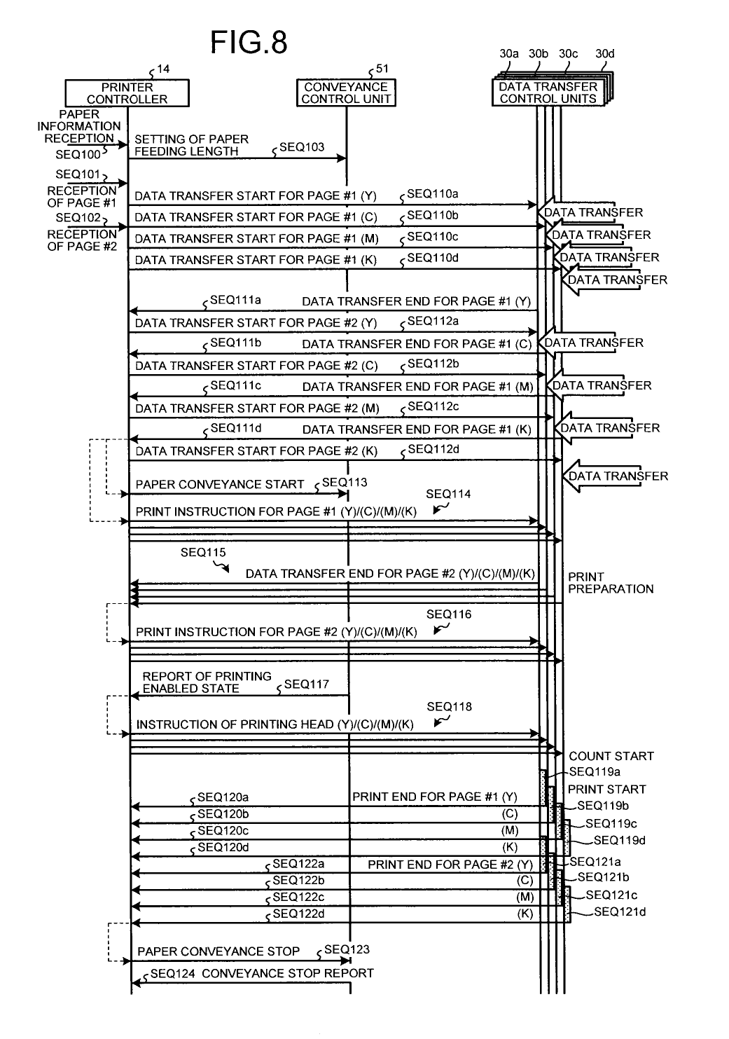

Referring to FIG. 3A, the conveyance control unit 51 is connected to the paper conveyance control unit 22 by the conveyance control line 41 and controls conveyance of paper to which an image is formed by the image output unit 50 on the basis of the print image data. FIG. 6 schematically illustrates an example of the configuration of a printer device 200 that includes a conveyance system of paper that can be applied to each embodiment of the present invention. As described above, in each embodiment, the printer device 200 uses continuous paper as printing paper.

Printing paper 201 is fed from a printing paper feeding unit 210 to a first conveyance unit 230 through a power supply operation box 220. In the first conveyance unit 230, the printing paper 201 is conveyed through plural rollers by conveyance control of the conveyance control unit 51, is aligned, and is fed to printer engine units 240 and 250 that correspond to the printer engine 15.

In a printing unit 241 that corresponds to the image output unit 50, the printer engine units 240 and 250 perform printing according to print image data with respect to the printing paper 201 fed from the first conveyance unit 230. The printing paper 201 where the printing ends is discharged from the printer engine unit 250 by the conveyance control of the conveyance control unit 51 and is fed to a second conveyance unit 260. The printed paper 201 is conveyed to a predetermined position by the second conveyance unit 260 to be discharged, and is fed to a cutting unit 270. The printed paper 201 is cut by the cutting unit 270 according to perforations and divided into individual pages.

In this case, the printing paper continuously exists even in a path until the printing paper 201 is discharged from the second conveyance unit 260 after printing is performed on the printing paper 201 in the printer engine units 240 and 250, in order for the printer device 200 to perform printing on the printing paper 201 which is the continuous paper.

The configuration that includes the first conveyance unit 230, the printer engine units 240 and 250, and the second conveyance unit 260 is additionally prepared, the printed paper 201 that is discharged from the second conveyance unit 260 disposed on the front side is reversed and fed to the first conveyance unit 230 disposed on the rear side, and both-sided printing with respect to the printing paper 201 can be performed.

### <Detail of Printing Process Applicable to Each Embodiment>

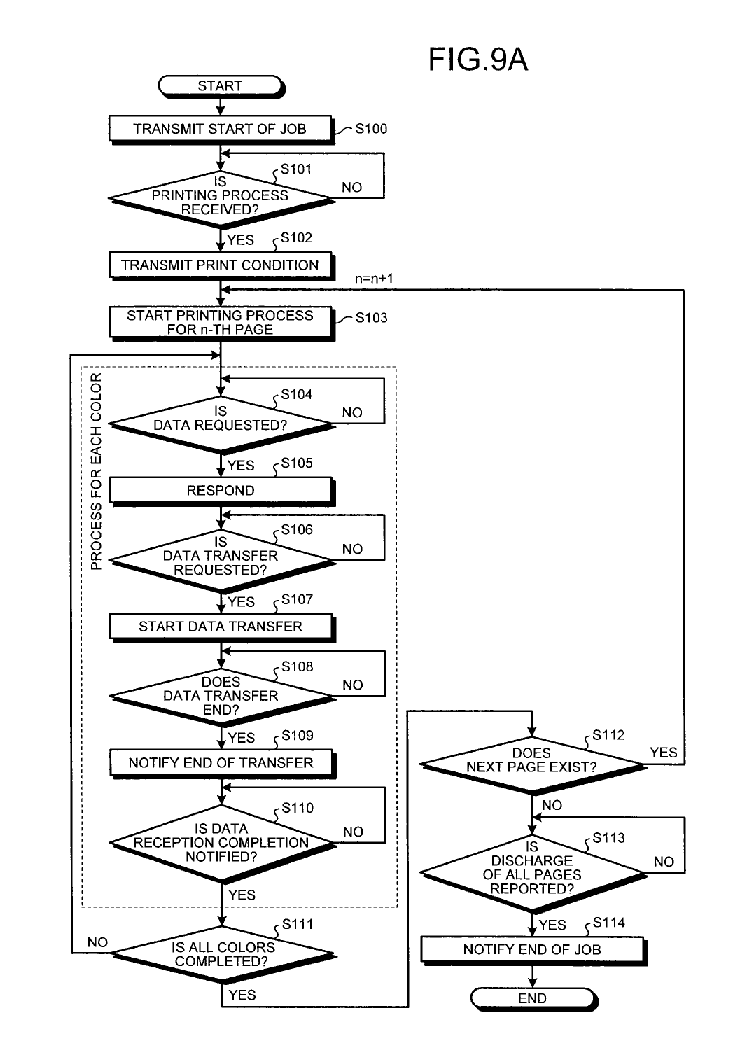

Next, a printing process applicable to each embodiment will be further described in detail. FIG. 7 illustrates an example of control information that is transmitted/received between the upper level device 10 and the printer controller 14 of the printer device 13 through the control line 12. In FIG. 7, the upper level device 10 is illustrated as a digital front end processor (DFE) and the printer controller 14 is illustrated as a PCTL. The control information roughly includes (i) job information, (ii) information indicating a printer status and a printing process, (iii) information indicating a printing condition, and (iv) information indicating a connection.

The job information is used to notify a job start and a job end. The job start includes a notification of the job start with respect to the printer controller 14 from the upper level device 10 and a response from the printer device 13 to the upper level device 10 with respect to the notification. The job end includes a notification of an end of all of the printing processes that are requested by the job start with respect to the printer controller 14 from the upper level device 10 and a response from the printer controller 14 to the upper level device 10 with respect to the notification. At the time of a response in the job start and the job end, a job identifier (jobID) to identify a job is transmitted from the printer controller 14 to the upper level device 10.

The information indicating a printer status and a printing process includes a printing process reception start notification, a request/notification of printer information, a printing process start notification, a printing process request, a data transfer completion notification, a data reception completion notification, a printing process completion notification, a process status report, a service control (SC) notification, and an error occurrence and removal notification.

As for the printing process reception start notification, the printer device 13 notifies the upper level device 10 that the printer controller 14 is ready to receive a printing process. The request/notification of printer information includes a request of necessary printer information from the upper level device 10 to the printer controller 14, as well as a response to the request from the printer controller 14 to the upper level device 10.

The printing process start notification includes a notification from the upper level device 10 to the printer controller 14 indicating that the preparation of the print image data is completed and a response to the notification from the printer device 13 to the upper level device 10. The notification indicating that the preparation of the print image data is completed is notified in accordance with the sequence of the output of the print image data, page-by-page (process-by-process). It can be said that the page is a print unit by which a series of printing operation is performed.

The printing process request includes a notification of printing process from the printer controller 14 to the upper level device 10 and a response to the notification from the upper level device 10 to the printer controller 14. The printer controller 14 notifies the upper level device 10 of color information (yellow, cyan, magenta, or black) indicating the colors Y, C, M, or K to perform printing, a process identification number (processID), and a plane identification number. In the case of printing with only a single color, the color information indicating the color of the printing object is notified to the upper level device 10 together with the process identification number (processID) and the plane identification number.

Note that the plane corresponds to each of images from print image data of each color printed on one page. The printer controller 14 notifies these kinds of information for every plane in accordance with the sequence of requests from engine, i.e. the data transfer control units 30a, 30b, 30c and 30d. That is, the printer engine 15 retrieves the print image data composed of bitmap data from the upper level device 10.

As for the data transfer completion notification, the completion of transferring the print image data as for the requested plane is notified from the upper level device 10 to the printer controller 14. As for the data reception completion notification, the completion of receiving the print image data as for the requested plane is notified from the printer controller 14 to the upper level device 10. As for the printing process completion notification, the completion of print request for all pages (process) is notified from the upper level device 10 to the print controller 14. As for the process status report, the print status of pages (process) is notified from the printer controller 14 to the upper level device 10. At this time, the printer controller 14 acquires from the printer engine 15 the information about feeding or discharging of sheets or the information about the print start timing, and adds the acquired information to the completion notification. Then, the notification to which the acquired information is added is transmitted to the upper level device 10.

As for the SC notification, an acquisition of obstacle information is requested from the upper level device 10 to the printer controller 14. The obstacle information acquired according to the request is notified from the printer controller 14 to the upper level device 10. As for the error occurrence and removal, an occurrence of any error and a removal thereof at the upper level device 10 is notified from the upper level device 10 to the printer controller 14.

The information indicating printing conditions includes setting the printing conditions, that is, a notification of the printing conditions from the upper level device 10 to the printer controller 14 and a response from the printer controller 14 to the notification. Examples of the printing conditions include a printing form, a printing type, feeding/discharging information, printing surface order, a printing paper size, a print data size, resolution and gradation, and color information.

The printing form indicates, for example, whether both-sided printing or a single-sided printing is performed on the printing paper 201. The printing type indicates whether print image data exists and thus the print image data is printed or the print image data does not exist and thus a white page is output without printing the print image data. The feeding/discharging information indicates identification information, such as a stacker of a discharging destination or a feeding origin of the printing paper 201. The printing surface order indicates whether printing is performed from a front surface to a back surface of the printing paper 201 or is performed from the back surface to the front surface. The printing paper size indicates, for example, the length of a page to be printed in a conveyance direction of the printing paper 201, when continuous paper is used as the printing paper 201. The print data size indicates a data size of the print image data. That is, the print data size indicates a size of the print image data corresponding to one page. The resolution and gradation indicates resolution and gradation of the case where the print image data is printed on the printing paper 201. The color information indicates, for example, whether to perform printing using a full color in which the colors Y, C, M, and K are used, or to perform printing using a single color in which only the color K is used.

The information indicating the connection includes registration and release, and specifically includes registration of information in each opponent between the upper level device 10 and the printer controller 14, and release of the registered information.

### <Printing Sequence>

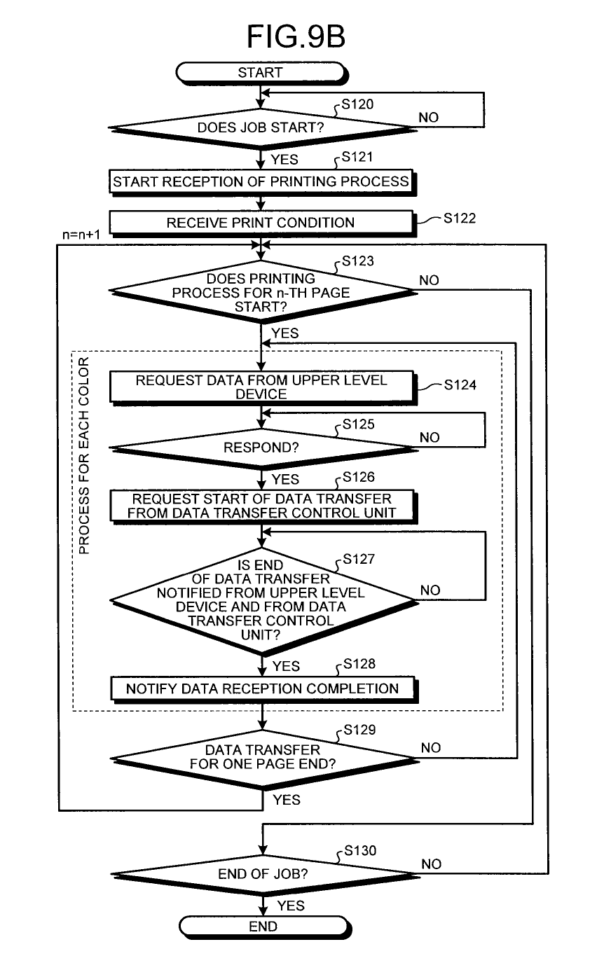

Next, a printing process applicable to each embodiment will be described. FIG. 8 is a sequence diagram conceptually illustrating an example of the printing process that can be applied to each embodiment. In this case, full-color printing using the individual colors Y, C, M, and K is performed. If the printer controller 14 receives information related to the printing paper 201 as control information from the upper level device 10 (SEQ100), paper feeding length is set to the conveyance control unit 51 on the basis of the received information (SEQ103). The paper feeding length is, for example, a size of one page in a conveyance direction.

If the printer controller 14 receives control information indicating a job start of a first page (page #1) from the upper level device 10 (SEQ101), the printer controller 14 requests the data transfer control units 30a, 30b, 30c, and 30d to start data transfer of the first page with respect to the colors Y, C, M, and K (SEQ110a, SEQ110b, SEQ110c, and SEQ110d). The data transfer control unit 30a requests the upper level device 10 to transmit print image data of the first page of the color Y according to the request through the data line 11a, and stores the print image data of the first page of the color Y transmitted from the upper level device 10 in the memory 31a, according to the request.

Similar to the data transfer control unit 30a, the data transfer control units 30b, 30c, and 30d request the upper level device 10 to transmit the print image data of the individual colors C, M, and K of the first page through the data lines 11b, 11c, and 11d according to the requests from SEQ110b, SEQ110c, and SEQ110d. Each of the data transfer control units 30b, 30c, and 30d stores the print image data of the first page of the individual colors C, M, and K transmitted from the upper level device 10 according to the request in the memories 31b, 31c, and 31d.

Meanwhile, in the example of FIG. 8, while the data transfer of the first page is requested from the printer controller 14 to each of the data transfer control units 30a, 30b, 30c, and 30d, the printer controller 14 receives control information indicating a job start of the next second page transmitted from the upper level device 10 (SEQ102). The received control information is held in, for example, the RAM 323.

Once the print image data transfer of the first page of each color from the upper level device 10 ends, each of the data transfer control units 30a, 30b, 30c, and 30d notifies the printer controller 14 of the end of the transmission (SEQ111a, SEQ111b, SEQ111c, and SEQ111d). The printer controller 14 requests each of the data transfer control units 30a, 30b, 30c, and 30d to start the data transfer of the second page (page #2), in response to the notification (SEQ112a, SEQ112b, SEQ112c, and SEQ112d).

Each of the data transfer control units 30a, 30b, 30c, and 30d requests the upper level device 10 to transmit the print image data of the second page of each color, according to the request, and stores the print image data of the second page of each color transmitted from the upper level device 10 in the memories 31a, 31b, 31c, and 31d, according to the request.

Each of the data transfer control units 30a, 30b, 30c, and 30d can recognize the end of the data transfer on the basis of the data amount of the transmitted print image data. The information indicating the data amount of the printing image corresponding to one page, for example, is added to the head of the print image data by the upper level device 10 and is transmitted, when the data transfer starts with respect to each of the data transfer control units 30a, 30b, 30c, and 30d. In a case that a predetermined unit of the print image data is transferred, it may be configured that the upper level device 10 adds any end information for indicating the completion of transferring one page to the last transferred unit of the print image data corresponding to the end of one page. Alternatively, it may be configured that the upper level device 10 transmits any information for indicating the completion of transferring the print image data corresponding to one page to each data transfer control unit 30a, 30b, 30c and 30d independently of the print image data, for example immediately after the print image data corresponding to one page is transferred.

Meanwhile, once the printer controller 14 receives the notification of the completion of transferring the data of the first page from all of the data transfer control units 30a, 30b, 30c, and 30d, the printer controller 14 requests the conveyance control unit 51 to start the paper conveyance (SEQ113). The conveyance control unit 51 starts conveyance at a predetermined speed of the printing paper 201 according to the request. The printer controller 14 requests the conveyance control unit 51 to start the paper conveyance and instructs each of the data transfer control units 30a, 30b, 30c, and 30d to start printing of the first page (SEQ114).

If the printing paper 201 reaches a predetermined position, the conveyance control unit 51 notifies the printer controller 14 of a printing enabled state (SEQ117). The printer controller 14 instructs each of the data transfer control units 30a, 30b, 30c and 30d of the print start position, according to the printing enabled state report from the conveyance control unit 51 (SEQ118).

Each of the data transfer control units 30a, 30b, 30c and 30d starts the printing operation according to the print start position instruction. In this example, the heads of the individual colors Y, C, M, and K are arranged in order of the heads 56a, 56b, 56c, and 56d along a conveyance direction of the printing paper 201. In this case, once the print start position of the first page in the printing paper 201 reaches a position to be printed by the head 56a, the data transfer control unit 30a firstly starts reading out the print image data of the first page from the memory 31a. The print image data of the color Y read from the memory 31a is transmitted to the image output unit 50. The print image data is supplied to the head 56a through the output control unit 55 and printing with respect to the printing paper 201 is performed (SEQ119a). Once printing the first page of the color Y is completed, the completed of the printing is notified to the printer controller 14 (SEQ120a).

Next, once the print start position of the first page in the printing paper 201 reaches a position to be printed by the head 56b, the data transfer control unit 30b starts reading out the print image data of the first page from the memory 31b. The print image data of the color C read from the memory 31b is transmitted to the image output unit 50. The print image data is supplied to the head 56b through the output control unit 55 and printing with respect to the printing paper 201 is performed (SEQ119b). Once printing the first page of the color C ends, the end of the printing is notified to the printer controller 14 (SEQ120b).

Hereinafter, in the same way as mentioned above, the printing operations with the colors M and K are sequentially started (SEQ119c and SEQ119d). Once the printing operations with the colors M and K are completed, the completion of the printing operation is notified to the printer controller 14 (SEQ120c and SEQ120d).

Meanwhile, once transferring each color print image data of the second page started at SEQ112a to SEQ112d are completed, each of the data transfer control units 30a, 30b, 30c and 30d notifies the printer controller 14 of the completion of transferring the data (SEQ115). The printer controller 14 instructs each of the data transfer control units 30a, 30b, 30c and 30d to start printing the second page, according to the data transfer completion notification (SEQ116).

Each of the data transfer control units 30a, 30b, 30c and 30d starts to print the second page after the completion of printing the first page. For example, when the print start position of the second page in the printing paper 201 reaches a position to be printed by the head 56a after the completion of printing the first page (SEQ120a), the data transfer control unit 30a reads out the print image data of the color Y of the second page from the memory 31a, supplies the print image data to the image output unit 50, and starts printing on the printing paper 201 (SEQ121a). Once the printing operation of the color Y is completed, the completion of the printing operation is notified to the printer controller 14 (SEQ122a).

In the same way, also in the data transfer control units 30b, 30c, and 30d, when the print start position of the second page reaches each position to be printed by the heads 56b, 56c, and 56d, each color print image data is read from the memories 31b, 31c and 31d, respectively, and printing with respect to the printing paper 201 is started (SEQ121b to SEQ121d). When the printing operation of each color is completed, the completion of the printing operation of each color is notified to the printer controller 14 (SEQ122b to SEQ122d).

Once the printer controller 14 receives the printing process completion notification of the color K of the second page from the data transfer control unit 30d, the printer controller 14 assumes that the printing operation of the final page according to the print job ends and requests the conveyance control unit 51 to stop conveyance of the printing paper 201 (SEQ123). The conveyance control unit 51 stops conveyance of the printing paper 201 according to the request and reports the stop of conveyance to the printer controller 14 (SEQ124). Thereby, a series of printing processes terminates.

### <Detail of Printing Process>

Next, a printing process applicable to each embodiment will be described in detail. In each embodiment, each of the data transfer control units 30a to 30d acquires control information to control printing, from the upper level device 10, under the control of the printer controller 14. Each of the data transfer control units 30a to 30d stores print image data of each color transmitted from the upper level device 10 in the memories 31a to 31d, under the control of the printer controller 14.

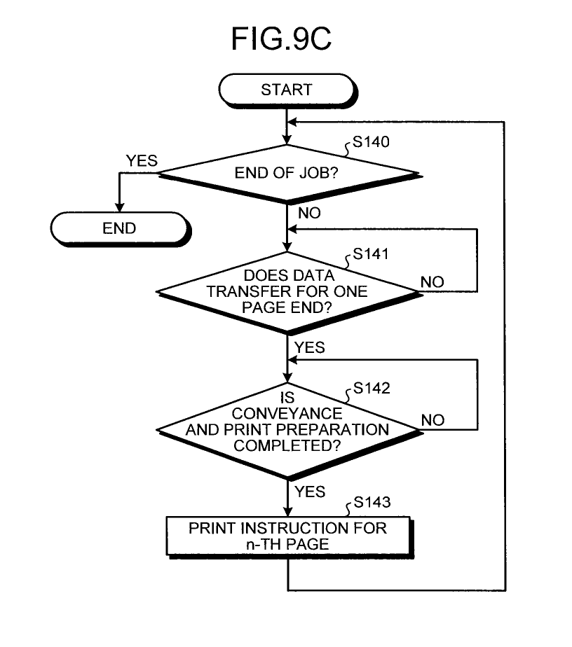

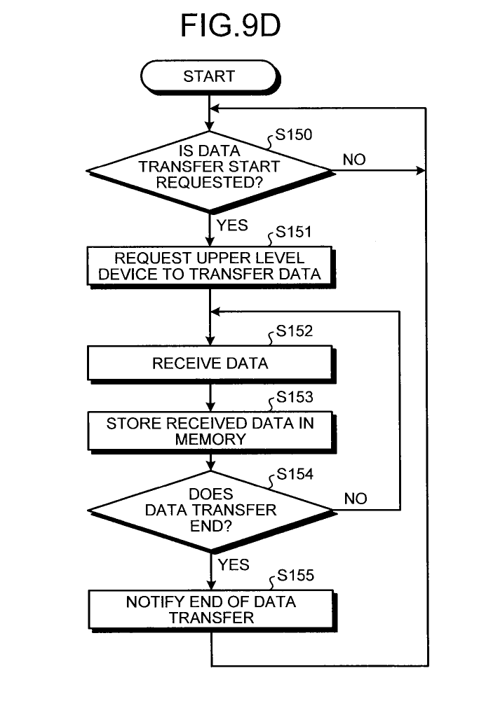

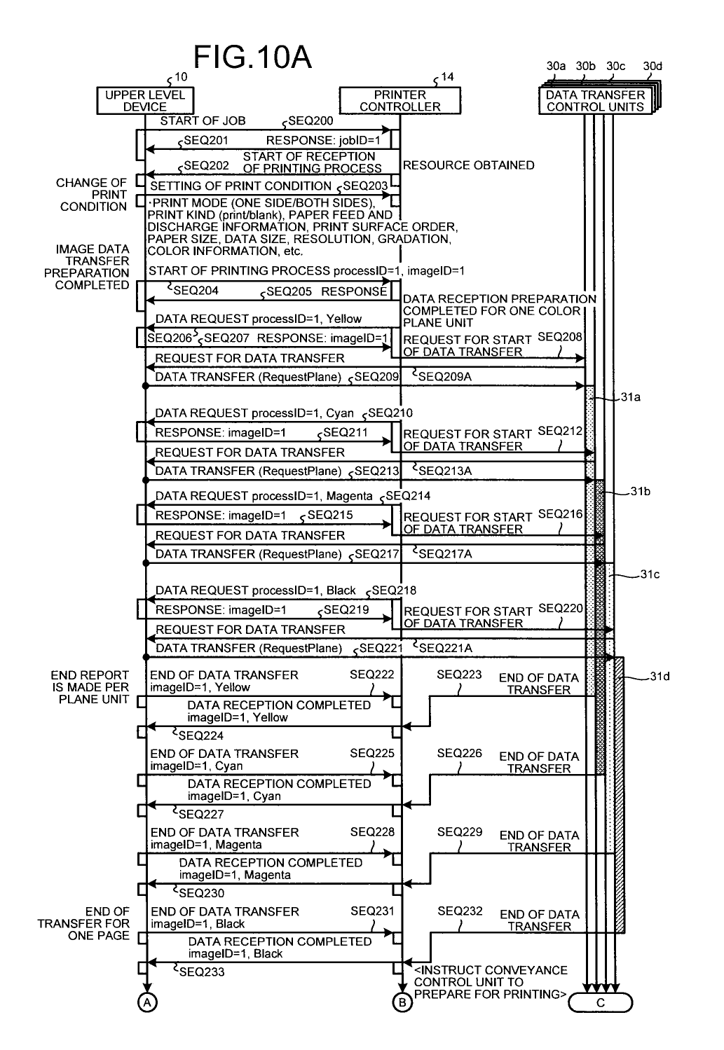

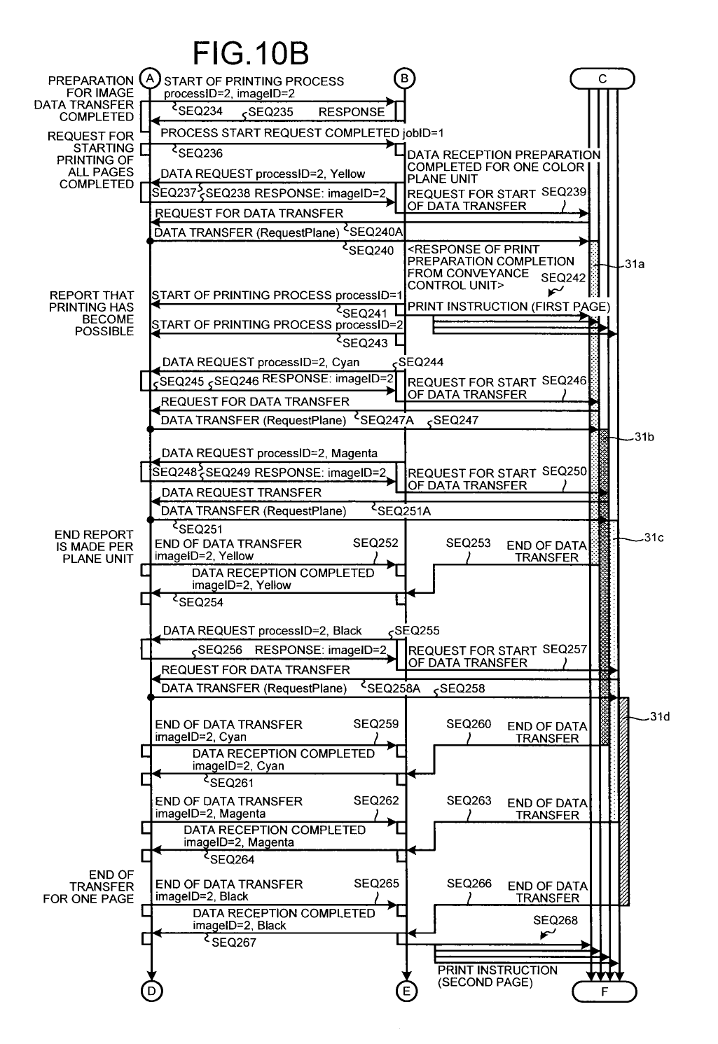

A data transfer process of the print image data that can be applied to each embodiment will be described using flowcharts of FIGS. 9A to 9D. Hereinafter, the data lines 11a, 11b, 11c, and 11d transmit print image data of the colors Y, C, M and K, respectively, and the data transfer control units 30a, 30b, 30c and 30d control the transfer of the print image data of the colors Y, C, M and K, respectively.

FIG. 9A is a flowchart illustrating an example of a process in the upper level device 10 relating to data transfer. Once the upper level device 10 receives job data from the host device 5, the upper level device 10 transmits control information indicating a job start to the printer controller 14 through the control line 12, in step S100. The upper level device 10 stands by a control signal that is transmitted from the printer controller 14 in response to the control signal and indicates printing process reception (step S101).

Once the upper level device 10 receives the control signal indicating the printing process reception from the printer controller 14, the upper level device 10 transmits control information indicating printing conditions in job data to the printer controller 14 through the control line 12 in step S102. Next, in step S103, the upper level device 10 sets a page number to “n” and transmits a control signal to control a printing process start of the n-th page to the printer controller 14 through the control line 12. The processes from step S103 to step S112 are executed in a page unit.

The processes of steps S104 to S110 become processes that are executed on the individual colors of Y, C, M, and K. Hereinafter, a process that is related to the color Y will be mainly described. In step S104, the upper level device 10 stands by a request for transmission of the print image data of the color Y from the printer controller 14. Once the upper level device 10 receives a data transfer request transmitted from the printer controller 14 through the control line 12, the upper level device 10 returns a response to the received data request to the printer controller 14 in step S105. Next, in step S106, the upper level device 10 stands by a data transfer request that is transmitted from the data transfer control unit 30a through the data line 11a.

Once the upper level device 10 receives the data transfer request from the data transfer control unit 30a through the data line 11a, the upper level device 10 starts the transfer of the print image data of the color Y with respect to the data transfer control unit 30a in step S107. The print image data of the color Y is transmitted to the data transfer control unit 30a through the data line 11a. At this time, the upper level device 10 adds information indicating a size of the print image data to the transmitted print image data of the color Y.

In step S108, the upper level device 10 stands by the completion of transferring the data corresponding to one page of the color Y. Referring to FIG. 2B, the upper level device 10 monitors the storage unit 122 and the interface 123 using the control unit 124 and determines whether transferring the data corresponding to one page is performed with respect to the individual colors Y, C, M, and K. When it is determined that the transfer of the data corresponding to one page of the color Y terminates, the upper level device 10 makes the process proceed to step S109 and the data transfer completion notification indicating that the transfer of the data corresponding to one page terminates is transmitted to the printer controller 14 through the control line 12. In step S110, the upper level device 10 stands by a data reception completion notification with respect to the color Y, from the printer controller 14.

In step S111, the upper level device 10 determines whether the data reception completion notification is received for all of the colors Y, C, M, and K. When it is determined that the data reception completion notification is not received, the process returns to step S104 and the upper level device 10 executes a process on the next color.

In FIG. 9A, the processes of steps S104 to S110 has been described to be sequentially executed with respect to the individual colors Y, C, M, and K. However, the present invention is not limited thereto. For example, the processes of steps S104 to S110 may be executed in parallel with respect to the individual colors Y, C, M, and K. In this case, in step S111, the upper level device 10 stands by the data reception completion notification in step S110 in the processes of the individual colors Y, C, M, and K.

Once the upper level device 10 determines that the data reception completion notifications is received with respect to all of the colors of Y, C, M, and K in step S111, the upper level device 10 makes the process proceed to step S112 and determines whether a printing process of the next page is executed. The number of pages to be printed can be acquired from the print job data that is received from the host device 5. When it is determined that the printing process of the next page exists, the page number n becomes n+1 and the process returns to step S103.

Meanwhile, when it is determined that transmission of the data corresponding to all of the pages in the print job data terminates, the upper level device 10 makes the process proceed to step S113 and stands by transmission of a discharging report of all of the pages from the printer controller 14. When the upper level device 10 receives the discharging report of all of the pages from the printer controller 14, the upper level device 10 makes the process proceed to step S114 and the upper level device 10 transmits a job end notification indicating that all of the print jobs end to the printer controller 14 through the control line 12.

FIG. 9B is a flowchart illustrating an example of a process in the printer controller 14 relating to the data transfer. In step S120, the printer controller 14 stands by the control information indicating the job start transmitted from the upper level device 10 through the control line 12. Once the printer controller 14 receives the control information, the printer controller 14 returns a response to the upper level device 10 through the control line 12, in the next step S121. In step S121, the printer controller 14 transmits the control information indicating the printing process reception start to the upper level device 10 through the control line 12. In the next step S122, the printer controller 14 receives the control information indicating the printing conditions that is transmitted from the upper level device 10 through the control line 12.

In the next step S123, the printer controller 14 determines whether the control signal transmitted from the upper level device 10 through the control line 12 and indicating the printing process start of the n-th page is received. When it is determined that the control signal is not received, the printer controller 14 makes the process proceed to step S130 and determines whether the job end notification is received from the upper level device 10 through the control line 12. When it is determined that the job end notification is not received, the process returns to step S123. Meanwhile, when it is determined that the job end notification is received in step S130, a series of printing processes terminates.

In step S123, when it is determined that the control signal transmitted from the upper level device 10 through the control line 12 and indicating the printing process start is received, the printer controller 14 makes the process proceed to step S124. The subsequent processes of steps S124 to S128 become the processes of the individual colors Y, C, M, and K. In this case, a transfer process of the print image data of the color Y will be described.

In step S124, the printer controller 14 requests the upper level device 10 to transfer the print image data through the control line 12. Next, in step S125, the printer controller 14 stands by a response from the upper level device 10 with respect to the request. Once the printer controller 14 receives the response from the upper level device 10, the printer controller 14 requests the data transfer control unit 30a to start to transfer the data through the engine I/F control line 40a in step S126.

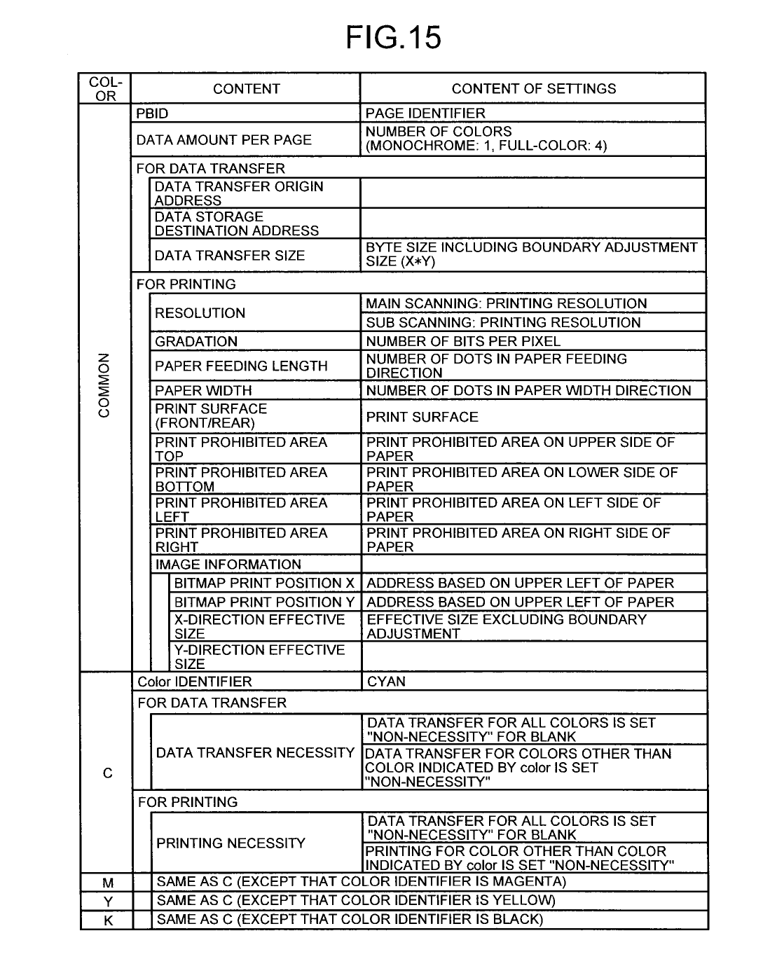

At this time, the printer controller 14 extracts a page identifier PBID indicating a page (n-th page) to perform printing and a transfer origin address indicating an address of a transfer origin of the print image data, from a transfer management table to be described below using FIG. 15. The printer controller 14 adds the extracted page identifier PBID and transfer origin address to the data transfer start request for requesting to start the data transfer and transmits it to the data transfer control unit 30a in next step S126.

In next step S127, the printer controller 14 stands by the data transfer completion notification from the upper level device 10 and the data transfer completion notification from the data transfer control unit 30a. Once the data transfer completion notification is received from the upper level device 10 and the data transfer control unit 30a through the control line 12 and the engine I/F control line 40a, the printer controller 14 makes the process proceed to step S128 and transmits the data reception completion notification with respect to the color Y to the upper level device 10 through the control line 12.

In step S129, the printer controller 14 determines whether the data transfer of all of the colors of Y, C, M, and K terminates. When it is determined that the data transfer does not terminate, the printer controller 14 makes the process to return to step S124 and executes the process with respect to the next color. Meanwhile, when it is determined that the data transfer of all of the colors Y, C, M, and K ends in step S129, the printer controller 14 sets the page number “n” to “n+1” and returns the process to step S123.

In FIG. 9B, the processes of steps S124 to S128 are sequentially executed with respect to the individual colors Y, C, M, and K. However, the present invention is not limited thereto. For example, the processes of steps S124 to S128 may be executed in parallel with respect to the individual colors Y, C, M, and K. In this case, in step S129, the printer controller 14 stands by the data reception completion notification in step S128 in the processes of the individual colors Y, C, M, and K.

The printer controller 14 transmits a printing instruction to the data transfer control units 30a to 30d through each of the engine I/F control lines 40a to 40d. By the printing instruction, the print image data is read from the memories 31a to 31d in the data transfer control units 30a to 30d and printing of the print image data with respect to the printing paper 201 is executed.

The printing instructions that are transmitted from the printer controller 14 to the individual data transfer control units 30a to 30d can be generated as a table based on information needed to perform printing, which is setting information of printing conditions, among the control information described using FIG. 7. The printer controller 14 transmits the table generated in the above-described way to each of the data transfer control units 30a to 30d.

FIG. 9C is a flowchart illustrating an example of a process that is executed when the printer controller 14 instructs printing. Before the flowchart is executed, the printer controller 14 transmits a printing preparation instruction to the conveyance control unit 51.

In step S140, the printer controller 14 determines whether the job end notification is transmitted from the upper level device 10. When it is determined that the job end notification is transmitted, the printer controller 14 terminates a series of processes. When it is determined that the job end notification is not transmitted from the upper level device 10, the printer controller 14 makes the process proceed to step S141.

In step S141, the printer controller 14 stands by the completion of transferring the print image data corresponding to at least one page with respect to each of the colors Y, C, M, and K. When it is determined that the transfer of the print image data corresponding to one page terminates, the printer controller 14 makes the process proceed to step S142 to stand by reception of a response indicating the printing preparation completion from the conveyance control unit 51. Once the printer controller 14 receives the response indicating the printing preparation completion transmitted from the conveyance control unit 51 through the conveyance control line 41, the printer controller 14 transmits a printing instruction to instruct to perform printing of the n-th page to the data transfer control units 30a to 30d through the engine I/F control lines 40a to 40d, respectively in step S143.

FIG. 9D is a flowchart illustrating an example of a process in each of the data transfer control units 30a to 30d relating to the data transfer. In this case, in order to simplify the description, the process in the color Y and the data transfer control unit 30a will be described. In step S150, the data transfer control unit 30a stands by a data transfer start request that is transmitted from the printer controller 14 through the engine I/F control line 40a.

Once the data transfer control unit 30a receives the data transfer start request, the data transfer control unit 30a transmits a data transfer request to request to transfer the print image data of the color Y to the upper level device 10 through the data line 11a in step S151. The print image data of the color Y that is transmitted from the upper level device 10 through the data line 11a according to the data transfer request is received by the data transfer control unit 30a (step S152). The data transfer control unit 30a controls a data transfer DMA 133a and stores the received print image data of the color Y in a predetermined area of the memory 31a (step S153).

In step S154, the data transfer control unit 30a determines whether the transfer of the print image data of the color Y from the upper level device 10 terminates. The data transfer control unit 30a can determine whether the transfer of the print image data terminates, on the basis of size information added to the transferred print image data. When it is determined that the transfer of the print image data does not terminate, the data transfer control unit 30a makes the process return to step S152 and continues to receive data and store the data in the memory 31a. Meanwhile, when it is determined that the transfer of the print image data terminates, the process proceeds to step S155. The data transfer control unit 30a transmits the data transfer completion notification to the printer controller 14 through the engine I/F control line 40a. Then, the process returns to step S150.

FIGS. 10A to 10C are sequence diagrams specifically illustrating an example of a printing process that can be applied to each embodiment realized according to each flowchart illustrated in FIGS. 9A to 9D. In FIGS. 10A to 10C, reference numerals A to F indicate that the process proceeds to the corresponding reference numerals between the different drawings. Hereinafter, it is assumed that a print job is to perform printing corresponding to two pages.

Referring to FIG. 10A, first, control information of the print job is transmitted from the upper level device 10 to the printer controller 14 through the control line 12 (SEQ200). The printer controller 14 transmits control information indicating the job identifier jobID=1 responding to the control information to the upper level device 10 through the control line 12 (SEQ201). The printer controller 14 acquires resources to execute a job according to the start of the job. The printer controller 14 transmits control information indicating a printing process reception start to the upper level device 10 through the control line 12 (SEQ202).

Next, the upper level device 10 transmits control information to determine printing conditions to the printer controller 14 through the control line 12 (SEQ203). The printing conditions that are set to the printer controller 14 include a printing form, a printing type, feeding/discharging information, order of printing surfaces, a size of printing paper, a data size of print image data, resolution and gradation, and color information as described with reference to FIG. 7. Further, the printing conditions may include information of the number of pages to be printed. Once the control information is received in the printer controller 14, the various printing conditions that are included in the received control information are written in a register of the printer controller 14, for example, and the printing conditions are set.

Next, the upper level device 10 transmits the control information of the printing process start of the first page to the printer controller 14 through the control line 12 (SEQ204). The control information includes a process identification number processID=1 to identify the process and an image identification number imageID=1 indicating an image constituting the first page. The printer controller 14 returns control information of the printing process start to be a response to the printing process start, to the upper level device 10 (SEQ205).

Next, the printer controller 14 transmits control information of the printing process request to the upper level device 10 and requests the upper level device 10 to transmit the print image data. The printing process request is sequentially processed in arrangement order of the colors of the printer engine 15, with respect to the individual colors Y, C, M, and K. In this example, the heads of the colors Y, C, M, and K along a conveyance direction of the printing paper 201 are arranged in order of the heads 56a, 56b, 56c, and 56d.

First, the printer controller 14 transmits the control information of the printing process request to request to transmit the print image data of the color Y to the upper level device 10 through the control line 12 (SEQ206). The control information includes process identification number processID=1 to designate a process and color information Yellow to designate the color Y. The upper level device 10 returns the control information including the image identification number imageID=1 to the printer controller 14 in response to the control information (SEQ207). Once the printer controller 14 receives the control information, the printer controller 14 requests the data transfer control unit 30a corresponding to the color Y to start to transmit the print image data (SEQ208). At this time, the printer controller 14 transmits a data size of the print image data requiring the start of the transmission and the request to the data transfer control unit 30a.

The data transfer control unit 30a receives the request and requests the upper level device 10 to transmit the print image data of the plane of the color Y through the data line 11a (SEQ209A), and the print image data of the color Y is transmitted from the upper level device 10 to the data transfer control unit 30a (SEQ209) according to the request. The transmitted print image data is stored in an area in the memory 31a of the data transfer control unit 30a that is allocated for the print image data of the first page.

Hereinafter, the same processes as those of SEQ206, SEQ207, SEQ208, SEQ209A, and SEQ209 are repeated with respect to each of the other colors C, M, and K, the print image data of each color is transmitted from the upper level device 10 to the data transfer control units 30b, 30c, and 30d through the data lines 11b, 11c, and 11d and are stored in the areas of the memories 31b, 31c, and 31d that are allocated for the print image data of the first page (SEQ210 to SEQ221).

Once the print image data transfer of one plane completes, the upper level device 10 transmits the control information of the data transfer completion to the printer controller 14. The printer controller 14 transmits the control information of the reception completion of the print image data to the upper level device 10, according to the control information.

For example, once the print image data transfer of the plane of the color Y completes, the upper level device 10 transmits the control information of the data transfer completion including the image identification number imageID=1 and the color information Yellow to the printer controller 14 (SEQ222). Meanwhile, once the print image data transfer from the upper level device 10 through the data line 11a completes, the data transfer control unit 30a notifies the printer controller 14 of the completion of the transfer (SEQ223). The printer controller 14 transmits the control information of the data reception completion including the image identification number image ID=1 and the color information Yellow to the upper level device 10, in response to the notification (SEQ224).

Hereinafter, the same processes as those of SEQ222 to SEQ224 are repeated with respect to other colors C, M, and K, respectively, in accordance with the completion of transferring each print image data. And the control information of the data reception completion is transmitted to the upper level device 10 (SEQ225 to SEQ233).

After the printer controller 14 transmits the control information of the data reception completion with respect to the final print image data (that is, print image data of the color K) of the first page to the upper level device 10 at SEQ233, the printer controller 14 instructs the conveyance control unit 51 to prepare for printing. The conveyance control unit 51 starts to convey the printing paper 201 to the printing position, according to the instruction.

The description proceeds to FIG. 10B. Once the print image data transfer of each color of the first page is completed, the upper level device 10 transmits the control information of the printing process start of the second page to the printer controller 14 through the control line 12 (SEQ234). The control information includes the process identification number processID=2 to identify the process of the second page and the image identification number imageID=2 indicating the image constituting the second page. The printer controller 14 returns the control information of the printing process start to be a response to the printing process start to the upper level device 10 (SEQ235).

For example, when printing of the second page is performed, the printing process start request is completed by the processes of SEQ234 and SEQ235. For this reason, once the upper level device 10 receives the response to the printing process start request of the second page at SEQ235, the upper level device 10 transmits the control information of the process start request completion where the job identifier jobID=1 is designated to the printer controller 14, at SEQ236.

Next, similar to SEQ206 to SEQ221, the printer controller 14 transmits the control information of the printing process request to the upper level device 10 and requests the upper level device 10 to transmit the print image data. The printing process request is sequentially processed according to arrangement order of the colors in the printer engine 15, with respect to each of the colors Y, C, M, and K.

First, the printer controller 14 transmits the control information of the printing process request to request to transmit the print image data of the color Y to the upper level device 10 through the control line 12 (SEQ237). The control information includes the process identification number processID=2 to designate the process and the color information Yellow to designate the color Y. The upper level device 10 returns the control information including the image identification number imageID=2 to the printer controller 14, in response to the control information (SEQ238). Once the printer controller 14 receives the control information, the printer controller 14 requests the data transfer control unit 30a corresponding to the color Y to start to transmit the print image data (SEQ239).

The data transfer control unit 30a receives the request and requests the upper level device 10 to transmit the print image data of the plane of the color Y through the data line 11a (SEQ240A), and the print image data of the color Y is transmitted from the upper level device 10 to the data transfer control unit 30a according to the request (SEQ240). The transmitted print image data is stored in an area in the memory 31a of the data transfer control unit 30a that is allocated for the print image data of the second page.

Hereinafter, the same processes as those of SEQ237, SEQ238, SEQ239, SEQ240A, and SEQ240 are repeated with respect to each of the other colors C, M, and K, the print image data of each color is transmitted from the upper level device 10 to the data transfer control units 30b, 30c, and 30d through the data lines 11b, 11c, and 11d and are stored in the areas of the memories 31b, 31c, and 31d that are allocated for the print image data of the second page (SEQ244 to SEQ251 and SEQ255 to SEQ258).

Similar to the above case, the upper level device 10 transmits the control information of the data transfer completion to the printer controller 14, whenever the transmission of the print image data of one plane ends. The printer controller 14 transmits the control information of the reception completion of the print image data to the upper level device 10, in response to the control information.

In the example of FIG. 10B, once the print image data transfer of the color Y at SEQ240 completes, the upper level device 10 transmits the control information of the data transfer completion to the printer controller 14 (SEQ252). Once the print image data transfer from the upper level device 10 through the data line 11a completes, the data transfer control unit 30a transmits the notification indicating the completion of the transfer to the printer controller 14 (SEQ253). The printer controller 14 transmits the control information of the data reception completion including the image identification number imageID=2 and the color information Yellow to the upper level device 10, in response to the notification (SEQ254).

Hereinafter, the same processes as those of SEQ252 to SEQ254 are repeated with respect to each of the other colors C, M, and K according to the completion of transferring each print image data, and the control information of the data reception completion is transmitted to the upper level device 10 (SEQ259 to SEQ267).

In the example of FIG. 10B, the response indicating that the printing preparation from the conveyance control unit 51 is completed according to the instruction of the printing preparation with respect to the conveyance control unit 51 immediately before SEQ234 described above is notified from the conveyance control unit 51 to the printer controller 14 immediately after SEQ240. Once the printer controller 14 receives the notification, the printer controller 14 transmits the two items of control information of the printing process start of the process identification number processID=1 and the process identification number processID=2 to the upper level device 10 (SEQ241 and SEQ243). Thereby, the notification indicating that it is ready to perform the printing of the first page and the second page is transmitted to the upper level device 10.

At the time point of SEQ241, the transfers of each color print image data of the first page with respect to the data transfer control units 30a, 30b, 30c, and 30d are completed. For this reason, the printer controller 14 notifies each of the data transfer control units 30a, 30b, 30c, and 30d of a printing instruction to perform printing of the first page (SEQ242). The printing instructions are stored in the memories 31a, 31b, 31c, and 31d in the data transfer control units 30a, 30b, 30c, and 30d. The actual print operation according to the printing instruction is executed by matching timing with timing of a print operation of a page to be executed hereinafter.

In the example of FIG. 10B, in the printer controller 14, the request with respect to the upper level device 10 of the print image data of the plane of the color C where transfer secondly starts is delayed due to transmission of the control information of the printing process start of SEQ241 and SEQ243 (refer to SEQ244). Due to the delay, the transfer of the print image data of the plane of the color Y where the transfer first starts may be completed before the transfer of the print image data of the plane of the color K starts (refer to SEQ253). After the notification process of the transfer completion of the print image data of the plane of the color Y (SEQ253), the transfer of the print image data of the plane of the color K starts (SEQ257 and SEQ258).

During the data transfer process of the first page illustrated in FIG. 10A, after the transfer of the print image data of each color is performed in order of the colors and the transfer of the print image data ends, the data transfer end process is executed in order of the colors. Meanwhile, during the data transfer process of the second page that is illustrated in FIG. 10B, the data transfer end process may start before the transmission of the print image data of each color ends.

As described above, the data transfer control units 30a, 30b, 30c, and 30d to control the transmission of the data of the colors Y, C, M, and K are independently configured and the printer controller 14 can independently communicate with the data transfer control units 30a, 30b, 30c, and 30d. The data transfer control units 30a, 30b, 30c, and 30d independently execute the process. For this reason, the process does not need to be changed, even though another process is interrupted during a series of processes executed by the data transfer control units 30a, 30b, 30c, and 30d.

At SEQ267, once the printer controller 14 notifies the upper level device 10 of completion of transmission of the print image data of the plane of the color K, the printer controller 14 notifies each of the data transfer control units 30a, 30b, 30c, and 30d of a printing instruction to instruct to perform printing of, the second page (SEQ268).

The description proceeds to FIG. 10C. In the printer engine 15, printing of the first page is executed according to a printing instruction of SEQ242 and feeding of the printing paper 201 starts. The printer engine 15 notifies the printer controller 14 of the feeding start of the first page (SEQ269). Once the printer controller 14 receives the notification, the printer controller 14 transmits control information indicating that the process identification number processID is set to 1 and feeding of the first page starts, to the upper level device 10 (SEQ270). In addition, the printer controller 14 instructs the data transfer control units 30a, 30b, 30c, and 30d to execute printing in synchronization with each other. According to the printing instruction, the data transfer control units 30a, 30b, 30c, and 30d read the print image data of the colors Y, C, M, and K from the memories 31a, 31b, 31c, and 31d and sequentially execute printing of each plane of the first page with respect to the printing paper 201.

Similarly, once printing of the first page is completed and printing of the second page starts, the printer engine 15 notifies the printer controller 14 of the feeding start of the second page (SEQ271). Once the printer controller 14 receives the notification, the printer controller 14 transmits control information indicating that the process identification number processID is set to 2 and feeding of the second page starts, to the upper level device 10 (SEQ272). In addition, the printer controller 14 instructs the data transfer control units 30a, 30b, 30c, and 30d to execute printing in synchronization with each other. According to the printing instruction, the data transfer control units 30a, 30b, 30c, and 30d read the print image data of the colors Y, C, M, and K from the memories 31a, 31b, 31c, and 31d and sequentially execute printing of each plane of the second page with respect to the printing paper 201.

Once printing of each color of the first page ends and the first page of the printing paper 201 is discharged, the printer engine 15 notifies the printer controller 14 of the end of the printing and the discharge of the first page (SEQ273). Once the printer controller 14 receives the notification, the printer controller 14 transmits control information indicating that the process identification number processID is set to 1 and the printing paper 201 of the first page is discharged, to the upper level device 10 (SEQ274). Similar to the above case, once printing of each color of the second page ends and the second page of the printing paper 201 is discharged, the printer engine 15 notifies the printer controller 14 of the end of the printing and the discharge of the second page (SEQ275). The printer controller 14 transmits control information indicating that the process identification number processID is set to 2 and the printing paper 201 of the second page is discharged, to the upper level device 10, in response to the notification (SEQ276).

Once the upper level device 10 receives a discharge report corresponding to information indicating the number of pages to be printed included in the control information of setting of the printing conditions from the printer controller 14 at SEQ203, the upper level device 10 determines that the printing based on the job where the start is notified at SEQ200 ends, and transmits control information of the end of the job of the job identification number jobID=1 to the printer controller 14 (SEQ277). Once the printer controller 14 receives the control information, the printer controller 14 sets the job identification number jobID=1 and transmits control information of the response to the upper level device 10 (SEQ278). Accordingly, a series of printing processes ends.

As described above, the functions conventionally executed by each color data transfer control unit, such as the control of the transmission timing of the print image data from the upper level device 10 or the exchange of the control information with the upper level device 10, are collectively performed by the printer controller 14. The data transfer control units (data transfer control units 30a to 30d) that correspond to the individual colors only receive and read the print image data. For this reason, the transmission process of the print image data can be executed at a high speed.

The data transfer control units 30a, 30b, 30c, and 30d that control the transmission of the data of the individual colors Y, C, M, and K are independently configured. In addition, the printer controller 14 and the data transfer control units 30a, 30b, 30c, and 30d are connected by the engine I/F control lines 40a, 40b, 40c, and 40d, and communication between the printer controller 14 and the data transfer control units 30a, 30b, 30c, and 30d is independently performed by the data transfer control units 30a, 30b, 30c, and 30d. The data transfer control units 30a, 30b, 30c, and 30d independently execute the processes.

For this reason, the process does not need to be changed, even though another process is interrupted during a series of processes executed by the data transfer control units 30a, 30b, 30c, and 30d, from SEQ237 to SEQ266. Since the processes of the data transfer control units 30a, 30b, 30c, and 30d are independently executed, addition or removal of the data transfer control units 30a, 30b, 30c, and 30d can be easily performed and various variations of the system configuration can be provided with the common configuration.

### <Another Example of Data Transfer Process>

Next, another example of the data transfer process will be described. In the above example, when the transfer process of the print image data of each color is executed, the upper level device 10 transfers the print image data of each color according to the data transfer request transmitted from the data transfer control units 30a to 30d of the individual colors through the data lines 11a to 11d. Meanwhile, in this example, the data transfer request is not transmitted from the data transfer control units 30a to 30d to the upper level device 10. After responding to the data request from the printer controller 14, the upper level device 10 directly transmits the print image data of each color to the data transfer control units 30a to 30d through the data lines 11a to 11d.

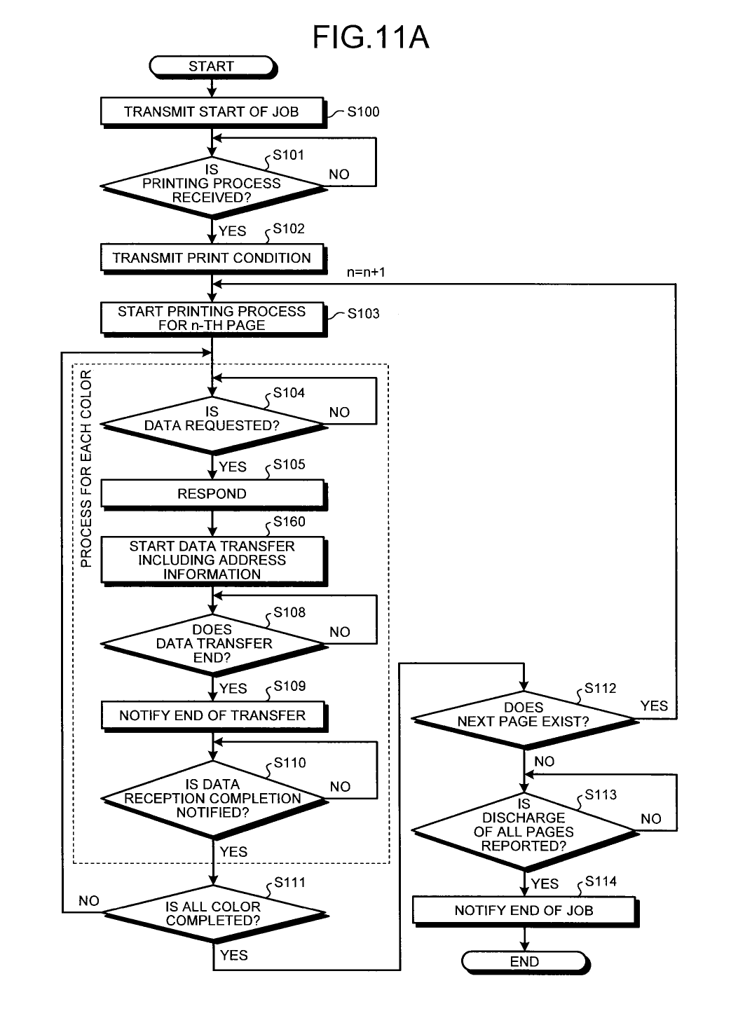

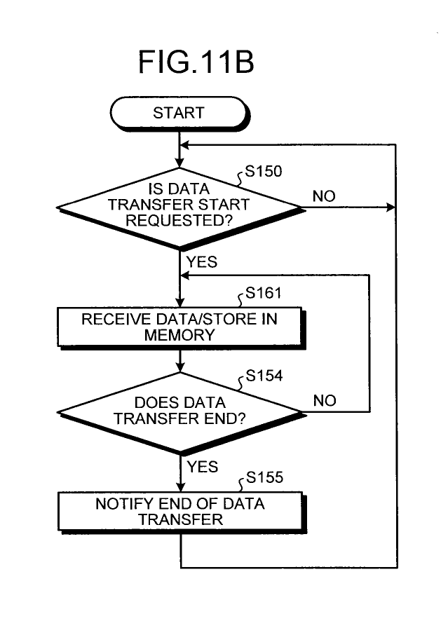

The data transfer process of the print image data according to another example of the data transfer process will be described using flowcharts of FIGS. 11A and 11B. FIG. 11A is a flowchart illustrating an example of a process in the upper level device 10 according to the data transfer of this example. In FIG. 11A, the processes that are common to those of FIG. 9A described above are denoted by the same reference numerals and the redundant description will not be repeated.

As illustrated in the flowchart of FIG. 11A, the process of the upper level device 10 is the same as the process illustrated in FIG. 9A in the process until the response with respect to the data request from the printer controller 14 of step S105 is returned to the printer controller 14 from the transmission of the control information indicating the job start of step S100. Therefore, the redundant description will not be repeated.

In this example, after transmitting the response to the data request from the printer controller 14 to the printer controller 14 through the control line 12 in step S105, the upper level device 10 makes the process proceed to step S160. In step S160, the upper level device 10 transmits the print image data of the color Y to the data transfer control unit 30a through the data line 11a and stores the print image data in the memory 31a in the data transfer control unit 30a. At this time, the upper level device 10 adds the address information of the memory 31a to the transmitted print image data and transmits the print image data to the data transfer control unit 30a. The data transfer control unit 30a stores the print image data in the memory 31a, according to the address information added to the print image data.

The upper level device 10 executes the transmission process of the print image data of step S160 by the predetermined amount, for example, until the transmission of the print image data corresponding to one page ends. When it is determined that the transmission of the print image data ends in step S108, the upper level device 10 transmits the data transfer end notification to the printer controller 14 through the control line 12 in step S109, and stands by a response to the notification, from the printer controller 14, in step S110. Since the following processes are the same as those illustrated in FIG. 9A, the redundant description will not be repeated.

In this example, since the data transfer process and the printing instruction process in the printer controller 14 are the same as the processes descried using FIGS. 9B and 9C, the redundant description will not be repeated.

FIG. 11B is a flowchart illustrating another example of a process in the data transfer control unit 30a that is related to the data transfer. In FIG. 11B, components that are common to those of FIG. 9D are denoted by the same reference numerals and the redundant description will not be repeated.

In step S150, the data transfer control unit 30a stands by a data transfer start request transmitted from the printer controller 14 through the engine I/F control line 40a. Once the data transfer control unit 30a receives the data transfer start request from the printer controller 14, the data transfer control unit 30a makes the process proceed to step S161 and receives the print image data of the color Y transmitted from the upper level device 10 through the data line 11a. The data transfer control unit 30a stores the print image data in the memory 31a, according to the address information added to the print image data.

In step S154, the data transfer control unit 30a determines whether transmission of the print image data of the color Y from the upper level device 10 ends. For example, the data transfer control unit 30a determines whether the transmission of the print image data ends, on the basis of the size information added to the print image data transmitted by the upper level device 10. The upper level device 10 may transmit instruction information to the data transfer control unit 30a, when the transmission of the print image data ends. When it is determined that the transmission of the print image data does not end, the upper level device 10 makes the process return to step S161 and continuously receives the data and stores the data in the memory 31a.

Meanwhile, when it is determined that the transmission of the print image data ends, the upper level device 10 makes the process proceed to step S155 and transmits the data end notification to the printer controller 14 through the engine I/F control line 40a. Then, the process is returned to step S150.

As such, without transmitting the data transfer request from the data transfer control units 30a to 30d to the upper level device 10, after responding to the data request from the printer controller 14, the upper level device 10 may directly transfer the print image data of the individual colors to the data transfer control units 30a to 30d through the data lines 11a to 11d.

### First Memory Management Method

Next, a first memory management method applicable to each embodiment is described. In each embodiment, the memories 31a to 31d that are included in the data transfer control units 30a to 30d are collectively managed by the printer controller 14. Hereinafter, the case where the print image data are supplied from the upper level device 10 to the printer device 13 by bitmap data having the same size in each of the colors C, M, Y, and K will be described.

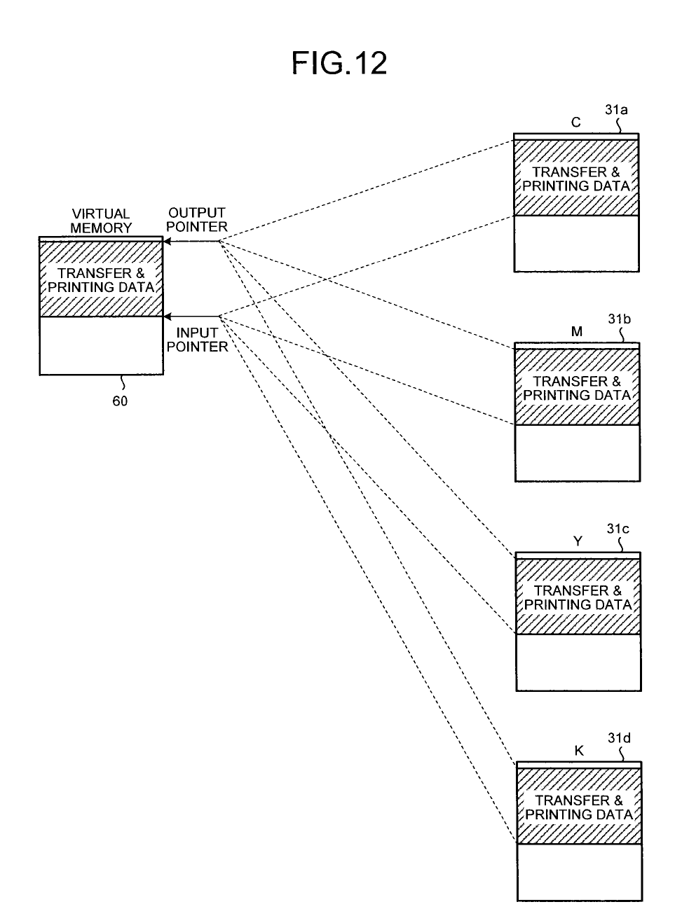

In each embodiment, in the printer controller 14, a virtual memory 60 that has the same memory space as that of each of the memories 31a to 31d is defined (hereinafter, referred to as virtual memory 60), as illustrated in FIG. 12. The printer controller 14 manages a start point of writing the print image data transferred from the upper level device 10 into the respective memories 31a to 31d (referred to as input pointer) and a start point of reading out the print image data from the respective memories 31a to 31d (referred to as output pointer) on the virtual memory 60.

When the printer controller 14 performs the writing with respect to respective memories 31a to 31d, the controller 14 sends the address indicated by the input pointer to respective data transfer control units 30a to 30d. The respective data transfer control units 30a to 30d start to write the data using the address indicated by the input pointer sent from the printer controller 14 as the head address. Similarly, when the printer controller 14 performs the reading from respective memories 31a to 31d, the controller 14 sends the address indicated by the output pointer to respective data transfer control units 30a to 30d. The respective data transfer control units 30a to 30d start to read the data from respective memories 31a to 31d using the address indicated by the output pointer sent from the printer controller 14.

The printer controller 14 updates the input pointer by moving the address by one page when the writing of the data corresponding to one page is completed. Similarly, the printer controller 14 updates the output pointer by moving the address by one page when the reading of the data corresponding to one page is completed. Since the start point of writing and the start point of reading as for respective memories 31a to 31d are collectively managed by the printer controller 14, storage areas in respective memories 31a to 31d can be easily reserved and released page by page.

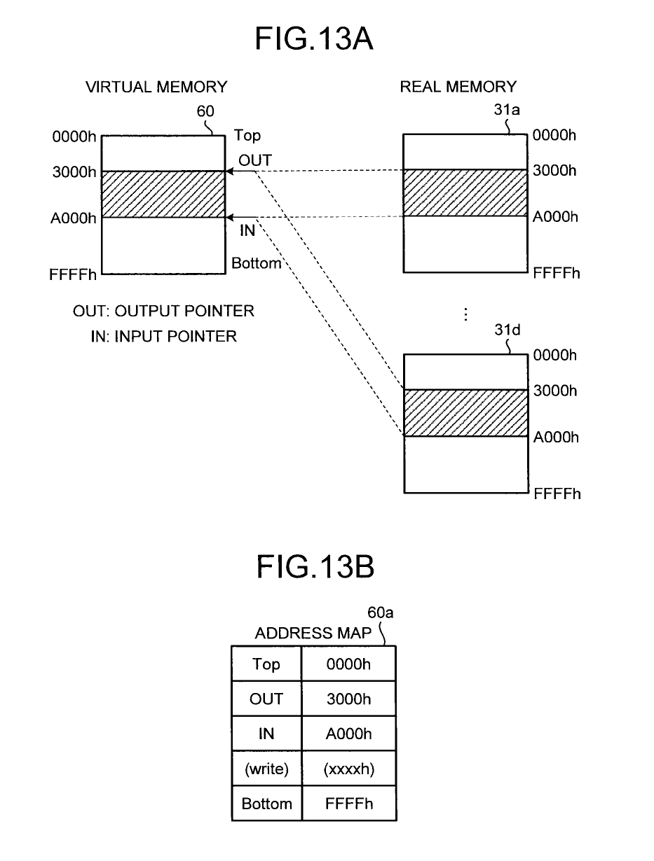

For example, the virtual memory 60 is configured as an address map that is information indicating memory spaces in respective memories 31a to 31d. FIGS. 13A and 13B illustrate a further specific example of the virtual memory 60. For example, as illustrated in FIG. 13A, in respective memories 31a to 31d which are real memories, each top address indicating each start point of available area is defined as “0000h” and each bottom address indicating each end point of available area is defined as “FFFFh”. The address in respective memories 31a to 31d is increased by a predetermined unit in a direction from the top address to the bottom address. Incidentally, the denotation “h” means that a character string immediately before “h” in the address is a numeral in hexadecimal.

The top address and the bottom address of the virtual memory 60 are defined as “0000h” and “FFFFh”, respectively, similarly to respective memories 31a to 31d. Furthermore, input pointers (IN) and output pointers (OUT) of respective memories 31a to 31d which are real memories are managed as the same addresses as the input pointer and the output pointer of the virtual memory 60. In the example of FIG. 13A, the output pointer is identified by the address “3000h” and the input pointer is identified by the address “A000h”.

FIG. 13B illustrates an example of address map 60a which is to be an entity of the virtual memory 60. For example, the address map 60a is configured as an assembly of addresses that include a Top address, a Bottom address, and addresses of an output pointer and an input pointer at a current point of time. In the example of FIG. 13B, a write address (write) to write data is further included in the address map 60a.

In the addresses of the input pointer and the output pointer, an address corresponding to one page is increased and updated, when writing of one page ends and reading of one page ends. When data is written with respect to each of the memories 31a to 31d, the write address is increased in a data write unit and a write position of data with respect to each of the memories 31a to 31d is shown. As the update result of the input pointer, the output pointer, and the write address, when the resulted value is more than the Bottom address, the address is set cyclically from the Top address.

The address map 60a is constructed in the control unit 23 in the printer controller 14, for example. Specifically, the address map 60a is constructed by storing each value on the RAM 323 by the CPU 321, for example. The Top address and the Bottom address can be previously stored in the ROM 324. At the time of starting and an initialization process of the printer device 13, the control unit 23 communicates with each of the data transfer control units 30a to 30d through the control signal transmitting/receiving unit 21, acquires the Top address and the Bottom address of each of the memories 31a to 31d, and generates the address map 60a. However, the invention is not limited thereto and a memory space may be actually secured on the RAM 323 of the printer controller 14 and the virtual memory 60 may be constructed.

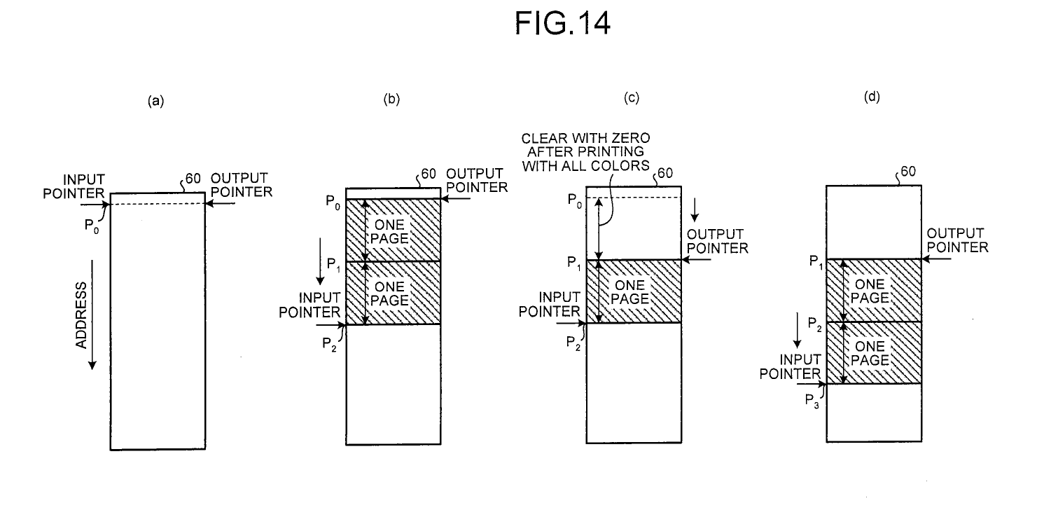

Referring to FIG. 14, control of the input pointer and the output pointer on the virtual memory 60 will be described. In FIG. 14, an address increases from the upper side to the lower side. As illustrated in (a) of FIG. 14, in the virtual memory 60, in an initial state, the input pointer and the output pointer show an address P₀.

For example, in SEQ101 of FIG. 8, once the upper level device 10 requests the data transfer of the first page to the printer controller 14, the print image data corresponding to the first page starts to be written into respective memories 31a to 31d from the address P0 indicated by the input pointer on the virtual memory 60. If it is judged that the transfer of the print image data for all colors corresponding to the first page is completed, the printer controller 14 moves the input pointer on the virtual memory 60 by an amount of one page from the address P0 to the address P1 so that the input pointer is updated as the address P1. Thereby, the new address is designated to which the print image data corresponding to the next page is to be transferred. In the example of FIG. 8, if the completion of transferring the print image data of color K corresponding to the first page is notified to the print controller 14 at SEQ111d, the printer controller 14 judges that transferring the print image data for all colors corresponding to the first page is completed.

Incidentally, in this example, the explanation was made on the case that the input pointer is updated, when the transfer of the print image data for all color corresponding to the first page is completed. However, the present invention is not limited to this example. For example, the input pointer may be updated, every time when the data transfer of the print image data for one color corresponding to the first page is completed.

The print image data corresponding to the second page is written into respective memories 31a to 31d from the address P₁ (that is the transfer destination address) indicated by the input pointer on the virtual memory 60. For example, if the data transfer of the print image data for all colors corresponding to the second page is completed and the data transfer of the print image data corresponding to the next page is requested at SEQ115 in FIG. 8, the printer controller 14 moves the input pointer by an amount of one page from the address P₁ to the address P₂ so that the input pointer is updated as the address P₂. Thereby, the new address is designated to which the print image data corresponding to the next page is to be transferred (see (b) of FIG. 14).

Once the printing operation for all colors corresponding to the first page is completed, the printer controller 14 moves the output pointer by an amount of one page from the address P₀ to the address P₁ so that the output pointer is updated as the address P₁. Thereby, the print start position of the next page is designated to the top address of the second page, as illustrated in (c) of FIG. 14. In the example of FIG. 8, if the printing operation for color K corresponding to the first page is completed at SEQ120d, the printer controller 14 judges that the printing operation for all colors corresponding to the first page is completed.

Incidentally, in this example, the explanation was made on the case that the output pointer is updated, when the printing operation for all colors corresponding to the first page is completed. However, the present invention is not limited to this example. For example, the output pointer may be updated, every time when the printing operation for one color corresponding to the first page is completed.

Once the printing operation for all colors corresponding to one page is completed, the printer controller 14 sends an instruction to respective data transfer control units 30a to 30d for clearing (so-called “zero-clear”) the areas of respective memories 31a to 31d where the print image data is already written by the completed printing operation, as well as moving the output pointer. In accordance with this instruction, respective data transfer control units 30a to 30d perform the “zero-clear” by filling the areas of respective memories 31a to 31d where the printing operation is already completed (e.g. an area designated by addresses P₀ to P₁ on the virtual memory 60 for the first page) with zero. Thus, by filling the areas of respective memories 31a to 31d where the printing operation is completed with zero, any mistake can be avoided in the following printing operation.

In the above description, the areas where the print image data is already written by the completed printing operation is explained as the areas of respective memories 31a to 31d to which the “zero-clear” is performed. However, the present invention is not limited to this. For example, the areas of respective memories 31a to 31d to which the “zero-clear” is performed may be set to the discharge ended areas where the print image data is written. In this case, the data before discharged is stored into respective memories 31a to 31d of respective data transfer control units 30a to 30d. Therefore, it becomes not necessary to re-transfer the print image data from the upper level device 10, even in a case that the re-printing of page is needed because of a jam trouble of the printing sheet 201.

In the above description, the “zero-clear” of respective memories 31a to 31d is performed at a time point when the print operation corresponding to one page is completed. However, the present invention is not limited to this. That is, the “zero-clear” of respective memories 31a to 31d may be performed at any time point from the time point when the print image data corresponding to a page before printing is transferred from the upper level device 10 until the time point when the transferred print image data is written into respective memories 31a to 31d. In this case, the output pointer may be moved in advance at the time point when the printing operation corresponding to one page is completed, or may be moved at the time point when the “zero-clear” is performed. Furthermore, the “zero-clear” may be performed almost simultaneously at respective memories 31a to 31d, or may be performed sequentially from the memory among memories 31a to 31d to which the print image data is transferred.

Then, the data transfer corresponding to the second page is completed, the printer controller 14 moves the input pointer on the virtual memory 60 by an amount of one page from the address P₂ to address P₃ so that the input pointer is updated as the address P₃. Thereby, the new address is designated to which the data corresponding to the third page is transferred.

Thus, in each embodiment, the input pointer that indicates the transfer destination address of the print image data is moved on the virtual memory 60 upon the completion of the data transfer corresponding to one page. And, the output pointer that indicates the reading start position address of the print image data is moved on the virtual memory 60 upon the completion of the printing operation for each color corresponding to one page. Furthermore, the writing and the reading of the print image data with respect to the respective memories 31a to 31d are performed in accordance with the addresses indicated by the input pointer and the output pointer on the virtual memory 60. Therefore, the printer controller 14 can readily know statuses of the respective memories 31a to 31d. Along with that, the printer controller 14 can readily judge whether the printing operation for all colors has ended or not, in the printing operation corresponding to one page.

Incidentally, the writing and reading of the image print data corresponding to one page is not always performed at the same timing or the same speed. Specifically, in the necessity of performing the high speed printing, the print image data is often buffered to ensure the continuous printing. For this purpose, it is preferable to control the access of the print image data to respective memories 31a to 31d in such a manner that the writing speed becomes faster than the reading speed. In this case, the print image data corresponding to more than one page is stored into respective memories 31a to 31d. Thereby, the difference in address between the input pointer and the output pointer corresponds to a page size corresponding to more than one page.

Furthermore, the difference in address between the input pointer and the output pointer is affected by the development speed (RIP processing speed) of the print image data at the upper level device 10. Specifically, since the development speed of the print image data depends on the content of the print image data, the change speed of the input pointer depends on the content of the print image data. On the other hand, since the change speed of the output pointer depends on the printing speed at the image output unit 50 (data output speed to respective heads 56a to 56d), it becomes constant. Incidentally, in a case that the writing speed of the print image data into respective memories 31a to 31d is slower than the reading speed at the image output unit 50, the difference in address between the input pointer and the output pointer becomes zero.

### <Transfer Management Table>

Next, the transfer management table used in the case where the data processing is performed page by page in the data transfer control units 30a to 30d will be described. The transfer management table is used to manage a data transfer process in the data transfer control units 30a to 30d or a printing process in the image output unit 50. In the printer controller 14, the control unit 23 creates and holds the transfer management table, on the basis of a print job transmitted from the upper level device 10, the paper information, the information indicating (3) printing conditions described using FIG. 7, and the like. Specifically, the CPU 321 creates the transfer management table and stores the transfer management table in the RAM 323.

When the control unit 23 outputs the data transfer start request or the printing instruction to the data transfer control units 30a to 30d, the control unit 23 holds needed information among the information of the transfer management table in the data transfer control units 30a to 30d. For example, the control unit 23 transmits the information from the control signal transmitting/receiving unit 21 to the data transfer control units 30a to 30d through the engine I/F control lines 40a to 40d, and the information is written in the storage unit of the data transfer control units 30a to 30d, such as registers.

A specific example will be described using the data transfer control unit 30a. The control unit 23 transmits needed information among the information of the transfer management table from the control signal transmitting/receiving unit 21 to the data transfer control unit 30a through the engine I/F control line 40a, and the information is written in a register of a logic circuit 32a (data transfer control unit controller 135a) in the data transfer control unit 30a.

The data transfer control units 30a to 30d output the transmission request of the print image data to the upper level device 10 or the printing instruction to the image output unit 50, according to the information of the transfer management table written in the registers. A page identifier to identify a page is included in the transfer management table, and the data transfer control units 30a to 30d select the information of the transfer management table on the basis of the page identifier and execute the data transfer and the printing process.

FIG. 15 illustrates an example of the transfer management table used in the case where data processing is performed page by page in the data transfer control units 30a to 30d. The transfer management table includes information that is common to the colors C, M, Y, and K and information for each color. The information common to the respective colors and the information for each color include data transfer information that is used to transfer the print image data from the upper level device 10 and print information that is information related to the print instruction with respect to the image output unit 50. A management form of each information that is included in the transfer management table is not limited to a table form and each information may be managed in another data management form.

The information that is common to the respective colors will be first described. In the information that is common to the colors, a page identifier PBID and the data amount for each page are included as information other than the data transfer information and the print information. The page identifier PBID is a page identifier to identify a printing page and the transfer management table is identified by the page identifier PBID. The data amount for each page is the number of colors that are used in the page identified by the page identifier PBID, and for example, in the case of a monochrome, the value is “1” and in the case of a full color, the value is “4”.

The data transfer information in the information common to the colors includes a data transfer origin address, a data storage destination address, and a data transfer size. The data transfer origin address indicates an address where the print image data of the page indicated by the page identifier PBID in the upper level device 10 are stored. The data transfer origin address designates the print image data in a raster (line) unit.

In the case where the data processing is performed page by page in the data transfer control units 30a to 30d, the same address is used as the transfer origin address, with respect to the print image data of each color. For example, in the upper level device 10, the print image data of each color are stored in the storage unit 122 illustrated in FIG. 2B. Specifically, with respect to the RAM 103 illustrated in FIG. 2A, the print image data of each color are stored in the address that is identified by each of the data lines 11a to 11d or each color.

The data storage destination address is an address that is indicated by the input pointer. Therefore, the data storage destination address is also updated whenever the input pointer is updated. The data transfer size indicates a data size of the print image data that is transmitted according to a request from each of the data transfer control units 30a to 30d. For example, the data transfer size is a data size of the print image data of the page that is indicated by the page identifier PBID.

The data transfer size includes a boundary adjustment size to adjust the size of the print image data in a predetermined unit (for example, byte unit). When one page is printed, the print image data of the data size that is indicated by the data transfer size is stored in each of the memories 31a to 31d. For example, a value that is obtained by adding the boundary adjustment size to a “print data size” of the information indicated by the (3) printing conditions described using FIG. 7 becomes the data transfer size.

The print information in the information common to the colors will be described next. The print information includes resolution and gradation as information of print image data to be printed and includes a paper feeding length, a paper width, a printing surface (front/rear), a printing prohibited area (upper side/lower side/left side/right side), and image information as information related to a printing object. The image information includes a bitmap printing position X and a bitmap printing position Y and an X-direction effective size and a Y-direction effective size.

In the information of the print image data to be printed, the resolution indicates printing resolution of each of a main scanning direction and a sub-scanning direction. The gradation indicates the number of bits per pixel.

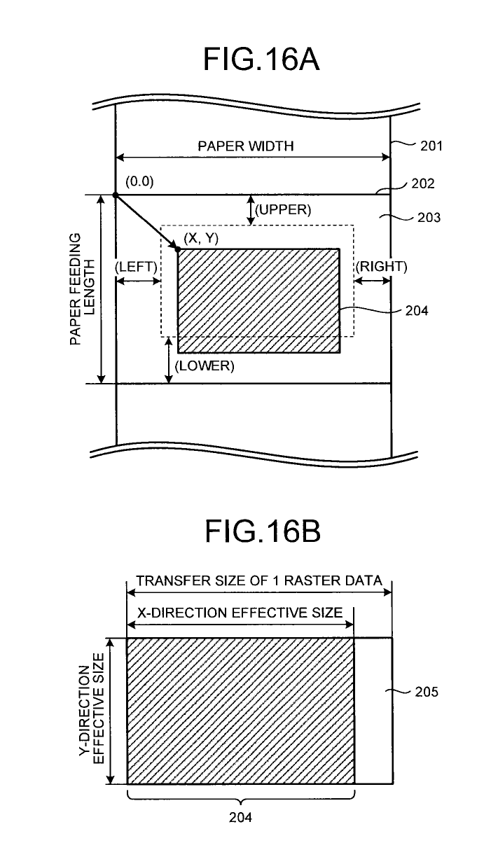

The information related to the printing object will be described using FIGS. 16A and 16B. FIG. 16A illustrates an example of a page area 202 with respect to printing paper 201. FIG. 16B illustrates an example of an effective printing area 204 by print image data. In the paper feeding length, the length of one page in a feeding direction of the printing paper 201 is represented by the number of dots and in the paper width, the length of the printing paper 201 in a width direction is represented by the number of dots. The printing surface indicates whether the print image data of the corresponding page is printed on the surface of the printing paper 201 or is printed on the back surface thereof.

The upper, lower, left, and right sides in the printing prohibited area are to represent a printing prohibited area 203 where printing is prohibited by the number of dots from an upper end (head of the paper feeding direction), a lower end (rear end of the paper feeding direction), a left end (left end of the paper width direction toward the paper feeding direction), and a right end (rear end of the paper width direction toward the paper feeding direction) of the page area 202.

The bitmap printing positions X and Y of the image information are to represent an address (coordinates) of the printing start position by the number of dots, when the upper left (head of the paper feeding direction and left end of the paper width direction) of the page area 202 is set to an original point. The X direction effective size in the image information is to represent a size not including a boundary adjustment area 205 of an X direction (paper width direction) by the number of dots. The boundary adjustment area 205 is provided to adjust a data size in a predetermined unit, when a data size of one raster data includes fractions of a predetermined unit or less (for example, byte unit). The Y direction effective size is to represent a size of a Y direction (paper feeding direction) by the number of dots. That is, the X direction effective size indicates an effective size that is printed by one raster data and the Y direction effective size indicate the number of rasters (number of lines) printed with the X direction effective size.

That is, the bitmap printing positions X and Y are set to the upper left and the area that are shown by the X direction effective size and the Y direction effective size becomes the printing area 204. In an area of the printing area 204 that overlaps the printing prohibited area 203, printing is not performed.

Information for each color will be described. The information for each color includes a color identifier that indicates the information on which printing color among the colors C, M, Y, and K, is written as information other than the data transfer information and the print information. Since the information for each color has the common configuration, information where the Color identifier is “Cyan” is described hereinafter. In the information management table, the information for each color is included with respect to each of the colors C, M, Y, and K.

The data transfer information in the information for each color includes information that indicates whether transfer of data is needed. The information that indicates whether the transfer of the data is needed indicates whether transfer of print image data of the corresponding printing color is needed. For example, in the case of white paper, that is, in the case of not performing printing, the information that indicates whether the transfer of the data is needed is set to “non-necessity”, with respect of all of the colors C, M, Y, and K. With respect to colors other than the colors designated by the Colors (Cyan, Magenta, Yellow, and Black), the information that indicates whether the transfer of the data is needed is set to “non-necessity”.

The print information in the information for each color includes information that indicates whether printing is needed. The information that indicates whether the printing is needed indicates whether printing of print image data of the corresponding printing color is needed. For example, in the case of white paper, that is, in the case of not performing printing, the information that indicates whether the printing is needed is set to “non-necessity”, with respect of all of the colors C, M, Y, and K. With respect to colors other than the colors designated by the Color identifier, the information that indicates whether the printing is needed is set to “non-necessity”.

### <Memory Control Process>

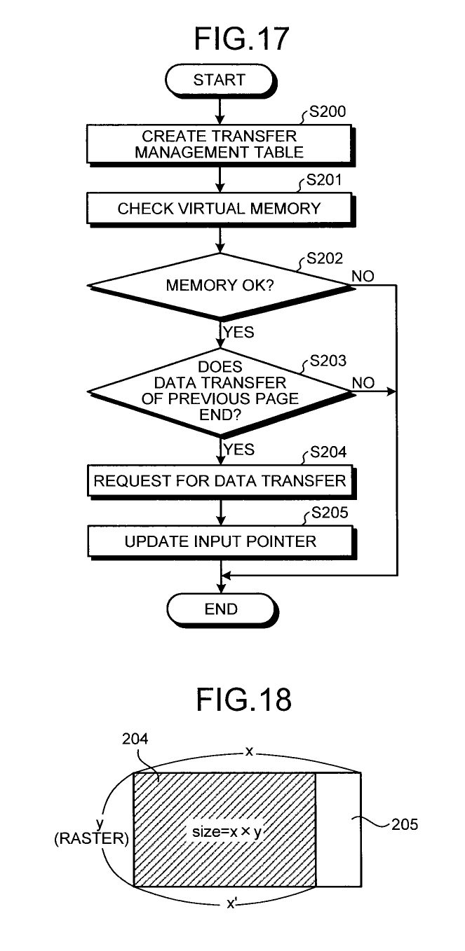

Next, a control process of the memories 31a to 31d applicable to each embodiment will be described using FIGS. 17 to 21. FIG. 17 illustrates an example of a process when the printer controller 14 receives data from the upper level device 10. The process according to the flow chart of FIG. 17 starts when the print job of the page is received from the upper level device 10 by the control unit 23, in the printer controller 14, in SEQ101 or SEQ102 of FIG. 8. Each process according to the flow chart of FIG. 17 is executed by control from the control unit 23 in the printer controller 14.

The printer controller 14 generates the transfer management table, on the basis of the received print job, the paper information received from the upper level device 10 in SEQ100 of FIG. 8, and the information indicating the (3) printing conditions described using FIG. 7, when the print job is received from the upper level device 10 (step S200). In step S201 of FIG. 17, the printer controller 14 checks the virtual memory 60 and acquires the empty capacities of the memories 31a to 31d.

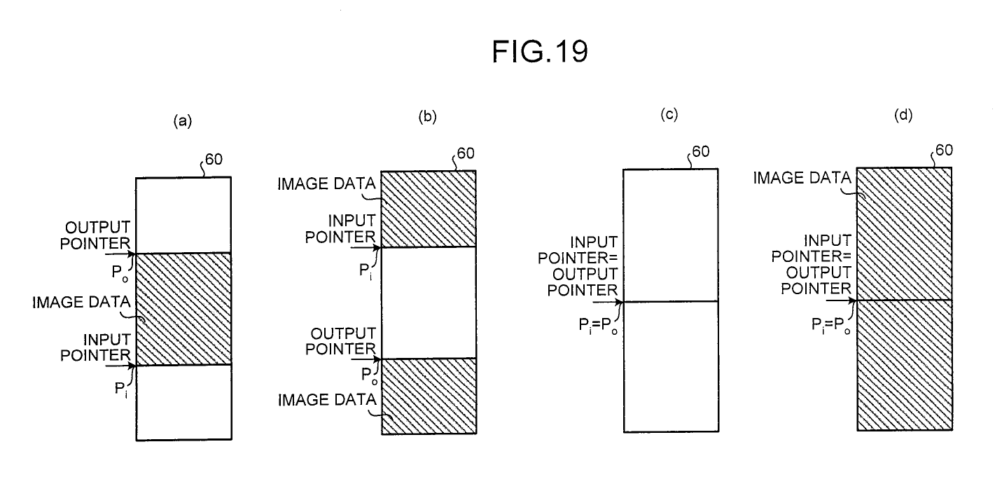

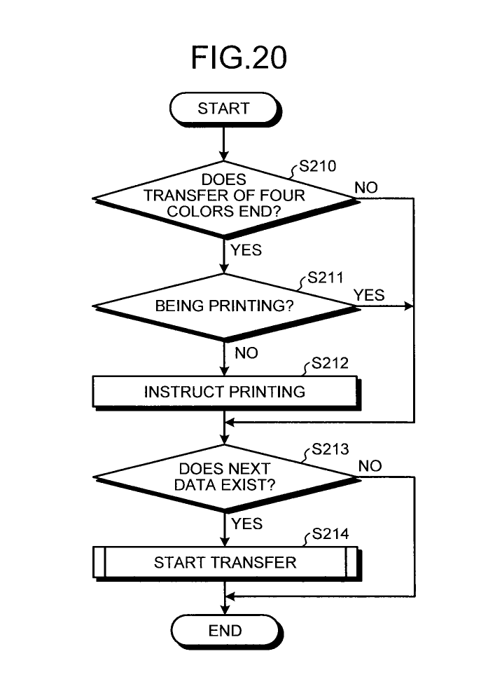

The checking of the empty capacities of the memories 31a to 31d by the virtual memory 60 will be described using FIGS. 18 and (d) of FIG. 19. Hereinafter, the “empty capacity of each of the memories 31a to 31d by the virtual memory 60” is described as the “empty capacity on the virtual memory 60” or is simply described as the “empty capacity”. The data size of the print image data corresponding to one page transmitted from the upper level device 10 is a data size that is obtained by adding the data size of the printing area 204 and the data size of the boundary adjustment area 205, as illustrated in FIG. 18.

Meanwhile, the empty capacity on the virtual memory 60 can be calculated on the basis of the difference of an address Pᵢ indicating an input pointer and an address Pₒ indicating an output pointer. A method of calculating the empty capacity on the virtual memory 60 will be schematically described using FIG. 19. In FIG. 19, the address of the virtual memory 60 increases from the upper side to the lower side and an area where print image data is written is shown by adding oblique lines.

In this case, according to a relation between the input pointer and the output pointer on the virtual memory 60, there are three cases, (A) the case where the address Pᵢ of the input pointer is more than the address Pₒ of the output pointer (refer to (a) of FIG. 19), (B) the case where the address Pₒ of the output pointer is more than the address Pᵢ of the input pointer (refer to (b) of FIG. 19), and (C) the case where the address Pᵢ of the input pointer is equal to the address Pₒ of the output pointer (refer to (c) and (d) of FIG. 19). The empty capacity D_{EMP} on the virtual memory 60 can be obtained on the basis of the difference of the address Pᵢ of the input pointer and the address Pₒ of the output pointer.

The case (A) where the address Pᵢ of the input pointer is more than the address Pₒ of the output pointer (Pᵢ>Pₒ) indicates that print image data is stored in an area from the address Pₒ of the output pointer to the address Pᵢ of the input pointer, as illustrated in (a) of FIG. 19. In this case, when a data size for each address is W and the capacity of the virtual memory 60 is D_{FULL}, the empty capacity D_{EMP} is calculated by the following Equation (1).

D_{EMP}=D_{FULL}−(Pᵢ−Pₒ)×W (1)

The case (B) where the address Pₒ of the output pointer is more than the address Pᵢ of the input pointer (Pₒ>Pᵢ) indicates that print image data is stored in an area from the address Pₒ of the output pointer to the Bottom address of the virtual memory 60 and an area from the Top address of the virtual memory 60 to the address Pᵢ of the input pointer, as illustrated in (b) of FIG. 19. In this case, the empty capacity D_{EMP} is calculated by the following Equation (2). In the case of (B), the Top address and the Bottom address are connected and read is controlled in a ring buffer manner.

D_{EMP}=(Pₒ−Pᵢ)×W (2)

The case (C) where the address Pᵢ of the input pointer is equal to the address Pₒ of the output pointer (Pᵢ=Pₒ) indicates that the virtual memory 60 is empty (refer to (c) of FIG. 19) and that print image data is stored in the virtual memory 60 without the empty capacity (refer to (d) of FIG. 19). It can be determined whether the virtual memory 60 is empty or full, on the basis of whether printing ends or starts. However, the present invention is not limited thereto and the printer controller 14 may monitor movement of the input pointer and the output pointer on the virtual memory 60 and set a flag when the virtual memory is full.

Returning the description to the flowchart of FIG. 17, if the empty capacity of the virtual memory 60 is calculated in step S201, the printer controller 14 determines whether print image data (in this case, print image data of one color) corresponding to one page can be stored with respect to the calculated empty capacity of the virtual memory 60, on the basis of the data transfer size of the transfer management table, in next step S202. When it is determined that the print image data cannot be stored, the process of the flowchart of FIG. 17 is not performed. In this case, when it is determined that printing ends, the printer controller 14 can request to transmit print image data.

Meanwhile, when it is determined that the print image data corresponding to one page can be stored in step S202, the printer controller 14 makes the process proceed to step S203 and determines whether transmission of print image data of the previous page ends. When it is determined that the transmission of the print image data does not end, the process of the flowchart of FIG. 17 is not performed. In this case, when it is determined that the transmission of the print image data ends, the printer controller 14 may request to transmit print image data of a next page. Meanwhile, when it is determined that the transmission of the print image data ends, the process proceeds to step S204.

In step S204, the printer controller 14 requests each of the data transfer control units 30a to 30d to start to transmit the print image data of each color indicated by the page identifier PBID in the transfer management table. For example, this corresponds to the processes of SEQ110a to SEQ110D in the sequence of FIG. 8 and SEQ208, SEQ212, SEQ216, and SEQ220 in the sequence of FIG. 10A, when the page identifier PBID indicates the first page. Then, the process proceeds to step S205 and the printer controller 14 moves the position of the input pointer on the virtual memory 60 by one page and updates the input pointer. If the input pointer is updated, the process exits the flowchart of FIG. 17.

In step S204, once the printer controller 14 requests to start the data transfer of the print image data to respective data transfer control units 30a to 30d, the requests of transferring the print image data are sent from respective data transfer control units 30a to 30d to the upper level device 10. For example, in a case that the page identifier PBID indicates the first page, this corresponds to SEQ209A, SEQ213A, SEQ217A, and SEQ221A in the sequence of FIG. 10A.

At this time, each of the data transfer control units 30a to 30d adds at least the page identifier PBID and the data transfer origin address shown in the transfer management table of FIG. 15 to the data transfer start request and transmits the data transfer request to the upper level device 10. The page identifier PBID and the data transfer origin address are extracted from the transfer management table in the printer controller 14 and are transmitted to each of the data transfer control units 30a to 30d, in step S126 of FIG. 9B, as described above.

The upper level device 10 reads the print image data of each color from the storage unit 122, on the basis of the page identifier PBID and the data transfer origin address transmitted from each of the data transfer control units 30a to 30d, and transmits the print image data to each of the data transfer control units 30a to 30d through each of the data lines 11a to 11d. In this case, the page identifier PBID and the data transfer origin address are added to the transmission start request of the print image data by the printer controller 14 and are transmitted to each of the data transfer control units 30a to 30d.

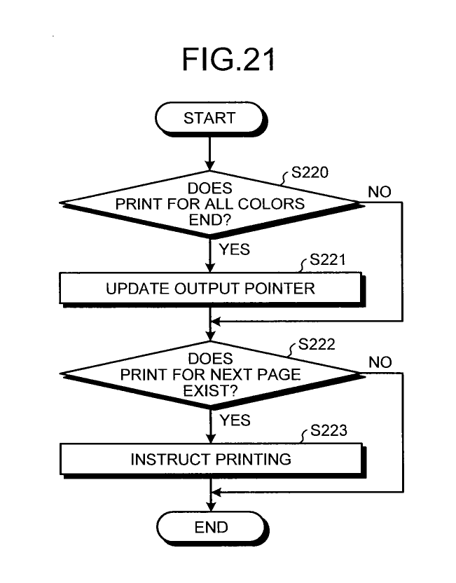

FIG. 20 is a flowchart illustrating an example of a process of when transmission ends. The process according to the flowchart of FIG. 20 starts when the notification of the end of the transmission of the data is received from the data transfer control units 30a to 30d and is executed by the printer controller 14, in SEQ111a to SEQ111d of FIG. 8.

First, in step S210, it is determined whether transmission of the print image data corresponding to one page with respect to each of the four colors, that is, each of the colors C, M, Y, and K from the upper level device 10 to each of the data transfer control units 30a to 30d ends. For example, the printer controller 14 sets the flags, whenever the notification of the end of the transmission of the print image data is received from the each of the data transfer control units 30a to 30d, in SEQ111a to SEQ111d of FIG. 8. If the flags of the four colors are set, the printer controller 14 determines that the transmission of the print image data of each color corresponding to one page ends. When it is determined that the transmission of the print image data does not end, the process proceeds to step S213.

Meanwhile, when it is determined that the transmission of the print image data of each color corresponding to one page ends, the printer controller 14 makes the process proceed to step S211 and determines whether the print image data is being printed. For example, after the printing instruction is output to each of the data transfer control units 30a to 30d in SEQ114 of FIG. 8, if the corresponding printing instruction end notification is not received in SEQ120a to SEQ120d, the printer controller 14 determines that printing is being performed. When it is determined that printing is being performed, the process proceeds to step S213. Meanwhile, when it is determined that printing is not performed at the present time, the printer controller 14 makes the process proceed to step S212 and outputs the printing instruction of the page indicated by the page identifier PBID to each of the data transfer control units 30a to 30d (for example, SEQ114 of FIG. 8).

Next, in step S213, the printer controller 14 determines whether there is next print image data transmitted from the upper level device 10 to each of the data transfer control units 30a to 30d. For example, when the print image data where the printing instruction is output in step S212 is the print image data of the first page and the process proceeds to step S213, if the print job of the next second page is received by SEQ102 of FIG. 8, it is determined that print image data to be transmitted next exists.

If it is determined that the print image data to be transmitted next does not exist, the process exits the flowchart of FIG. 20. Meanwhile, if it is determined that the print image data to be transmitted next exist, the printer controller 14 makes the process proceed to step S214. The process of step S214 is the same as the process after step S201 in the flowchart illustrated in FIG. 17. After the empty state of the memory is confirmed, if the memory is empty, the printer controller 14 requests each of the data transfer control units 30a to 30d to start to transmit the next print image data and does not perform the process according to the flowchart of FIG. 20.

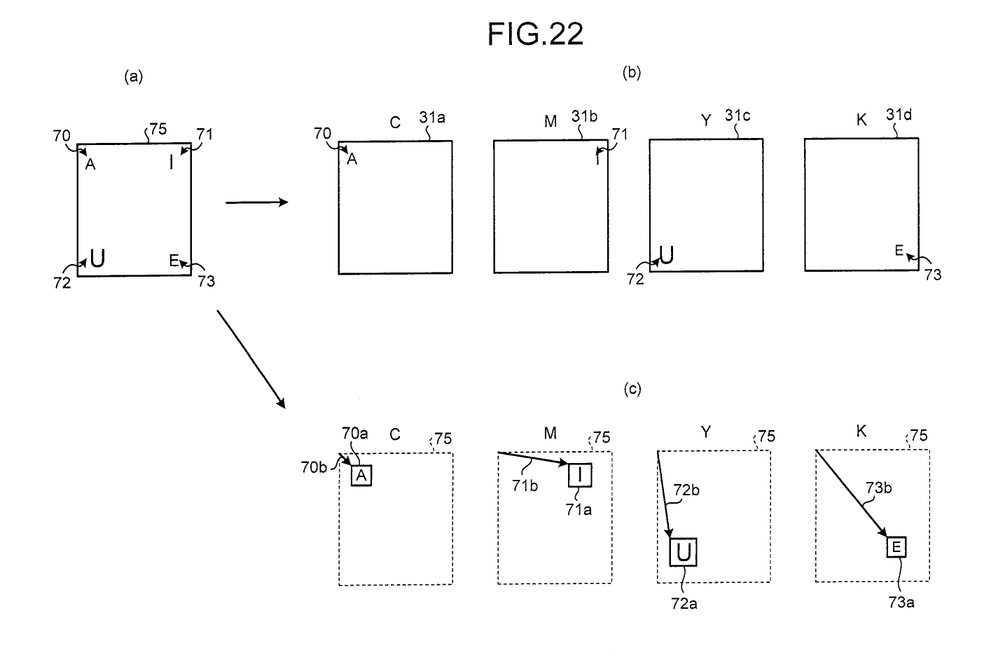

FIG. 21 is a flowchart illustrating an example of a process of when printing ends. The process according to the flowchart of FIG. 21 starts when the notification of the end of the printing is received from the data transfer control units 30a to 30d by the printer controller 14 and is executed by the printer controller 14, in SEQ120a to SEQ120d or SEQ122a to SEQ122d of FIG. 8.

First, in step S220, it is determined whether printing of all of the four colors ends, with respect to the print image data corresponding to one page. For example, the printer controller 14 sets the flags, whenever the notification of the end of the printing is received from the each of the data transfer control units 30a to 30d, in SEQ120a to SEQ120d of FIG. 8. If the flags of the four colors are set, the printer controller 14 determines that the printing of the print image data of each color corresponding to one page ends. However, the present invention is not limited thereto. When printing is performed in order of the colors C, M, Y, and K, the printer controller 14 may determine that printing ends, after the printing end notification of the final color K is received. When it is determined that printing of all of the four colors does not end, the process proceeds to step S222.

Meanwhile, when it is determined that printing of each color corresponding to one page ends, the process proceeds to step S221. In step S221, the printer controller 14 moves the position of the output pointer on the virtual memory 60 by one page and updates the output pointer. If the output pointer is updated, the process proceeds to step S222.

In step S222, the printer controller 14 determines whether a next page is printed. For example, the printer controller 14 receives the data transfer end notification from each of the data transfer control units 30a to 30d. However, when there is a page where the printing end notification is not received exists, the printer controller 14 can determine that printing of a next page exists. When it is determined that printing of the next page does not exist, the printer controller 14 does not perform the process according to the flowchart of FIG. 21. Meanwhile, when it is determined that printing of the next page exists, the printer controller 14 makes the process proceed to step S223, designates the page identifier PBID indicating the next page to each of the data transfer control units 30a to 30d, instructs each of the data transfer control units 30a to 30d to start to perform printing of the next page, and the process exits the flowchart of FIG. 21.

### <Second Memory Management Method>

Next, an example of a second memory management method used in the case where data processing is performed page by page in the data transfer control units 30a to 30d is described. This is an example of the case where the memories 31a to 31d of the data transfer control units 30a to 30d are collectively managed by the printer controller 14 and print image data are transferred from the upper level device 10 to the printer device 13, with bitmap data having a different size for each of the colors C, M, Y, and K. Hereinafter, a part that is different from the first memory management method will be mainly described.

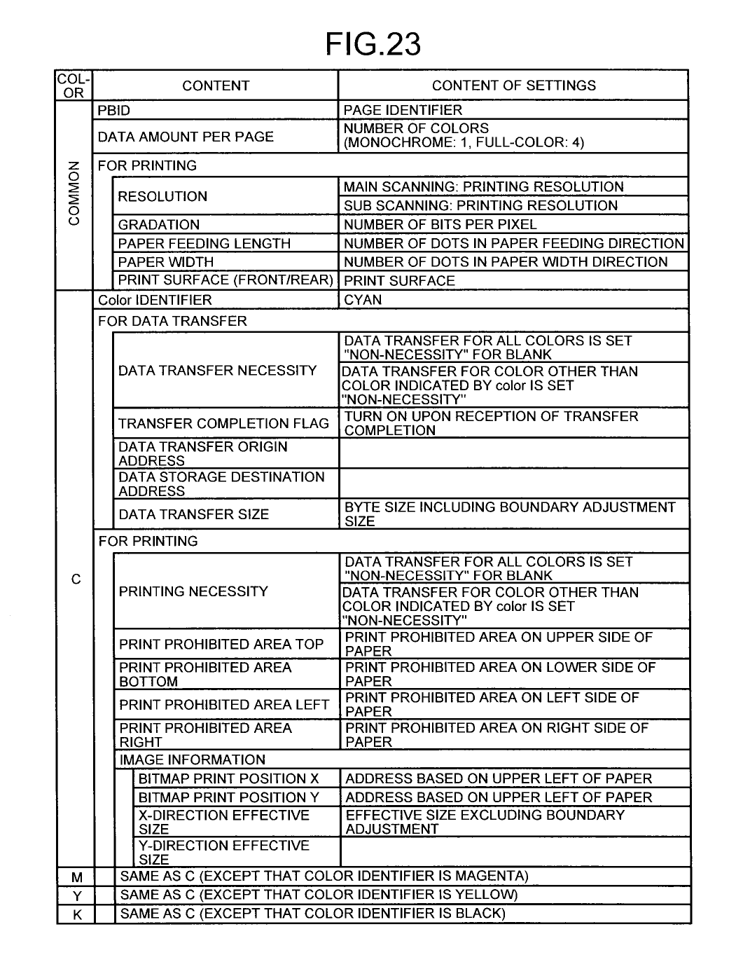

An example of the case where the bitmap data having the different size for each of the colors is transmitted will be described using FIG. 22. For example, as illustrated in (a) of FIG. 22, the case where an image 70 printed using the color C, an image 71 printed using the color M, an image 72 printed using the color Y, and an image 73 printed using the color K are disposed in a printing area 75 of one page is considered. The sizes of the images 70 to 73 are different from each other.

In this case, print image data of a minimum rectangular area including the image 70 is generated as the print image data of the color C at the side of the upper level device 10 and is transmitted to the data transfer control unit 30a. Similar to the color C, with respect to the other colors M, Y, and K, print image data of a minimum rectangular area including the images 71, 72, and 73 is generated at the side of the upper level device 10 and is transmitted to each of the data transfer control units 30b, 30c, and 30d. Thereby, the data transfer amount can be reduced, as compared with the case where print image data of one page is transmitted for each color.

In this case, a first method that performs arrangement of each print image data of the minimum rectangular area including the images 70 to 73 of the individual colors with respect to the predetermined position on the memories 31a to 31d and a second method that performs arrangement of each print image data to the predetermined position when printing is performed are used. Hereinafter, “each print image data of the minimum rectangular area including the images 70 to 73 of the individual colors” is described as “print image data of the images 70 to 73 of the individual colors”.

As illustrated in (b) of FIG. 22, the first method writes the print image data of the images 70 to 73 in the addresses of the memories 31a to 31d corresponding to the printing positions of the images 70 to 73. In order to simplify the description, only a storage area of one page in the memories 31a to 31d is illustrated in (b) of FIG. 22. According to the first method, since the area of one page is common in the memories 31a to 31d, the first virtual memory 60 that is common to the memories 31a to 31d may be prepared at the side of the printer controller 14.

In the first method, with respect to the transfer management table, address information of when the print image data of the images 70 to 73 is written in the memories 31a to 31d is described. As described above, in the memories 31a to 31d, an area where printing ends is cleared after printing of one page of each color ends and the output pointer is updated. For this reason, the data transfer control units 30a to 30d may overwrite the print image data of the images 70 to 73 with respect to the designated addresses of the memories 31a to 31d.

As illustrated in (c) of FIG. 22, the second method writes the print image data of the images 70 to 73 in the memories 31a to 31d. In addition, the print image data of the images 70 to 73 that are read from the memories 31a to 31d are printed with respect to the predetermined arrangement positions of the images 70 to 73. According to the second method, the consumption amount per page in the memories 31a to 31d can be reduced.

Meanwhile, according to the second embodiment, since the sizes of the print image data of the images 70 to 73 may be different from each other, the printer controller 14 needs to prepare the virtual memory 60 with respect to each of the memories 31a to 31d. In this case, in the address map 60a that is illustrated in FIG. 13B, a group of an input pointer (IN), an output pointer (OUT), and a write address (write) is set to each of the memories 31a to 31d, like (INₐ, OUTₐ, and writeₐ), (IN_{b}, OUT_{b}, and write_{b}), . . . . In addition, the transmission information and the print information of each color needs to be described with respect to the transfer management table.

The second method will be specifically described using (c) of FIG. 22. For example, with respect to the image 70 of the color C, a print image data 70a of the minimum rectangular area that includes the image 70 is printed at the position indicated by a printing address 70b of the printing area 75. Likewise, with respect to the images 71, 72, and 73 of the colors M, Y, and K, print image data 71a, 72a, and 73a of the minimum rectangular area that includes the images 71, 72, and 73 are printed at the positions indicated by printing addresses 71b, 72b, and 73b of the printing area 75. Therefore, as information of the transfer management table, data sizes and information indicating the coordinates 70b to 73b need to be held, with respect to the print image data 70a to 73a.

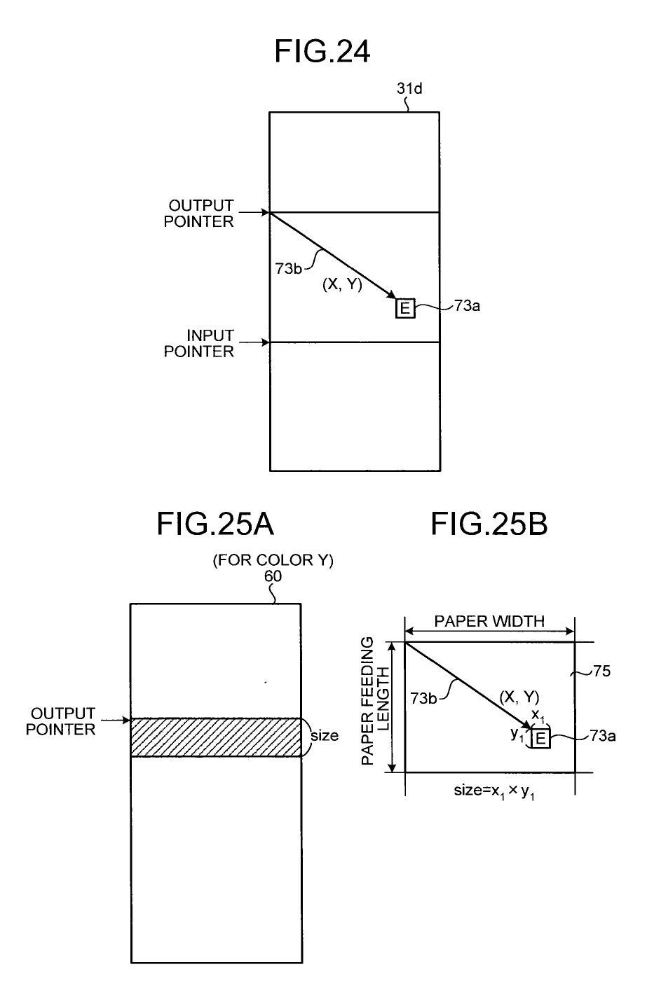

FIG. 23 illustrates an example of the configuration of the transfer management table according to the second memory management method. Hereinafter, the redundant description of a portion that is common to the transfer management table according to the first memory management method illustrated in FIG. 15 will not be repeated.

The transfer management table according to the second memory management method includes information common to the respective colors and information for each color, similar to the transfer management table according to the first memory management method. In this case, in the transfer management table according to the first memory management method and the transfer management table according to the second memory management method, the information common to the colors and the information for each color are different from each other.

The information common to the colors according to the second memory management method will be described. As illustrated in FIG. 23, in the transfer management table according to the second memory management method, the information common to the colors includes a page identifier PBID and the data amount for each page and includes resolution, gradation, a paper feeding length, a paper width, and a printing surface as print information. Since the sizes of the print image data of the individual colors to be transferred are different from each other, the information common to the colors does not include data transfer information.

The information for each color according to the second memory management method will be described. In the information for each color, the Color identifier, the data transfer information, and the print information are included. The data transfer information in the information for each color that is applied to the second memory management method includes data transfer necessity, a transfer completion flag, a data transfer origin address, a data transfer destination address, data storage destination address, and a data transfer size. Among these, the transfer completion flag becomes ON when the printer controller 14 has received the notification informing that the data transfer of the print image data of the corresponding color is completed. The printer controller 14 can update the corresponding input pointer on the virtual memory 60, with respect to the color for which the data transfer completion flag becomes ON.

The print information in the information for each color that is applied to the second memory management method includes print necessity, print prohibited areas (upper side/lower side/left side/right side), and image information. The print information includes the bitmap printing positions X and Y and a Y-direction effective size and an X-direction effective size.

In the second memory management method, the designation of the addresses to arrange the print image data of the images 70 to 73 on the memories 31a to 31d using the first method or the designation of the printing addresses of the print image data of the images 70 to 73 using the second method can be performed by the bitmap printing positions X and Y described as the print information for each color in the transfer management table.

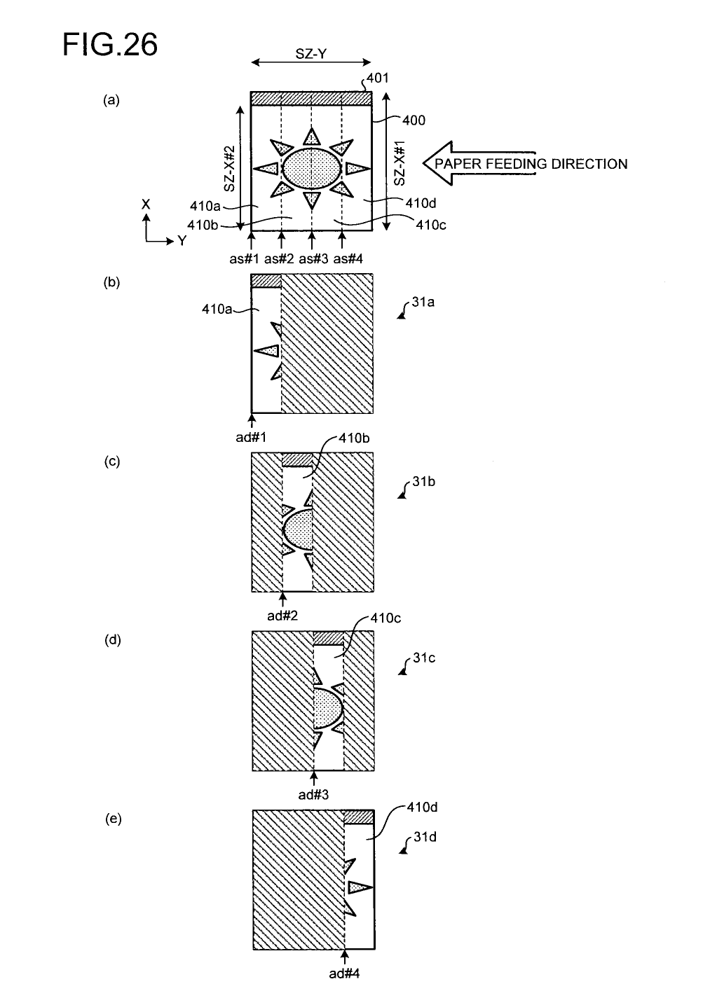

An example of a method of arranging the print image data of the images 70 to 73 on the memories 31a to 31d using the first method will be described using FIG. 24. In this case, the image 73 in FIG. 22 described above is used.

The image 73 is the image for the color K and the print image data 73a of the minimum rectangular area that includes the image 73 is written in the memory 31d in the data transfer control unit 30d. A head of an area of one page in the memory 31d is defined by the address indicated by the output pointer set to the virtual memory 60 common to each color in the printer controller 14. As schematically illustrated in FIG. 24, the address of the memory 31d that is indicated by the bitmap printing positions X and Y in the image 73 and corresponds to the address 73b in printing is calculated on the basis of the address of the head of the area of one page. On the basis of the calculated address, the print image data 73a is written in the memory 31d.

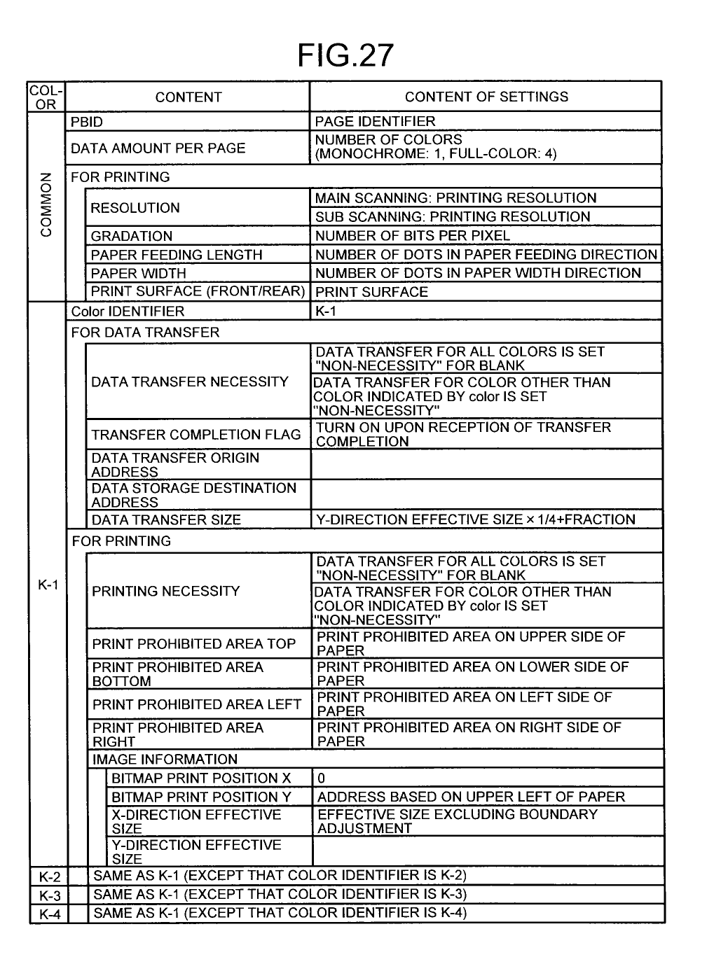

An example of a method of arranging the print image data of the images 70 to 73 on the memories 31a to 31d using the second method will be described using FIGS. 25A and 25B. In this case, the image 73 in FIG. 22 described above is used. FIG. 25A illustrates an example of the virtual memory 60 for the color Y and FIG. 25B illustrates an example of an actual printing area 75 in the printing paper 201.

In the printer controller 14, with respect to the virtual memory 60 for the color Y, a data size (=x₁×y₁) calculated from the X direction effective size (x₁) and the Y direction effective size (y₁) in the transfer management table is regarded as a data size of one page, and the address movement amount at the time of updating the output pointer and the input pointer is set. In the memory 31d, the print image data 73a of the image 73 to be printed next is written from the output pointer (refer to FIG. 25B).

In this case, in order to simplify the description, it is assumed that only print image data of one page is written in the memory 31d. In FIG. 25A, only the output pointer is illustrated and the input pointer is not illustrated.

At the time of printing, the image output unit 50 reads the print image data 73a from the memory 31d, on the basis of the address indicated by the output pointer, and performs printing of the print image data 73a, on the basis of the printing address 73b indicated by the bitmap printing positions X and Y of the image 73. If the print image data corresponding to the data size is read, the output pointer is moved by the data size, and the output pointer is updated.

In the second memory management method, the method of managing the input pointer and the output pointer on the virtual memory 60, the process when the data are received from the upper level device 10, the process when the print image data transfer ends, and the process when printing process ends are the same as those of the first memory management method. Therefore, the redundant description will not be repeated.

In the first memory management method and the second memory management method described above, the colors that are used for printing are the so-called process colors of the colors C, M, Y, and K. However, the present invention is not limited to this. For example, even when colors of red (R), green (G), and blue (B) or special colors such as a gold color, a silver color, and a white color are used for printing, the first memory management method and the second memory management method can be applied as they are. Further, the number of colors is not limited to four. Even when printing is performed using five or more colors, or three or less colors, the first memory management method and the second memory management method can be applied as they are.

### First Embodiment

Next, the first embodiment is described. In the first embodiment, image data with a single color (referred to as single-color image data) generated in the upper level device 10 when the single-color image data are printed with the printer device 13 are divided in accordance with the number of the data transfer control units 30a to 30d included in the printer device 13. On this occasion, in the first embodiment, the single-color image data are divided per unit raster (line) in blocks where rasters are successive. The division pieces of image data obtained by dividing the single-color image data are transferred from the upper level device 10 to the data transfer control units 30a to 30d via the data lines 11a to 11d, respectively and stored in the memories 31a to 31d, respectively.

The division pieces of image data stored in the memories 31a to 31d are supplied to the image output unit 50 via the output lines 33a to 33d at predetermined timing, respectively, and printed at positions on a page that correspond to positions within the single-color image data out of the division pieces of image data.

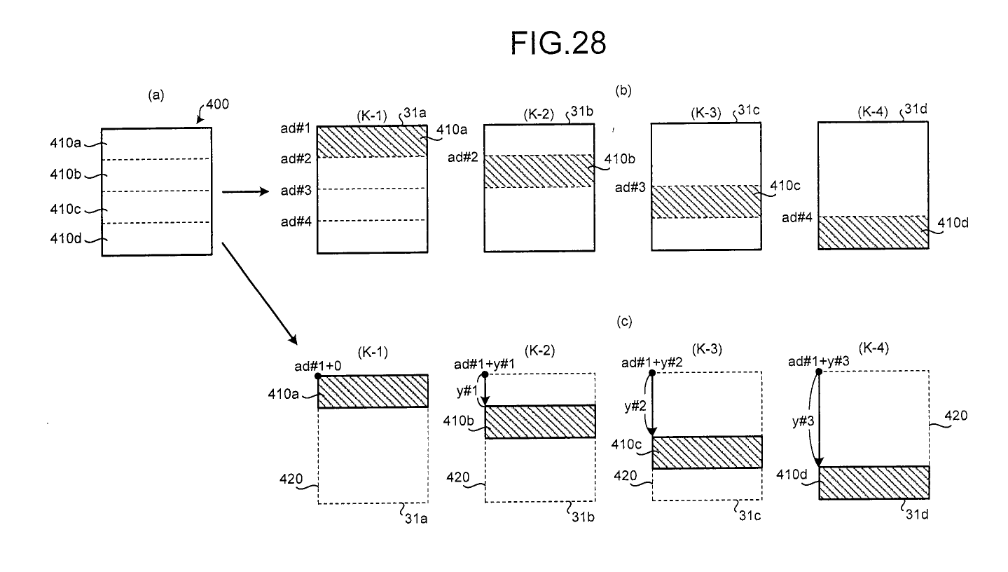

The data transfer according to the first embodiment is more specifically described with reference to FIG. 26. Illustrated in (a) of FIG. 26 is an example of a printing image of single-color image data 400. The single-color image data 400 are created through RIP process based on print job data transmitted from the host device 5 in the upper level device 10, for example and then are written in the RAM 103. As illustrated in (a) of FIG. 26, in the case where the paper is fed from the right side to the left side in the drawing, the lower left corner of the single-color image data 400 in the drawing serves as the origin of coordinates; the Y-direction coordinate increases from the left side toward the right side, and the X-direction coordinate increases from the lower side toward the upper side. One line along the X direction is a raster, and the printing is performed by sequentially increasing the Y coordinate in the raster unit.

In the example of (a) of FIG. 26, the range of the X-direction effective size SZ-X#2 and the Y-direction effective size SZ-Y of the single-color image data 400 is defined as the print region. In the example of (a) of FIG. 26, the single-color image data 400 include a boundary adjustment region 401, and the X-direction effective size SZ-X#2 of the image created by the upper level device 10 through RIP process is smaller than the X-direction data transfer size SZ-X#1 to be transferred.

In the first embodiment, the single-color image data 400 are divided into four blocks, which correspond to the number of data transfer control units 30a to 30d of the printer device 13, in raster unit, and are transferred to the data transfer control units 30a to 30d as division pieces of image data 410a, 410b, 410c, and 410d for each block. The head addresses of the division pieces of image data 410a, 410b, 410c, and 410d in the Y direction at the time of the division are denoted by as#1, as#2, as#3, and as#4, respectively. These addresses as#1, as#2, as#3, and as#4 are transfer origin addresses of the single-color image data 400 in the data transfer control units 30a, 30b, 30c, and 30d, respectively.

Each of (b) to (e) of FIG. 26 illustrates an example in which each of the division pieces of image data 410a, 410b, 410c, and 410d is transferred to each of the data transfer control units 30a, 30b, 30c, and 30d and is written in each of the memories 31a, 31b, 31c, and 31d. For example, as depicted in (b) of FIG. 26, the division piece of image data 410a is written with the address ad#1 as the head address of the writing in the memory 31a of the data transfer control unit provided in the head in the printer device 13 in the printing direction.

Similarly, as illustrated in (c) to (e) of FIG. 26, the division pieces of image data 410b, 410c, and 410d are written in the memories 31b, 31c, and 31d, respectively with the address ad#2, the address ad#3, and the address #4 as the head addresses of the writing. These addresses ad#1, ad#2, ad#3, and ad#4 each serve as the storage destination address of the single-color image data 400 in each of the data transfer control units 30a, 30b, 30c, and 30d.

Here, in the case where the raster number (the Y-direction effective size SZ-Y) of the single-color image data 400 is not the multiple of the integer number of the value n when the single-color image data 400 are divided into the n number of blocks corresponding to the number of the data transfer control units 30a to 30d in raster unit, a raster for a fraction is generated in the single-color image data 400. For example, when the Y-direction effective size SZ-Y is 243 rasters, 243/4=60 with a remainder of 3. A remainder of 3 rasters are allocated one by one to the division pieces of image data 410b, 410c, and 410d in order.

For example, when the Y-direction effective size SZ-Y is Y rasters and the number of data transfer control units 30a to 30d is four, the allocation of the rasters to the division pieces of image data 410a to 410d in the remainder values is as follows. Note that “/” represents the calculation of division, and “%” represents the calculation for the remainder.

(A) In the case of Y % 4=0, (Y/4) rasters are allocated to each of the division pieces of image data 410a to 410d.

(B) In the case of Y % 4=3, the 3 raster remainders is allocated one by one to the division pieces of image data 410a to 410c, for example. That is, {(Y/4)+1} rasters are allocated to each of the division pieces of image data 410a, 410b, and 410c, and (Y/4) rasters are allocated to the division piece of image data 410d.

(C) In the case of Y % 4=2, the 2 raster remainders are allocated one by one to the division pieces of image data 410a and 410b. That is, (Y/4)+1) rasters are allocated to the division pieces of image data 410a and 410b, and (Y/4) rasters are allocated to each of the division pieces of image data 410c and 410d.

(D) In the case of Y % 4=1, the 1 raster remainder is allocated to the division piece of image data 410a, for example. That is, the {(Y/4)+1} rasters are allocated to the division piece of image data 410a, and (Y/4) rasters are allocated to each of the division pieces of image data 410b, 410c, and 410d.

### <Transfer Management Table>

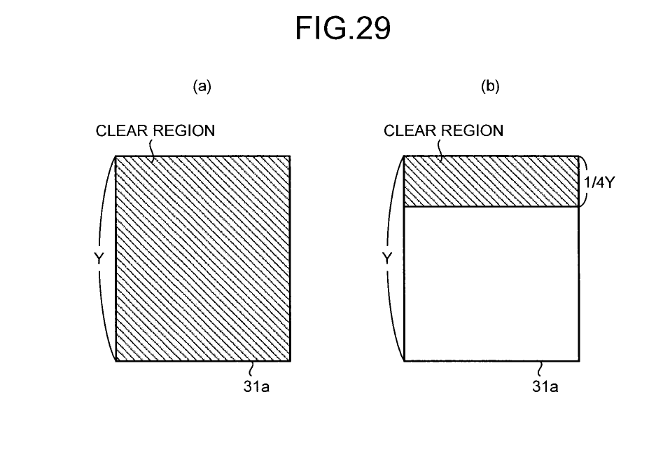

Next, the transfer management table according to the first embodiment is described. FIG. 27 illustrates an example of the configuration of the transfer management table according to the first embodiment. The description is omitted on the items common to the transfer management tables according to the first memory management method and the second memory management method which have been described with reference to FIGS. 15 and 23. The colors of the division pieces of image data 410a, 410b, 410c, and 410d handled with the data transfer control units 30a, 30b, 30c, and 30d when the single-color data are black (K) image data are represented by colors K-1, K-2, K-3, and K-4, respectively.

In the transfer management table of FIG. 27, the information common to the respective colors is approximately common to the transfer management table according to the second memory management method described with reference to FIG. 23. In the example of FIG. 27, the method according to the first embodiment can be applied to the printing with two colors (for example, black and red colors); therefore, the data number “2” in the case of the two colors is added concerning the data number per page.

The information for each color according to the first embodiment is described. In the information for each color, the value of the Color identifier represents the color K-1, the color K-2, the color K-3, and the color K-4 about the color-1, the color K-2, the color K-3, and the color K-4, respectively. Hereinafter, each piece of information when the Color identifier is “color K-1” is described.

Among the pieces of data transfer information for each color, the address as#1 described with reference to (a) of FIG. 26 is described as the data transfer origin address. Meanwhile, as the data storage destination address, the information corresponding to the method of writing the division pieces of image data 410a to 410d in the memories 31a to 31d is described.

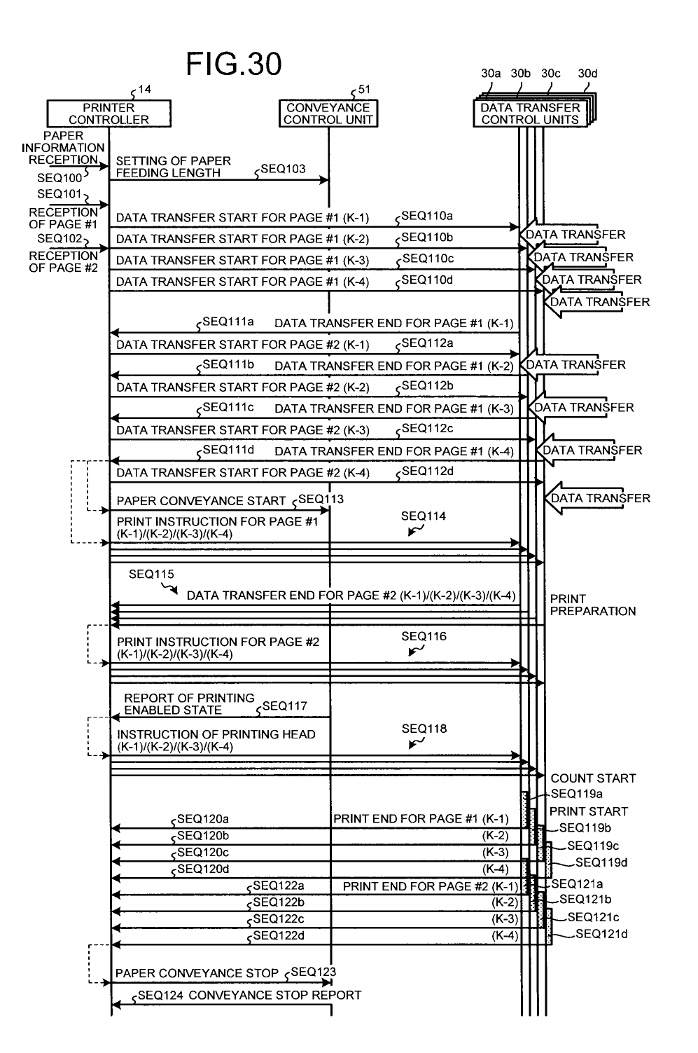

With reference to FIG. 28, an example of the method of writing the division pieces of image data 410a to 410d in the memories 31a to 31d is described. For writing the division pieces of image data 410a to 410d obtained by dividing the single-color image data 400 in (a) of FIG. 28 in the memories 31a to 31d, the following two methods are considered.

In a first writing method, a region for one page is secured in each of the memories 31a to 31d and the division pieces of image data 410a to 410d are written in the regions of the memories 31a to 31d in accordance with the printing image. In this case, the addresses ad#1 to ad#4 in the memories 31a to 31d described with reference to (b) to (e) of FIG. 26 serve as the data storage destination addresses, respectively.

That is, as depicted in (b) of FIG. 28, for example, the division piece of image data 410a indicated by the Color identifier “K-1” are written after the address ad#1 of the memory 31a and just before the address ad#2 corresponding to the writing position of the head of the next division piece of image data 410b. That is, the address ad#1 is described as the data storage destination address.

For example, the division piece of image data 410b indicated by the Color identifier “K-2” is written after the address ad#2 of the memory 31b and just before the address ad#3 corresponding to the writing position of the head of the next division piece of image data 410c. That is, the address ad#2 is written as the data storage destination address. This similarly applies to the division pieces of image data 410c and 410d indicated by the Color identifiers “K-3” and “K-4”, respectively.

In a second writing method, only a region of the size that corresponds to the data transfer size of each of the division pieces of image data 410a to 410d is secured in each of the memories 31a to 31d, and the division pieces of image data 410a to 410d are written. In this case, the offset at the time of printing is designated together with the data storage destination address.

The second writing method is described with reference to (c) of FIG. 28. In (c) of FIG. 28, a region 420 is a print region for one page corresponding to the entire single-color image data 400. On the other hand, the division pieces of image data 410a to 410d are written in the memories 31a to 31d from the head address ad#1, for example. Then, at the time of printing, the offset of the printing position relative to the original point in the Y direction is set at, for example, a value “0”, a value “y#1”, a value “y#2”, and a value “y#3” relative to the division pieces of image data 410a to 410d stored in the memories 31a to 31d. It is considered that the offset values at the time of printing relative to the division pieces of image data 410a to 410d are written together with the data storage destination address.

As for the data transfer size, the size of the sum of the quotient obtained by dividing the Y-direction effective size SZ-Y by the number of data transfer control units 30a to 30d and the value obtained by allocating the fraction, i.e., the remainder to the data transfer control units 30a to 30d for every raster as appropriate is described.

The pieces of data transfer information for every color excluding the data transfer origin address, the data storage destination address, and the data transfer size are common to the aforementioned information of the transfer management table of FIG. 23.

Among the pieces of print information for each color, the value “0” indicating the position of the left end of the paper is described as the bitmap printing position X. The print information except for the bitmap X is common to the information of the transfer management table of FIG. 23.

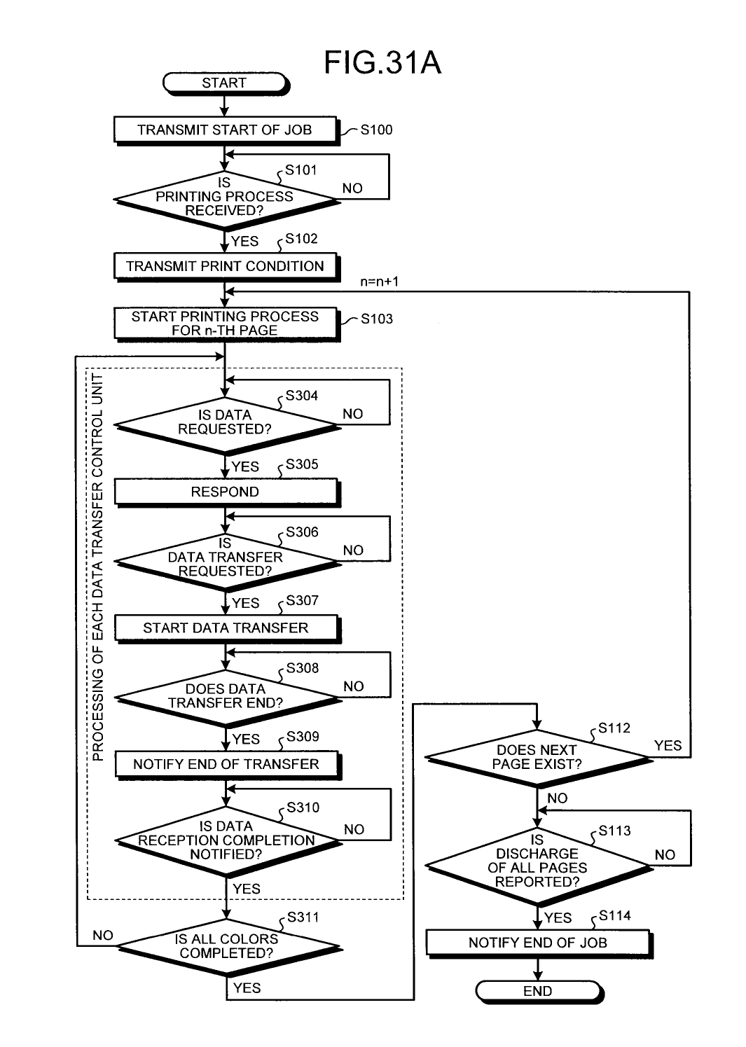

A zero-clearing method for the memories 31a to 31d is different in the first writing method and the second writing method. With reference to FIG. 29, the zero-clearing method for the memories 31a to 31d according to the first embodiment is described. Note that the memories 31a to 31d are represented by the memory 31a throughout FIG. 29. The size Y corresponds to the size for one page in the Y direction.

Illustrated in (a) of FIG. 29 is an example of the zero-clearing method for the first writing method. In the first writing method, for example, the region for one page is secured in the memory 31a, and the division piece of print image data 410a is written in the position corresponding to the printing image for the secured region. Therefore, zero-clearing is performed while the entire region for one page of the memory 31a is used as the clear region as illustrated with oblique lines in (a) of FIG. 29.

Illustrated in (b) of FIG. 29 illustrates an example of the zero-clearing method for the second writing method. In the second writing method, for example, the region of the size that corresponds to the data transfer size of the division piece of image data 410a in the memory 31a is secured. Therefore, zero-clearing is performed while only the region in which the division piece of image data 410a are written is used as the clear region. In the example having the four data transfer control units 30a to 30d, the data transfer size for the division piece of image data 410a is obtained by adding the fraction to the size Y×¼. Accordingly, as illustrated with oblique lines in (b) of FIG. 29, the region ranging from the head address in which the division piece of image data 410a is written to the address in which the fraction is added to the size Y×¼ is used as the clear region.

### <Printing Sequence According to the First Embodiment>

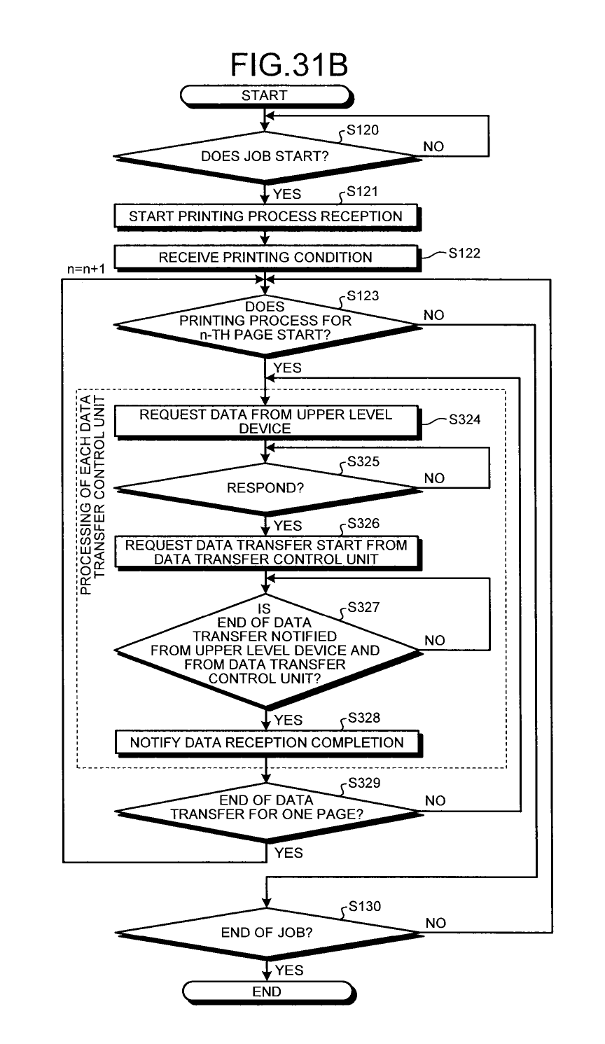

Next, the printing process according to the first embodiment is described. FIG. 30 is a sequence diagram of an example schematically illustrating the printing process applicable to the first embodiment. In FIG. 30, the parts common to those in FIG. 8 are denoted by the same reference symbols and the detailed description thereto is omitted. Moreover, the following description is mainly made of the part different from the sequence of FIG. 8 described above.

The sequence of the printing process according to the first embodiment illustrated in FIG. 30 is basically similar to the sequence described with reference to FIG. 8. The sequence of FIG. 30 is different from that of FIG. 8 in the designation of data subsequent to SEQ110a to 110d. That is, in FIG. 30, the designation of the colors Y, C, M, and K in FIG. 8 is the designation of the division pieces of image data obtained by dividing the single-color image data (color K-1, color K-2, color K-3, and color K-4).

More specifically, in SEQ110a to 110d, the printer controller 14 requests the data transfer control units 30a, 30b, 30c, and 30d to start the data transfer of the first page concerning the colors K-1, K-2, K-3, and K-4. In accordance with this request, the data transfer control unit 30a requests the division piece of image data 410a corresponding to the color K-1 in the single-color image data 400 from the upper level device 10 via the data line 11a, and stores in the memory 31a, the division piece of image data 410a for the first page of the color K-1, which is the print image data transferred from the upper level device 10 in response to this request. The description on the processing of the colors K-2 to K-4 of the SEQ110b to 110d is omitted because the processing thereof is similar to that of the color K-1 of the SEQ110a.

Upon the completion of the transfer of the print image data of the first page of the colors from the upper level device 10, the data transfer control units 30a, 30b, 30c, and 30d notify the printer controller 14 of the completion (SEQ111a, SEQ111b, SEQ111c, and SEQ111d). At this time, in the first embodiment, the image data of the size corresponding to ¼ of one page are transferred to the data transfer control units 30a, 30b, 30c, and 30d. Therefore, the data transfer processing can be performed at high speed as compared with, for example, the case where the image data for one page are transferred to at least one of the data transfer control units 30a, 30b, 30c, and 30d.

The printer controller 14 responds to each notification, and requests the data transfer control units 30a, 30b, 30c, and 30d to start the data transfer for the second page (page #2) (SEQ112a, SEQ112b, SEQ112c, and SEQ112d). In response to this request, the data transfer control units 30a, 30b, 30c, and 30d request the print image data for the second page of the colors from the upper level device 10, and store in the memories 31a, 31b, 31c, and 31d, the division pieces of image data 410a to 410d, which are the print image data transferred from the upper level device 10 in accordance with this request.

Since the processes of SEQ113 to SEQ117 are similar to those described with reference to FIG. 8, the description is omitted.

The printer controller 14 instructs the data transfer control units 30a, 30b, 30c, and 30d on the start point of the printing according to the report of the printing enabled state from the conveyance control unit 51 in SEQ117 (SEQ118).

The data transfer control units 30a, 30b, 30c, and 30d start the printing according to the printing start point instruction. In this example, four heads are arranged in the order of heads 56a, 56b, 56c, and 56d in the conveyance direction of the printing paper 201.

In the case where the division pieces of image data 410a to 410d are written in the memories 31a to 31d according to the first writing method described with reference to (b) of FIG. 28, upon the reach of the start point of the printing of the first page on the printing paper 201 at the printing position by the head 56a, first, the readout of the print image data of the first page from the memory 31a is started in the data transfer control unit 30a. The data transfer control unit 30a reads out the print image data by the division piece of image data 410a of the color K-1 from the head (address ad#1) of the region of one page secured on the memory 31a. The readout print image data are transferred to the image output unit 50 and supplied to the head 56a via the output control unit 55, and thus the printing on the printing paper 201 is performed (SEQ119a). Upon the completion of the printing on the first page of the color K-1, the completion is notified to the printer controller 14 (SEQ120a).

Similarly, the readout and printing of the division pieces of image data 410b to 410d are sequentially performed by the data transfer control units 30b to 30d.

In the case where the division pieces of image data 410a to 410d are written in the memories 31a to 31d according to the second writing method described with reference to (c) of FIG. 28, upon the reach of the start point of the printing of the first page on the printing paper 201 at the printing position by the head 56a, first, the readout of the print image data of the first page from the memory 31a is started in the data transfer control unit 30a. The data transfer control unit 30a reads out the print image data by the division piece of image data 410a of the color K-1 from the address ad#1 of the memory 31a. The readout print image data are transferred to the image output unit 50 and supplied to the head 56a via the output control unit 55, and thus the printing on the printing paper 201 is performed (SEQ119a). Upon the completion of the printing on the first page of the color K-1, the completion is notified to the printer controller 14 (SEQ120a).

Subsequently, when the start point of the printing of the first page on the printing paper 201 has reached the printing point by the head 56b, the readout of the division piece of image data 410b, which is the print image data for the first page, from the memory 31b is started by the data transfer control unit 30b at the timing when the start point of the printing of the first page is advanced from the timing of the reach by the amount of distance corresponding to the offset “y#1” set relative to the division piece of image data 410b stored in the memory 31b. The division piece of image data 410b read out from the memory 31b is transferred to the image output unit 50 and supplied to the head 56b via the output control unit 55, and the printing on the printing paper 201 is started (SEQ119b). Upon the completion of the printing of the division piece of image data 410b, the completion is notified to the printer controller 14 (SEQ120b).

As for the division piece of image data 410c, similarly, the data transfer control unit 30c starts to read out the division piece of image data 410c, which is the print image data for the first page, from the memory 31c at the timing when the start point of the printing for the first page is advanced from the timing of the reach of the start point of the printing for the first page on the printing paper 201 at the printing point by the head 56c by the amount of distance corresponding to the offset “y#2” set relative to the division piece of image data 410c. Similarly, the data transfer control unit 30d reads out the division piece of image data 410d from the memory 31d at the timing determined in consideration of the offset “y#3” set relative to the division piece of image data 410d.

### <Detail of Printing Process>

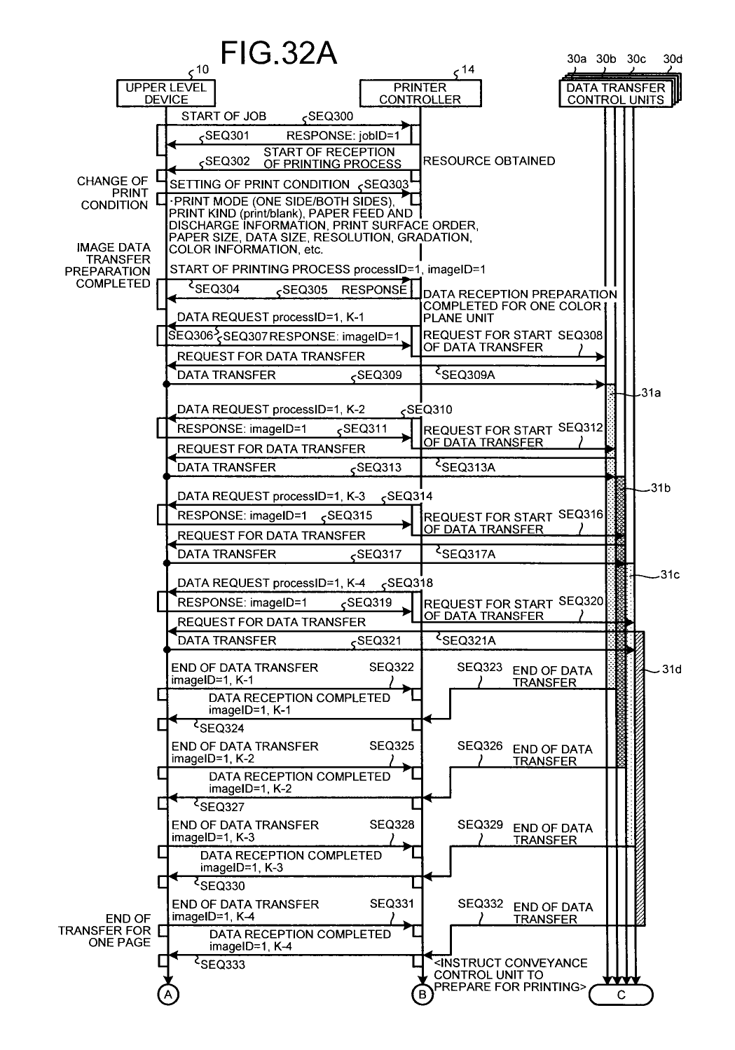

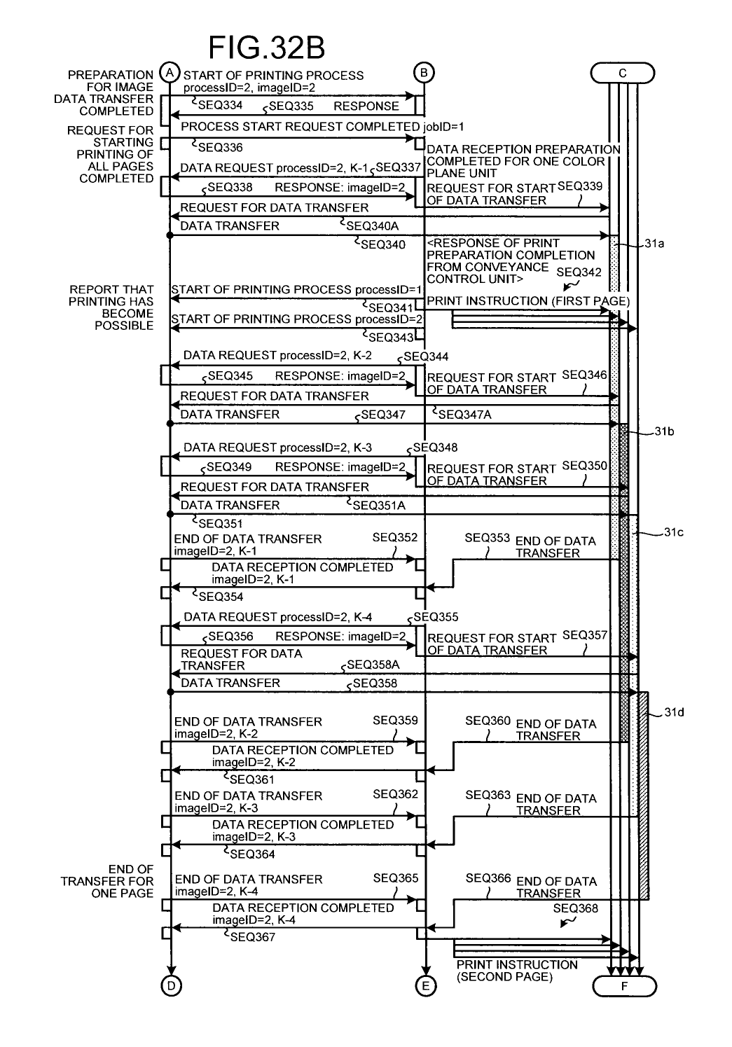

Next, the printing process applicable to the first embodiment is more specifically described. FIG. 31A is a flow chart illustrating an example of the process of the upper level device 10 for the data transfer. The parts of the process in FIG. 31A which are common to the process of FIG. 9A described above are denoted by the same reference symbols and the detailed description thereof is omitted. Since the process from the job start transmission of Step S100 to the start of the printing process for the n-th page in Step S103 is the same process as that of FIG. 9A, the description is omitted. The process ranging from Step S103 to Step S112 including Step S304 to Step S311 is performed per page.

The process for starting the printing process for the n-th page in Step S103 is followed by process of Step S304. Subsequently, the processes of Step S304 to Step S310 are performed for each of the data transfer control units 30a to 30d. The description is hereinafter made mainly of the process of the data transfer control unit 30a.

The upper level device 10 stands by the request for the division piece of image data 410a, which is the printing image of the color K-1, from the printer controller 14 in Step S304. Upon the receipt of the data request transmitted from the printer controller 14 via the control line 12, the upper level device 10 returns a response to the received data request to the printer controller 14 in Step S305. Then, in the next Step S306, the upper level device 10 stands by a data transfer request transmitted from the data transfer control unit 30a via the data line 11a.

Upon the receipt of the data transfer request from the data transfer control unit 30a via the data line 11a, the upper level device 10 starts to transfer the division piece of image data 410a, which is the print image data of the color K-1, to the data transfer control unit 30a in Step S307. The division piece of image data 410a is transferred to the data transfer control unit 30a via the data line 11a. At this time, the upper level device 10 adds the information indicating the size of the division piece of image data 410a to the division piece of image data 410a to be transferred.

The upper level device 10 stands by the completion of the data transfer of the division piece of image data 410a for one page in Step S308. With reference to FIG. 2B, the upper level device 10 monitors, for example, the storage unit 122 and the interface 123 using the control unit 124 monitor, and determines whether the transfer of each of the division pieces of image data 410a to 410d for one page has been done or not. When it is determined that the data transfer of the division piece of image data 410a for one page terminates, the upper level device 10 makes the process proceed to Step S309 and the data transfer completion notification indicating the completion of the data transfer for one page is transmitted to the printer controller 14 via the control line 12. Then, the upper level device 10 stands by a data reception completion notification of the division piece of image data 410a from the printer controller 14 in Step S310.

The upper level device 10 determines whether the data reception completion notifications of all the division pieces of image data 410a to 410d have been received in Step S311. If it is determined that the reception is not made, the process returns to Step S304 and the process on the next color is executed.

Although it has been described with FIG. 31A that the processes of Step S304 to Step S310 are sequentially executed on the division pieces of image data 410a to 410d, the present invention is not limited to this example. For example, the processes of Step S304 to Step S310 can be executed in parallel with respect to the division pieces of image data 410a to 410d. In this case, in Step S311, the upper level device 10 stands by the data reception completion notification in Step S310 in each of the processes performed on the division pieces of image data 410a to 410d.

If it is determined that the data reception completion notification is received on the division pieces of image data 410a to 410d in Step S311, the process proceeds to Step S112 and the upper level device 10 determines whether to execute the printing process for the next page. The number of pages to be printed can be acquired from the print job data received from the host device 5. However, if it is determined that the printing process for the next page exists, the process returns to Step S103 with the page number determined as n=n+1.

On the other hand, when it is determined that the data transfer for all the pages indicated on the print job data is completed, the process proceeds to Step S113 and the upper level device 10 stands by the paper output report for all the pages from the printer controller 14. The upper level device, upon the receipt of the paper output report for all the pages from the printer controller 14, makes the process proceed to Step S114 and transmits a job end notification indicating that all the print jobs end via the control line 12 to the printer controller 14.

FIG. 31B is a flow chart illustrating an example of the process of the printer controller 14 relating to the data transfer. Note that in each process of FIG. 31B, the parts common to the processing of FIG. 9B described above are denoted by the same reference symbols and detailed description thereof is omitted. Since the process from the job start transmission of Step S120 to the start of the printing process for the n-th page in Step S123 is the same process as that of FIG. 9B, the description is omitted. The process ranging from Step S123 to Step S329 is performed per page.

After the start of the printing process for the n-th page in Step S123, the process proceeds to Step S324. Subsequently, the process of Step S324 to Step S328 is performed for each of the data transfer control units 30a to 30d. The description is hereinafter made mainly of the process of the data transfer control unit 30a.

In Step S324, the printer controller 14 requests the print image data from the upper level device 10 via the control line 12, and in the next Step S325, stands by a response to this request from the upper level device 10. Upon the receipt of the response from the upper level device 10, the printer controller 14 requests the start of the data transfer via the engine I/F control line 40a from the data transfer control unit 30a in the next Step S326.

At this time, the printer controller 14 extracts from among the information of the color K-1 of the transfer management table described with reference to FIG. 27, at least the page identifier PBID indicating the page to be printed (n-th page), the transfer origin address indicating the address of the transfer origin of the division piece of image data 410a, which is the print image data, the storage destination address indicating the address of the storage destination of the division piece of image data 410a, and the data transfer size. Then, the printer controller 14 adds these extracted pieces of information to the data transfer start request that requests the start of the data transfer and transmits them to the data transfer control unit 30a, for example.

In the next Step S327, the printer controller 14 stands by the data transfer completion notification from the upper level device 10 and the data transfer completion notification from the data transfer control unit 30a. Upon the receipt of the data transfer completion notifications from the upper level device 10 and the data transfer control unit 30a via the control line 12 and the engine I/F control line 40a, respectively, the printer controller 14 proceeds the process to Step S328 and transmits the data reception completion notification on the division piece of image data 410a to the upper level device 10 via the control line 12.

The printer controller 14 determines whether the data transfer of the division pieces of image data 410a, 410b, 410c, and 410d has ended in Step S329. However, if it is determined that the transfer does not end yet, the process returns to Step S324 and the process on the next division piece of image data is executed. Meanwhile, if it is determined that the data transfer for one page has ended in Step S329, the printer controller 14 returns the process to Step S123 with the page number determined as n=n+1.

Although it has been described with FIG. 31B that the processes of Step S324 to Step S328 are sequentially executed on the division pieces of image data 410a to 410d, the present invention is not limited to this example. For example, the processes of Step S324 to Step S328 can be executed in parallel with respect to the division pieces of image data 410a to 410d. In this case, in Step S329, the upper level device 10 stands by the data reception completion notification in Step S328 in each of the processes on the division pieces of image data 410a to 410d.

The printer controller 14 transmits the print instruction to the data transfer control units 30a to 30d via the engine I/F control lines 40a to 40d, respectively. By this print instruction, the division pieces of image data 410a to 410d, which are the print image data, are read out from the memories 31a to 31d in the data transfer control units 30a to 30d, and thus the print of the print image data on the printing paper 201 is executed.

With reference to the aforementioned flow chart of FIG. 9C, the process of an example for performing the print instruction by the printer controller 14 according to the first embodiment is described. Prior to the execution of the flow chart of FIG. 9C, the printer controller 14 transmits the print preparation instruction to the conveyance control unit 51.

The printer controller 14, if it is determined that the job end notification is not transmitted from the upper level device 10 in Step S140, proceeds the process to Step S141 and then stands by the end of the transfer of the print image data for at least one page on the division pieces of image data 410a to 410d. If it is determined that the transfer of the print image data for one page ends, the printer controller 14 proceeds the process to Step S142 and stands by the reception of the response indicating the printing preparation completion from the conveyance control unit 51. Upon the receipt of the response, the printer controller 14 transmits the print instruction instructing the printing of the n-th page to the data transfer control units 30a to 30d (Step S143).

With reference to the aforementioned flow chart of FIG. 9D, the process of the data transfer control units 30a to 30d at the data transfer according to the first embodiment is described. Here, for the explanation, the data to be transferred are referred to as the division piece of image data 410a and the process in the data transfer control unit 30a is described.

Upon the receipt of the data transfer start request from the printer controller 14 in Step S150, the data transfer control unit 30a transmits the data transfer request for requesting the transfer of the division piece of image data 410a to the upper level device 10 via the data line 11a in the next Step S151. The division piece of image data 410a transferred from the upper level device 10 via the data line 11a in accordance with this data transfer request are received by the data transfer control unit 30a (Step S152). The data transfer control unit 30a stores the received division piece of image data 410a in a predetermined region of the memory 31a (Step S153).

The data transfer control unit 30a determines whether the transfer of the division piece of image data 410a from the upper level device 10 has ended or not in Step S154. The data transfer control unit 30a can determine whether the transfer of the print image data has ended or not, based on the size information added to the transferred division piece of image data 410a, for example. If it is determined that the transfer of the division piece of image data 410a has not ended yet, the process returns to Step S152 and the data reception and the storage into the memory 31a are continued. In contrast, if it is determined that the transfer of the print image data has ended, the process proceeds to Step S155 and the data transfer end notification is transmitted to the printer controller 14. Then, the process returns to Step S150.

In the above description, the division pieces of image data 410a to 410d are transferred by the upper level device 10 in accordance with the data transfer request transmitted via the data lines 11a to 11d from the data transfer control units 30a to 30d of the division pieces of image data 410a to 410d during the transfer process of the division pieces of image data 410a to 410d. The present invention is not limited to this example, and as described above in another example of the data transfer process, the data transfer control units 30a to 30d do not transmit the data transfer request to the upper level device 10 and after the upper level device 10 responds to the data request from the printer controller 14, the division pieces of image data 410a to 410d are transferred directly to the data transfer control units 30a to 30d via the data lines 11a to 11d.

The process in this case is approximately the same as the process described above with reference to FIGS. 11A and 11B in which the description on the print image data of the colors is replaced by the description on the division pieces of image data; therefore, the description is omitted here.

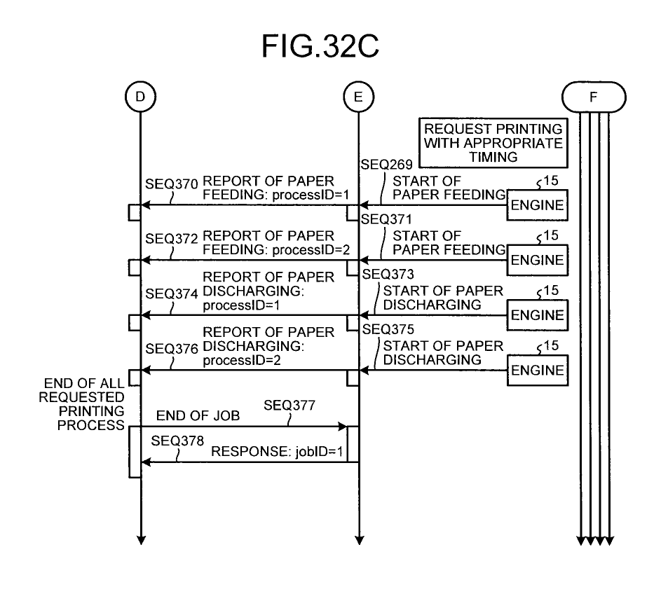

FIGS. 32A to 32C are the sequence diagrams of an example illustrating more specifically the print processing applicable to the first embodiment, which is performed according to the process described with reference to the flow charts of FIGS. 31A and 31B and FIGS. 9C and 9D. In FIGS. 32A to 32C, the parts common to those of FIGS. 10A to 100 are denoted by the same reference symbols and the detailed description is omitted.

Each process in the sequence diagrams of FIGS. 32A to 32C is the one in which the process on the colors of Y, M, C, and K in each process of FIGS. 10A to 10C is substantially replaced by the process on the division pieces of image data 410a to 410d. The processes of SEQ300 to SEQ305 are the same as those of SEQ200 to SEQ205 in FIG. 10A; therefore, the description here is omitted.

The printer controller 14 transmits via the control line 12 to the upper level device 10, the control information of the print process request for requesting the division piece of image data 410a, which are the print image data (SEQ306). This control information includes the process identification number processID=1 for designating the process and the color information K-1 for designating the color K-1. The information necessary for reading out the division piece of image data 410a, for example the transfer origin address may be transmitted to the upper level device 10 instead of the color information K-1.

The upper level device 10 returns the control information including the image identification number imageID=1 to the printer controller 14 as the response to this control information (SEQ307). Upon the receipt of the control information, the printer controller 14 requests the start of the transfer of the division piece of image data 410a from the data transfer control unit 30a corresponding to the color K-1 (SEQ308). At this time, the printer controller 14 transmits the data size of the division piece of image data 410a for requesting the start of the transfer to the data transfer control unit 30a together with this request.

Upon the receipt of this request, the data transfer control unit 30a requests the division piece of image data 410a corresponding to the color K-1 from the upper level device 10 via the data line 11a (SEQ309A). Note that in the first embodiment, just a single plane exists for printing the single-color image data 400; therefore, the plane is not designated in particular. Of course, the plane may be designated like the plane #1, for example. In response to the request of SEQ309A, the division piece of image data 410a are transferred from the upper level device 10 to the data transfer control unit 30a (SEQ309). The transferred division piece of image data 410a are stored in a region allocated for the print image data for the first page in the memory 31a of the data transfer control unit 30a.

The other division pieces of image data 410b, 410c, and 410d are subjected to the similar process to the aforementioned SEQ306, SEQ307, SEQ308, SEQ309A, and SEQ309, and the division pieces of image data 410b, 410c, and 410d are transferred to the data transfer control units 30b, 30c, and 30d via the data lines 11b, 11c, and 11d from the upper level device 10, respectively and are stored in the regions of the memories 31b, 31c, and 31d allocated for the print image data for the first page (SEQ310 to SEQ321).

Every time the transfer of the print image data of the division pieces of image data 410a to 410d ends, the control information of the data transfer completion is transmitted to the printer controller 14. The printer controller 14 transmits the control information of the reception completion of the division pieces of image data 410a to 410d to the upper level device 10 in accordance with this control information.

For example, the upper level device 10 transmits the control information of the data transfer completion including the image identification number imageID=1 and the color information K-1 to the printer controller 14 upon the completion of the transfer of the division piece of image data 410a (SEQ322). Meanwhile, upon the end of the transfer of the division piece of image data 410a from the upper level device 10, the data transfer control unit 30a transmits the notification indicating the end of the transfer to the printer controller 14 (SEQ323). The printer controller 14 transmits the control information of the data reception completion including the image identification number imageID=1 and the color information K-1 in accordance with this notification (SEQ324).

The other division pieces of image data 410b, 410c, and 410d are subjected to the similar process to the aforementioned SEQ322 to SEQ324 along with the end of the transfer of the division pieces of image data 410b, 410c, and 410d, and the control information of the data reception completion is transmitted to the upper level device 10 (SEQ325 to SEQ333).

According to the first embodiment, the print image data transferred to the data transfer control units 30a to 30d from the upper level device 10 are the division piece of image data 410a to 410d obtained by dividing the single-color image data 400 for one page into the blocks whose number corresponds to the number of the data transfer control units 30a to 30d. Therefore, as compared with the case of transferring the image data for one page from the upper level device 10 to the data transfer control units 30a to 30d, the process from SEQ306 to SEQ333 can be executed at high speed.

The printer controller 14 transmits the control information of the data reception completion on the final print image data (for example, the division piece of image data 410d) of the first page in SEQ333, and then instructs the preparation of the printing to the conveyance control unit 51. The conveyance control unit 51 starts the conveyance of the printing paper 201 to the printing position in accordance with the instruction.

Now, description is made with reference to FIG. 32B. After the completion of the transfer of the division pieces of image data 410a to 410d in the first page, the upper level device 10 transmits the control information of the printing process start of the second page to the printer controller 14 (SEQ334). This control information includes the process identification number processID=2 for identifying the process of the second page and the image identification number imageID=2 indicating the image forming the second page. The printer controller 14 returns the control information of the printing process start, which is the response to the printing process start, to the upper level device 10 (SEQ335). The upper level device 10, upon the receipt of this response, transmits to the printer controller 14 the control information of the completion of the process start request designated by the job identifier jobID=1 in SEQ336.

Next, in a manner similar to the aforementioned SEQ306 to SEQ321, the printer controller 14 transmits the control information of the printing process request to the upper level device 10 to request the print image data. This printing process request is sequentially performed on the division pieces of image data 410a to 410d in the order of the heads 56a to 56d corresponding to the data transfer control units 30a to 30d in which these are stored, respectively.

For example, the printer controller 14 transmits the control information of the printing process request for requesting the division piece of image data 410a to the upper level device 10 (SEQ337). This control information includes the process identification number processID=2 for designating the process and the color information K-1 for designating the color K-1. The upper level device 10 returns the control information including the image identification number imageID=2 as the response to this control information to the printer controller 14 (SEQ338). Upon the receipt of this control information, the printer controller 14 requests the start of the transfer of the division piece of image data 410a from the data transfer control unit 30a corresponding to the color K-1 (SEQ339).

In response to this request, the data transfer control unit 30a requests the division piece of image data 410a from the upper level device 10 via the data line 11a (SEQ340A), and in accordance with this request, the division piece of image data 410a are transferred from the upper level device 10 to the data transfer control unit 30a (SEQ340). The transferred division piece of image data 410a are stored in the region of the memory 31a in the data transfer control unit 30a allocated to the print image data for the second page.

The other division pieces of image data 410b to 410d are subjected to the similar process to the aforementioned SEQ337, SEQ338, SEQ339, SEQ340A, and SEQ340, and the division pieces of image data 410b to 410d are transferred to the data transfer control units 30b, 30c, and 30d via the data lines 11b, 11c, and 11d from the upper level device 10 and stored in the regions of the memories 31b, 31c, and 31d allocated for the print image data for the second page, respectively (SEQ344 to SEQ351, SEQ355 to SEQ358).

Similarly, the upper level device 10 transmits the control information of the data transfer completion every time the transfer of each of the division pieces of image data 410a to 410d ends. The printer controller 14 transmits the control information of the reception completion of the print image data to the upper level device 10 in response to this control information.

In the example of FIG. 32B, upon the end of the transfer of the division piece of image data 410a transferred in SEQ340, the upper level device 10 transmits the control information of the data transfer completion to the printer controller 14 (SEQ352). Upon the end of the transfer of the division piece of image data 410a from the upper level device 10 via the data line 11a, the data transfer control unit 30a transmits the notification indicating the end of the transfer to the printer controller 14 (SEQ353). In response to this notification, the printer controller 14 transmits the control information of the data reception completion including the image identification number imageID=2 and the color information K-1 to the upper level device 10 (SEQ354).

The other division pieces of image data 410b to 410d are also subjected to the similar process to the aforementioned SEQ352 to SEQ354 along with the end of the transfer of the division pieces of image data 410b to 410d. Thus, the control information of the data reception completion is transmitted to the upper level device 10 (SEQ359 to SEQ367).

In the example of FIG. 32B, in a manner similar to FIG. 10B, the response to the instruction of the printing preparation with respect to the conveyance control unit 51 just before the aforementioned SEQ334, which indicates that the printing preparation from the conveyance control unit 51 has been completed, is notified to the printer controller 14 from the conveyance control unit 51 just after the SEQ340. Upon the receipt of the notification, the printer controller 14 transmits to the upper level device 10, the control information of 2 of the printing process start assuming that the process identification number processID=1 and the process identification number processID=2 (SEQ341 and SEQ343). Thus, the notification that the printing on the first page and the second page has become possible is given to the upper level device 10.

At the time of SEQ341, the transfer of the division pieces of image data 410a to 410d for the first page to the data transfer control units 30a, 30b, 30c, and 30d has been completed. Therefore, the print instruction for performing the printing for the first page is notified by the printer controller 14 to the data transfer control units 30a, 30b, 30c, and 30d (SEQ342). This print instruction is held in the data transfer control units 30a, 30b, 30c, and 30d using, for example, the memories 31a, 31b, 31c, and 31d, respectively. The printing operation according to the print instruction is performed in accordance with the timing of the printing operation for the subsequent page or the like.

Moreover, in the example of FIG. 32B, due to the transmission of the control information of the printing process start of SEQ341 and SEQ343, the request for the division piece of image data 410b, which starts to be transferred secondly, to the upper level device 10 is delayed in the printer controller 14 (see SEQ344). Due to this delay, the transfer of the division piece of image data 410a, which starts to be transferred first, has been completed before the start of the transfer of the division piece of image data 410d (see SEQ353). Moreover, after the notification process of the transfer completion for the division piece of image data 410a (SEQ353), the transfer of the division piece of image data 410d is started (SEQ357 and SEQ358).

Upon the notification of the completion of the transfer for the division piece of image data 410d to the upper level device 10 from the printer controller 14 in SEQ367, the printer controller 14 notifies the print instruction for the printing of the second page to the data transfer control units 30a, 30b, 30c, and 30d (SEQ368).

Now, the description is made with reference to FIG. 32B. In the printer engine 15, the printing for the first page is performed according to the print instruction in SEQ342, and the feeding of the printing paper 201 is started. The printer engine 15 notifies the start of the paper feeding for the first page to the printer controller 14 (SEQ369). Upon the receipt of the notification, the printer controller 14 transmits to the upper level device 10, the control information indicating the paper feeding for the first page has been started with the process identification number processID=1 (SEQ370). Along with this, the printer controller 14 transmits the print instruction to the data transfer control units 30a, 30b, 30c, and 30d so that the printing is performed with the units synchronizing with each other. In accordance with the print instruction, the division pieces of image data 410a to 410d are read out from the memories 31a, 31b, 31c, and 31d by the data transfer control units 30a, 30b, 30c, and 30d, respectively; then, the printing at predetermined positions corresponding to the division pieces of image data 410a to 410d on the first page of the printing paper 201 is sequentially performed.

Similarly, after the printing on the first page, the printing on the second page is performed; the printer engine 15 notifies the printer controller 14 of the start of the paper feeding for the second page (SEQ371). Upon the receipt of the notification, the printer controller 14 transmits to the upper level device 10, the control information indicating that the paper feeding for the second page has been started with the process identification number processID=2 (SEQ372). Along with this, the print instruction for performing the printing with the data transfer control units 30a, 30b, 30c, and 30d synchronizing with each other is transmitted to the data transfer control units 30a, 30b, 30c, and 30d. In accordance with this print instruction, the data transfer control units 30a, 30b, 30c, and 30d read out the division pieces of image data 410a to 410d from the memories 31a, 31b, 31c, and 31d, respectively to perform the printing for the second page of the printing paper 201 sequentially.

Since the processes of SEQ373 to SEQ378 are the same as the processes of SEQ273 to SEQ278 in FIG. 10C, the description is omitted here.

### Second Embodiment

Next, the second embodiment is described. In the first embodiment described above, the single-color image data for one page are divided into the blocks whose number corresponds to the number of data transfer control units 30a to 30d. In contrast, in the second embodiment, the single-color image data for one page are sequentially transferred to the data transfer control units 30a to 30d in raster unit.

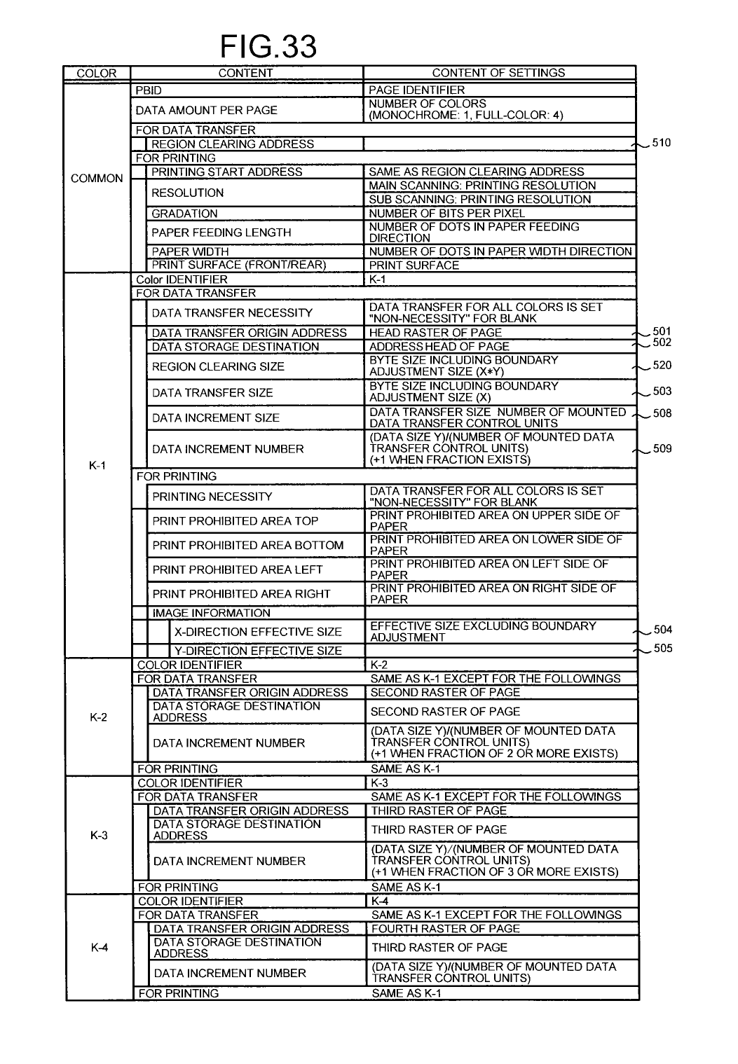

The second embodiment is described with reference to FIGS. 33 to 35. FIG. 33 illustrates an example of a transfer management table applicable to the second embodiment. The parts described below which are common to those of the transfer management table described above with reference to FIG. 23 are not described specifically, and the description is made mainly of the parts different from those of FIG. 23. In the example shown below, the printer device 13 has the four data transfer control units 30a to 30d which handle the color K-1, the color K-2, the color K-3, and the color K-4 as the image data of the black color (K), respectively.

As illustrated in FIG. 33, the transfer management table according to the second embodiment includes as the information common to the colors, the page identifier PBID and the data amount per page, and moreover the print start address, the resolution, the gradation, the paper feeding length, the paper width, and the printing surface as the print information. In the second embodiment, a region clearing address 510 is also included as the data transfer information as the information common to the colors. The print start address in the print information uses the same value as the region clearing address 510.

The information for each color in the transfer management table according to the second embodiment is described. The information for each color includes the Color identifier, the data transfer information, and the print information. The Color identifier is, for example, the value representing the color K-1, the color K-2, the color K-3, or the color K-4. The information when the Color identifier represents “the color K-1” is described.

The data transfer information in the information for each color applicable to this second embodiment includes the information indicating whether the data transfer is needed or not, a data transfer origin address 501, a data storage destination address 502, a region clearing size 520, a data transfer size 503, a data increment size 508, and a data increment number 509.

Among the data transfer information, the data transfer origin address 501 stores the information indicating the head raster of one page; the data storage destination address 502 stores the information indicating the head of the page. The region clearing size 520 is the byte size including the boundary adjustment size, and is the value obtained by multiplying the size in the X direction (pixel number) by the size in the Y direction (raster number). The data transfer size 503 is the byte size including the boundary adjustment size and is the size in the X direction.

The data increment size 508 is obtained by multiplying the above data transfer size 503 by the number of data transfer control units 30a to 30d mounted on the printer device 13. The data increment number 509 is obtained by dividing the size of single-color image data 531 in the Y direction by the number of the data transfer control units 30a to 30d. If there is a fraction, the fraction is allocated sequentially in raster unit to the data transfer control units 30a to 30d.

The print information in the information for each color that is applied to the second embodiment includes print necessity, print prohibited areas (upper side/lower side/left side/right side), and image information. The print information includes an X-direction effective size 504 and a Y-direction effective size. The print information, unlike in the example of FIG. 23, does not include the bitmap printing positions X and Y.

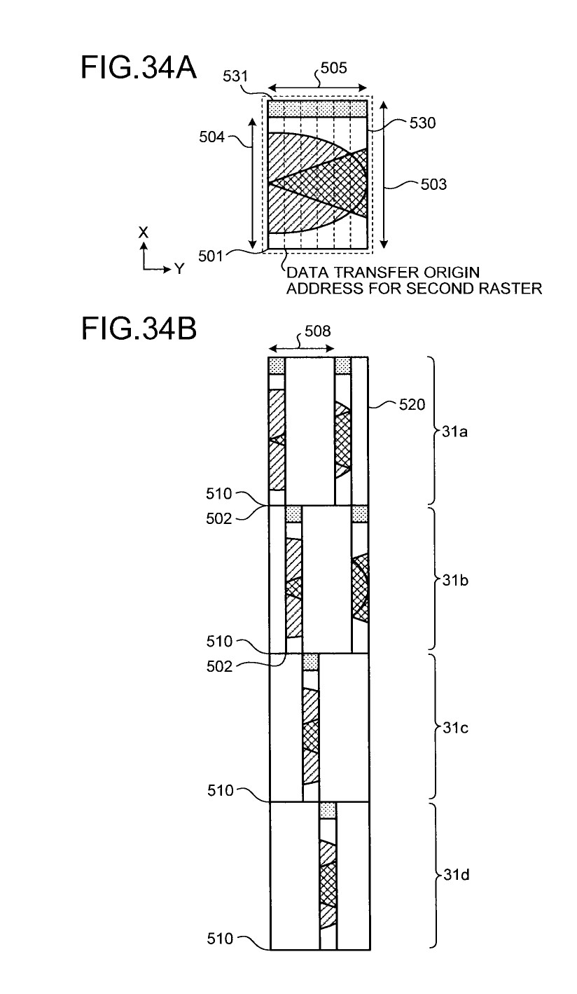

With reference to FIG. 34, a data transfer method according to the second embodiment is described. FIG. 34A illustrates an example of the single-color image data 531 transferred from the upper level device 10 to the printer device 13. Note that in FIG. 34A, the paper is fed from the right side to the left side in the drawing and the lower left corner of the single-color image data 531 serves as the origin of coordinate. The coordinate in the Y direction increases from the left side to the right side, and the coordinate in the X direction increases from the bottom to the top. A line along the X direction is a raster, and the printing is performed in raster unit while the Y coordinate is sequentially increased. Moreover, the vertical dotted line in the single-color image data 531 represents the border between the rasters.

In the example of FIG. 34A, the data transfer size 503 in the X direction of the single-color image data 531 transferred to the printer device 13 includes the boundary adjustment size in the X direction in addition to the X-direction effective size 504 in image data 530 generated by the upper level device 10. Moreover, the single-color image data 531 includes six rasters for one page for description.

The single-color image data 531 are sequentially transferred to the data transfer control units 30a to 30d in raster unit; therefore, the data transfer origin address 501 corresponding to the Color identifier K-1 represents the first raster and the data transfer origin address corresponding to the next Color identifier K-2 represents the second raster.

Meanwhile, the head address of the data in the first raster of the single-color image data 531 is designated as the data storage destination address 502 as exemplified in FIG. 34B, in the memory 31a, for example. In the memory 31b, the address at the position of the second raster is designated as the data storage destination address 502. In this manner, the data storage destination address 502 is designated while the address is displaced with respect to the memories 31a to 31d sequentially raster by raster.

In the memories 31a to 31d, the address obtained by adding the value indicated by the data increment size 508 to the designated data storage destination address 502 is used as the next data storage destination address 502. The data increment size 508 is the value obtained by multiplying the data transfer size 503 by the number of data transfer control units 30a to 30d. Therefore, for example, in the memory 31a, the space for the rasters is allowed for the data transfer control units 30b to 30d except for the data transfer control unit 30a including the memory 31a, and the single-color image data 531 are stored in raster unit (that is, for every four rasters).

More specifically, in the memory 31a for example, the data for the fourth raster of the single-color image data 531 are written in the address formed by adding four rasters to the address in which the data for the first raster of the single-color image data 531 have been written. The image data are not written in the addresses of the second raster to the fourth raster of the memory 31a. Specifically, the writing address is designated similarly in the memories 31b to 31d except that the writing address of the first raster data in the memories 31b to 31d is displaced by one raster.

That is, the raster data are written in the memories 31a to 31d with a space at a position where the raster data are written in the other memories.

The region indicated by the region clearing size 520 in the information for each color is zero-cleared from the address indicated by the region clearing address 510 of the information common to the colors in the memories 31a to 31d. The region clearing size 520 is obtained by multiplying the X-direction data transfer size 503 by a Y-direction effective size 505, and coincides with the size of the entire single-color image data 531 including the boundary adjustment size. The regions of the memories 31a to 31d are zero-cleared by the data transfer control units 30a to 30d just after the completion of the data readout and just before the next data writing.

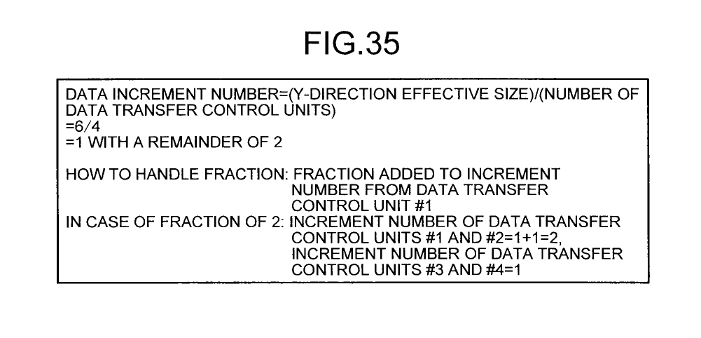

The above data increment number 509 is described. The data increment number 509 can be calculated using the formula of FIG. 35. That is, the following Formula (3) stands:

data increment number=(Y−direction effective size)/(the number of data transfer control units) (3)

Thus, the quotient and remainder are calculated. If the fraction (remainder) is produced, the fractions are allocated one by one to the data increment number 509 of the data transfer control units whose number corresponds to the number of fractions among the data transfer control units 30a to 30d.

More specifically, if the fraction is 1, 1 is added further to the increment number 509 corresponding to the data transfer control unit 30a. If the fraction is 2, 1 is added to each of the increment numbers 509 corresponding to the data transfer control units 30a and 30b. Moreover, if the fraction is 3, 1 is added to each of the increment numbers 509 corresponding to the data transfer control units 30a, 30b, and 30c.

Upon the completion of the data transfer for one page to the data transfer control units 30a to 30d, the printer controller 14 prints from the printing start address. In the data transfer control units 30a to 30d, the image data in raster unit are transferred after the region designated by the region clearing size 520 is zero-cleared from the region clearing address 510 designated as the same address as the print starting address in the memories 31a to 31d. Therefore, at the time of the printing, the printer controller 14 performs the printing with the entire bitmap for one page. The print image data output from the data transfer control units 30a to 30d are merged on the printing paper 201 and the output result for one page is obtained.

Note that since the sequence of the printing process according to the second embodiment is approximately the same as the sequence of the first embodiment, the description here is omitted.

Thus, according to the second embodiment, the print image data generated by the upper level device 10 are sequentially transferred to the data transfer control units 30a to 30d for every raster. Therefore, the data amount obtained by dividing the image data for one page by the number of data transfer control units 30a to 30d is transferred to the data transfer control units 30a to 30d. Accordingly, as compared with the case of transferring the image data for one page from the upper level device 10 to the data transfer control units 30a to 30d, the data transfer can be executed at high speed.

The printing device (printer device 13) according to the second embodiment includes a plurality of storage units in which the image data are written, storage space information indicating the same storage space as the storage space of each of the plurality of storage units, a control unit for managing the address information for writing and reading the image data to and from the plurality of storage units according to the storage space information, a plurality of data management units each provided for each of the plurality of storage units and writing and reading the image data to and from the plurality of storage units according to the address information, and a printing unit for printing the image data read from each of the plurality of storage units on the same page.

The printing device according to the second embodiment includes the storage space information common to the plurality of storage units.

The printing device according to the second embodiment includes the storage space information for every storage unit.

In the printing device according to the second embodiment, the control unit manages the first address information indicating the head address of the reading and the second address information indicating the head address of the writing.

In the printing device according to the second embodiment, the control unit manages empty regions of the plurality of storage units based on the difference between the address indicated by the first address information and the address indicated by the second address information.

In the printing device according to the second embodiment, the control unit updates the second address information by moving the head address of the writing for a predetermined unit in accordance with the completion of the writing of the predetermined unit of the image data for all the storage units.

In the printing device according to the second embodiment, the control unit updates the first address information by moving the head address of the reading for a predetermined unit in accordance with the completion of the reading of the predetermined unit of the image data from all the storage units.

In the printing device according to the second embodiment, the control unit clears with zero, a region for the predetermined unit from the address indicated by the first address information just before the update at any time point from the completion of the readout of the predetermined unit of the image data for all the storage units until the image data are written into the storage units.

In the printing device according to the second embodiment, the control unit clears with zero a region for the predetermined unit from the address indicated by the first address information just before the update, upon updating the second address information.

According to the embodiments, it is possible to provide an effect of higher single-color printing speed in the case of transferring the print image data via a different data line for each color.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A printing device comprising:
a plurality of holding units connected to an upper level device for generating image data, via a plurality of first transfer paths, respectively;
a control unit configured to divide the image data into a plurality of blocks and transfer division pieces of image data corresponding respectively to the blocks to the respective holding units via the first transfer paths to cause the holding units to hold the division pieces of image data, the number of blocks being equal to the number of holding units; and
a printing unit configured to print the division pieces of image data read out from the holding units on a same page.

2. The printing device according to claim 1, wherein the image data is data for a single-color image.

3. The printing device according to claim 1, wherein the control unit divides the image data into the plurality of blocks in raster unit so that piece(s) of raster line data corresponding to a remainder when all raster lines of the image data are divided by the number of blocks are allocated one by one to the groups.

4. The printing device according to claim 1, wherein the holding units request the division pieces of image data via the first transfer paths from the upper level device in accordance with a control made by the control unit and hold the division pieces of image data transferred from the upper level device via the first transfer paths in response to the request.

5. The printing device according to claim 1, wherein
the control unit requests the transfer of the division pieces of image data via a second transmission path from the upper level device to the holding units, and
the holding units receive and hold the division pieces of image data transferred from the upper level device via the first transfer paths in response to the request.

6. The printing device according to claim 1, wherein
the control unit reads out the division piece of image data from each of the holding units by designating a printing position in the page to the printing unit, and
the control unit clears with zero a region of the holding unit in which the division piece of image data read out from the holding unit for printing are written, at any time point from completion of readout of the division piece of image data from the holding unit until the next division piece of image data is written in the holding unit.

7. The printing device according to claim 1, wherein
the control unit writes the division piece of image data at a position corresponding to a printing position in the region while a region for writing the image data for one page is secured for each of the holding units, and
the control unit clears with zero the region of the holding unit at any time point from completion of readout of the division piece of image data from the holding unit until the next division pieces of image data is written in the holding unit.

8. A method of controlling a printing device, comprising:
holding data in a plurality of holding units connected to an upper level device for generating image data, via a plurality of first transfer paths, respectively;
dividing the image data into a plurality of blocks, the number of blocks being equal to the number of holding units;
transferring division pieces of image data corresponding respectively to the blocks to the respective holding units via the first transfer paths to cause the holding units to hold the division pieces of image data; and
printing the division pieces of image data read out from the holding units on a same page.
